(19) United States
(12) Patent Application Publication
(10) Pub. No.: US 2026/0071820 A1
(43) Pub. Date: Mar. 12, 2026

(54) LOW-COST HIGH-PURITY VACUUM PUMPS AND SYSTEMS

(71) Applicant: Desktop Metal, Inc., Burlington, MA (US)

(72) Inventor: Nathan WOODARD, Burlington, MA (US)

(21) Appl. No.: 19/107,617

(22) PCT Filed: Sep. 2, 2023
(86) PCT No.: PCT/US2023/031931

§ 371 Date: Feb. 28, 2025

Related U.S. Application Data
(60) Provisional application No. 63/403,569, filed on Sep. 2, 2022.

(51) Int. Cl. F27B 5/16; F27D 7/06

(52) U.S. Cl. CPC F27B 5/16; F27D 7/06; F27D 2007/066

(57) ABSTRACT

Disclosed is a pumping system with reduced contamination. A vacuum pump system includes a mechanical vacuum pump mechanism within a hermetic pump that hermetically isolates the pump mechanism from ambient air. A pump inlet is hermetically scaled to the hermetic pump housing. A pump outlet is hermetically sealed at one end to the hermetic pump housing and at the other end to an inlet of a Peclet seal tube. The vacuum pump system produces a vacuum in a vacuum processing chamber. A sweep gas source injects a sweep gas into at least one of (i) the hermetic pump housing and (ii) the inlet of the Peclet seal tube. The sweep gas and a process gas flow through the Peclet seal tube to substantially isolate against the backflow of the ambient air through the Peclet seal tube.

### REFERENCE TO PRIOR APPLICATION

This application is a U.S National Stage Application, filed under 35 U.S.C. § 371, of International Patent Application No. PCT/US2023/031931, filed on Sep. 2, 2023, and further claims benefit to U.S. Provisional Patent Application No. 63/403,569, titled “Systems and Methods for Ultra-High Purity Sintering” filed Sep. 2, 2022, all of which are incorporated by reference in their entirety. This application also incorporates by reference U.S. Patent Application No. PCT/US2021/020347 filed Mar. 1, 2021, the contents of which are herein incorporated by reference in their entirety.

### BACKGROUND

Various processing systems and laboratory instruments may require high purity and yet operate at medium or crude vacuum. This may be especially true in high temperature processes, such as metal processing and sintering, but is also true across a very wide range of systems and techniques outside of metal processing. Oftentimes high purity, such as parts per million (ppm) or parts per billion (ppb), may be desired meaning, for example, that for every billion molecules of a desired atmospheric gas, there would on average be only one molecule of contaminant. These high levels of purity can be desired even in cases where vacuum levels are relatively modest and might be considered as “medium” or even “low” or “crude” vacuum for other industries, such as semiconductor fabrication. For example, it may be possible to sinter metal at 300 Torr of process gas, such as pure argon (which is considered crude vacuum), and yet exotic metals, such as certain titanium alloys, may require purity levels as low as 0.1 ppb in a mostly inert process gas. In this case there would be one molecule of contamination for every 10 billion molecules of argon.

Vacuum pumps, including mechanical pumps such as piston pumps, diaphragm pumps, scroll pumps, screw pumps, rotary vane pumps, and other displacement pumps, may be configured to evacuate a vacuum processing chamber to adequate medium or crude pressure, and yet may not be able to produce chamber atmospheres with extremely high purity (such as ppm or ppb) because they are subject to back-streaming of air, contaminants, and/or pump lubrication.

One conventional approach for achieving high purity with medium or crude vacuum may be to employ relatively expensive pumping systems, such as pumping systems that include multiple pumps staged in series and to purchase very expensive best-in-class pumps. In other conventional applications, high purity may be pursued in a brute force manner by providing excessive gas flow to at least somewhat suppress the back-streaming. Excessive gas flow may be, for example, a larger gas flow than would be necessary if the system exhibited better purity. In general brute force approaches result in crude compromises that can be costly to operate and still falls short of the truly desired purity level. Many such compromises are routinely employed and may provide an adequate compromise considered “good enough” in light of the high costs that may be associated with improving purity level further, and operators may merely accept the compromise on the grounds of lack of better options.

### SUMMARY

Disclosed are systems and methods for increasing purity in vacuum processing chambers through the use of what will be referred to as Peclet sealing. In most embodiments this involves tubing long in length relative to a cross-sectional area combined with an outflow through the tubing of a sweeping gas that prevents backflow of contaminants and ambient air through the tubing.

In an embodiment pumping system a hermetic pump housing is hermetically sealed to the ambient air. The pumping system is hermetically connected to and produces a vacuum in a vacuum processing chamber. The pumping system outputs to a Peclet seal tube. By injecting sweep gas that transits the Peclet seal tube the Peclet seal tube prevents backflow of contaminants and ambient air, providing isolation to the pumping system and allowing high purity levels in the vacuum processing chamber.

In an embodiment furnace system for debinding and sintering parts, a vacuum processing chamber has a pumping tube for outgassing process gas and contaminants. A pumping system produces a vacuum in the vacuum processing chamber. The pumping tube is heated during at least a debinding process to reduce condensation of contaminants within the pumping tube, including the debinding by-products outgassed during the debinding cycle, to a predetermined threshold. A process gas source is configured to inject a sweep gas into the vacuum processing chamber at least during the sintering cycle such that the pumping tube provides an amount of Peclet sealing during sintering. The pumping system employed may be the pumping system described above.

In another embodiment furnace system a dual pumping system is employed. A pumping tube from the vacuum processing chamber is used for out-gassing and is connected to a first and second valve. The pumping tube and valves are heated at least during a debinding process to prevent condensation of contaminants. The first valve is utilized during a debinding process to allow a first pumping system to produce a vacuum in the vacuum processing chamber. The second valve is utilized during a subsequent sintering process to allow a second vacuum to produce a vacuum in the vacuum processing chamber. The second vacuum system utilizes a Peclet seal tube and sweep gas to provide isolation during the sintering process. The first pumping system is isolated from the vacuum processing chamber during the sintering process. Therefore, the first pumping system may be a “dirty” pump contaminated by the debinding process without impacting the purity achieved during the sintering process.

Utilizing the above described systems and accompanying methods, remarkable purity may be achieved without the use of high cost pumps. Applicant has utilized these systems to sinter aluminum and other metals which have been historically difficult or impossible to sinter successfully.

Various other embodiments are disclosed in detail below.

### BRIEF DESCRIPTION OF THE DRAWINGS

FIG. 1A-B depict prior art pumping systems.

FIG. 2 depicts a second prior art pumping system and manners of contamination.

FIG. 3A-B depict a third prior art pumping system and manners of contamination.

FIG. 4 depicts a fourth prior art pumping system and manners of contamination.

FIG. 5 depicts a pumping system with contamination reducing sealing.

FIG. 6A-C depict three embodiment pumping systems with reduced contamination.

FIG. 7 depicts a depiction of a Peclet seal tube.

FIG. 8 is a plot showing the relationship between Peclet number and normalized concentration.

FIG. 9 depicts another embodiment pumping system.

FIG. 10 depicts another embodiment pumping system.

FIG. 11 depicts a plot of temperature over time during a debinding process followed by a sintering process.

FIG. 12 depicts an embodiment furnace with a pumping system with reduced contamination.

FIG. 13 depicts another embodiment furnace with a pumping system with reduced contamination. FIG. 14 depicts a furnace employing a double seal system in a closed state.

FIG. 15 depicts the furnace of FIG. 14 in an open state.

FIG. 16 depicts a perspective view of the dual seal system of FIGS. 14-15.

FIG. 17 depicts a plan view of the dual seal system of FIGS. 14-15.

FIG. 18 depicts a plan view of another dual seal system.

FIG. 19A-H depict embodiment dual seal systems.

FIG. 20A-D depict embodiment sealing in a tube furnace.

FIG. 21 depicts an embodiment system having a first stage pump in series with an embodiment pumping system.

FIG. 22A-B depict embodiment furnaces wherein a retort has a Peclet seal tube for reducing contamination.

FIG. 23A-I depict embodiment furnace adapter arrangements using Peclet sealing for reducing contamination.

FIG. 24-C depict embodiment furnace adapter arrangements using Peclet sealing for reducing contamination.

FIG. 25 depicts an embodiment furnace adapter arrangement including bellows and an enlarged tube to aid in preventing clogging while outgas cools before entering a binder trap.

FIG. 26A-C depict various schematic depictions of furnace arrangements.

### DETAILED DESCRIPTION

This disclosure can provide relatively low-cost systems and methods to achieve ppm or ppb, or even better than ppb purity without introducing expensive ultra-high vacuum pumps or stages and without excessive gas flow. At least some embodiments described herein may be configured to achieve parts per million (ppm), parts per billion (ppb), or even better than ppb sealing and outlet-inlet isolation from outside air at medium and/or crude vacuum with extremely robust and rugged pumps that cost less than conventional pumps. As used herein, “outlet-inlet isolation” may refer to isolation of air from the outlet of the pumping system and its inlet, and the term “sealing” may refer to more traditional sealing (such as gaskets and o-rings) between the inside and outside of our chamber, tubes, and pumping systems.

This disclosure may relate to vacuum chambers and pumps that operate at medium or crude vacuum and yet require sufficient sealing and outlet-inlet isolation for achieving high purity of ppm to ppb, or even better than ppb, at least relative to ingress and/or leakage of outside air.

For purposes of this disclosure medium vacuum may correspond to 3E-4 Torr and above, and may include even 759 Torr. In terms of art, definitions may vary depending on the field. For example, the term “crude vacuum” in one field may correspond to a hard vacuum in another field. For example, operators of Molecular-beam epitaxy (MBE) machines may consider 10E-6 Torr as crude vacuum while operators of sintering furnaces may consider 10E-6 Torr as deep or “hard” vacuum. In the present disclosure, hard vacuum may correspond to less than IE-4 Torr, medium vacuum may correspond to IE-4 to 100 Torr, and crude vacuum may correspond to 101 Torr to 759 Torr. (Note that atmospheric pressure is approximately 760 Torr).

Purity level may be characterized as “parts per N,” where parts is a number of molecules of contaminant in a pure gas, and N is a large number of pure gas molecules. For example, an otherwise pure sample of argon, at parts per billion ppb of oxygen would be contaminated by roughly one molecule of oxygen for every billion molecules of argon, and this certainly can be considered as highly pure for all but the most extreme applications. As was the case with regard to vacuum, terms of art related to atmospheric purity may vary by discipline. As described herein, high purity may correspond to 100 parts per million (ppm) or better (more pure). Medium purity may correspond to 100 ppm to 1 parts per thousand (ppt), and crude purity may correspond to purities that are worse (less pure) than parts per thousand (ppt).

Practitioners of many disparate disciplines, when utilizing vacuum, generally tend to rely on the same catalogs and vendors, which may focus on the most stringent vacuum requirements. For example, manufacturers of chambers, seals, pumps and vacuum gauges, (e g., MDC Kurt Lesker, and Ideal Vac, among others) may tend to focus on similar products, which may be relatively costly and directed toward achieving hard vacuum at 10E-6 Torr or better. Achieving high purity with this technology may be relatively straightforward. Manufacturers and users of sintering furnaces may tend to rely on vacuum equipment made and sold for such high vacuum operation at least for the reason that this technology is well known and widely available.

Furthermore, vendors and sales personnel in the vacuum industry may be motived to encourage designers and users to rely on high vacuum equipment for lack of available alternatives. Accordingly, one seeking to achieve high purity will typically tend to employ commercially available standard high vacuum equipment.

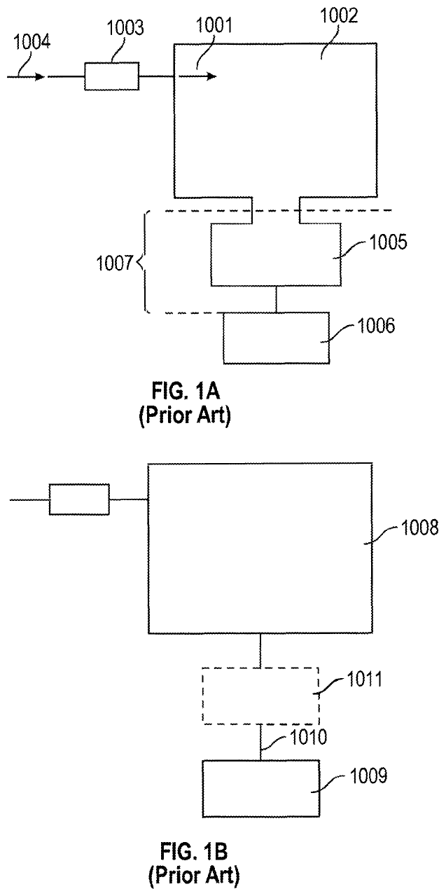

FIG. 1A is a schematic of an existing exemplary high vacuum system designed to use vacuum pumps for operation at high vacuum of less than IE-4 Torr. Vacuum systems for materials processing may include process gas flow 1001 that can be injected into a high-vacuum processing chamber 1002 by way of a mass flow controller (MFC) 1003 that is fed by a supply of high purity process gas 1004. Such systems may require a multi-stage turbo-mechanical and/or thermo-mechanical pumping system as is represented in FIG. 1A. The system may comprise a vacuum processing chamber as a high vacuum chamber 1002 that is hermetically sealed to prevent air leakage from the outside, a mechanical high vacuum pump 1005, such as a turbo molecular pump, a thermo-mechanical diffusion pump, or a turbomolecular drag pump. Each of these high vacuum mechanical pumps may require a secondary “roughing” pump 1006 in series to pump on the outlet of the high vacuum pump. High outlet-inlet isolation 1007 may be achieved by the overall series pump arrangement.

Diffusion pumps may be described herein as “thermo-mechanical” because the mechanism for pumping gas molecules may include generating high velocity oil droplets colliding with gas molecules for mechanically encouraging gas flow in a manner analogous to the action of turbo-molecular pumps where it is the pump blades that are colliding with gas molecules. It is noted that non-mechanical high vacuum pumps, such as ion pumps and cryo-pumps, may be generally used only at very high vacuums of IE-6 Torr or less, whereas diffusion pumps and turbo pumps may tend to be used with chambers that are at the higher pressure end of the “hard vacuum” range and may even be operated at medium vacuum pressures.

FIG. 1A illustrates an exemplary technique of using multi-stage pump systems comprising a high vacuum pump 1005 (for example, a thermo-mechanical or turbo-mechanical pump) pumping on a high-vacuum processing chamber 1002 in series with a medium vacuum “roughing” pump 1006, as a mechanism to achieve high vacuum, as well as high outlet-inlet isolation 1007. Vacuum sintering furnaces may include other components and/or features borrowed from vacuum systems, in particular pumps, valves, gauges and chambers in many cases.

FIG. 1B schematically illustrates a generic medium vacuum system, including a vacuum processing chamber 1008 and a roughing pump 1009 such as a mechanical pump, that is configured to receive process gas and is pumped with at least a mechanical vacuum pump. As described below, unlike some relatively expensive, best-in-class, mechanical pumps, relatively low cost “roughing” pumps may tend to allow a significant amount of air to backstream from the pump exhaust to the pump inlet. Also contaminants and/or vapor pump lubricant may backstream from inside the roughing pump 1009 to the pump inlet 1010. In some cases, this back-streaming may be somewhat mitigated by increasing process gas flow and by introducing various forms of traps 1011 (such as cryogenic and/or molecular sieve traps) or by adding multiple pumping stages in series. However, these mitigation strategies may be expensive and/or unsatisfactory or at least compromising in nature. Even when the medium vacuum chamber is hermetically sealed to state of the art levels (e g., similar to levels that may be used in ultra-high vacuum systems) it may be common for the purity of the process atmosphere to be limited by the back-streaming and the limitations of the mitigation techniques. It may also be common for users and designers to resolve this problem by employing expensive pumping systems that have high initial costs as well as high operating costs. For example, it may be common for users to employ a roots blower pump in series with a best-in-class rotary vane pump. However, even in this configuration, it may be necessary to include cryogenic inlet traps (such as liquid nitrogen traps) to diminish back-streaming of pump oil into the chamber.

FIG. 2 is a schematic representation of mechanisms of back-streaming in typical high, medium, and low-cost roughing pumps, such as a piston pump, diaphragm pump, rotary vane pump, or other displacement pump. As mentioned previously, regardless of cost, each of these pumps may exhibit significant back-streaming 2001 of outside air from the exhaust of the pump to the pump inlet and may not be capable of providing ppm of isolation, let alone ppb of isolation at the pump inlet. Purity at the inlet can be further degraded by housing leakage and or diffusion of air 2002 through the pump housing itself including leakage through shaft seals and imperfect gaskets. Pumps that may be capable of achieving ppm of isolation against air may tend to use oil, which may introduce back-streaming of contaminants and/or lubricants 2003 from within the pump, as is illustrated in FIG. 2. For example, even best-in-class rotary vane pumps may exhibit back-streaming of oil and other and other hydrocarbon contaminants to an extent that that it may be challenging to achieve sufficient purity with respect to oil and hydrocarbons and various traps including cryo-traps are often used to at least somewhat mitigate oil mist. In such cases, a modest amount of process gas flow (for example 1 slm) and a relatively long and thin pumping tube between the medium vacuum processing chamber and the pump (for example a ‘A” diameter tube 1 m in length) may facilitate better purity in the chamber as compared to the inlet of the pump. However, these approaches may lead to comprised performance, such as higher pressure than is desired, or very high cost, as larger pumps may be required to achieve desired pressure with the larger gas flow. In other words, the “brute force” use of higher gas flow may also increase cost with respect to equipment as well as operation. Also, as mentioned previously, cryogenic inlet traps and other traps may be used, but these approaches add to cost and complexity as well as other compromises.

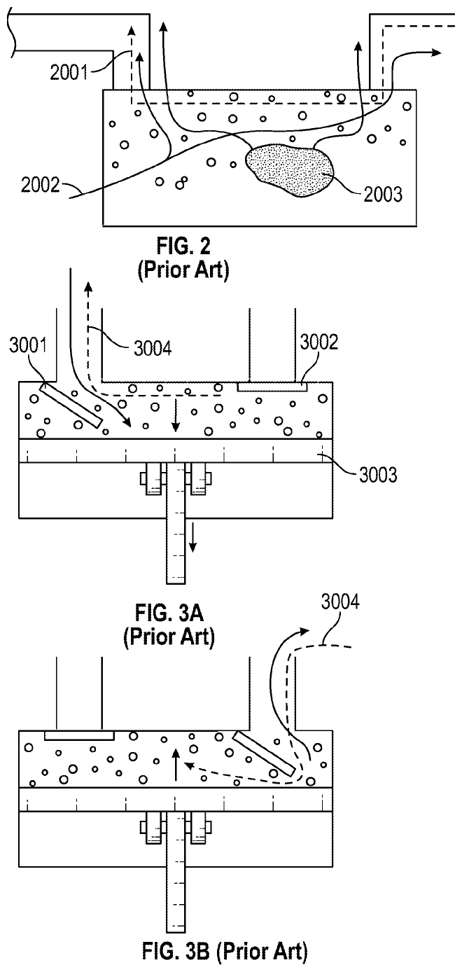

FIGS. 3A and 3B illustrate the basic pumping mechanism for piston pumps having inlet and outlet valves (allowing for inlet flow and outlet flow respectively) and a reciprocating piston. Piston pumps are described herein for explanatory purposes, and it is to be understood that the issues described may also apply to other types of displacement pumps. During at least a portion of the inlet stroke (FIG. 3A), the inlet valve 3001 may be open and the outlet valve 3002 may be closed for most (or all) of the intake stroke, such that the piston 3003 displaces volume from the inlet into the piston as is shown in FIG. 3A. As can be seen in FIG. 3A, some backflow from the pump housing into the pump inlet will normally occur. During the outlet stroke, the inlet valve 3001 may be closed and the outlet valve 3002 may be open for most (or all) of the outlet stroke, such that the content of the piston is displaced to the outside. As can be seen in FIG. 3B, some backflow 3004 from the ambient air into the pump housing will normally occur.

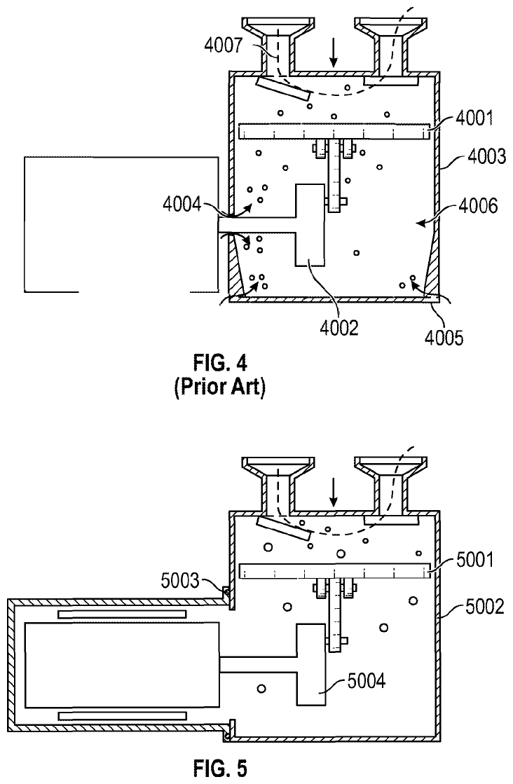

As is noted in FIG. 4, various imperfections such as imperfect seals, leaks, and imperfect geometric fits and tolerances may each contribute to the presence of some degree of back-streaming, even in relatively expensive best-in-class pumps. This back-streaming may diminish outlet-inlet isolation of the pump. Housing leaks gasket leaks, and shaft seal leaks may also contribute to the base pressure of a given pump. Furthermore, displacement pumps may include some finite degree of excess inactive or “dead” volume in the piston chamber that cannot be purged with each outlet stroke, and this dead volume may uptake a significant amount of residual air molecules from the outside air and may contribute to limiting base pressure and back-streaming. The tendency for back-streaming may be causally correlated to a quantifiable performance specification known as “base pressure”. The base pressure of a given pump may be defined as the measured inlet pressure (pressure at the inlet) when the pump inlet is sealed off during operation, and, in many cases, the base pressure is limited by back-streaming, such that a relatively lower cost lower precision pump may tend to exhibit more back-streaming and therefore tend to achieve poorer (higher) base pressure. For example, a best-in-class rotary vane, piston, or diaphragm pump (examples of which may be produced by Edwards, Varian, or Kinney) may cost several thousand dollars and exhibit a base pressure of 0.001 Torr of air from the outside, whereas a relatively low cost piston pump or diaphragm pump used in pneumatic applications may exhibit a base pressure of 0.001 Torr to 1 Torr, 1-10 Torr, 10-100 Tor, 100-300 Torr and 300-750 Torr, of air from the outside. Base pressure at the inlet may develop by back-streaming, which may be significantly larger in low cost pumps, such that base pressure of air may constitute a limit to outlet-inlet isolation of the pump.

As illustrated in FIG. 4, the piston 4001 and the drive mechanism 4002 may be contained in a sealed pump housing 4003 having leaks, including a relatively leaky shaft seal 4004 (where the motor shaft enters the housing), gasket leaks at static seals 4005 (such as adhesively glued face seals or gaskets where two separate portions of pump housing are sealed to one another), and housing leaks 4006 through porous housing material, such as plastic and/or cast metal. Some or all of these leaks may be considered tolerable especially insofar as the total of all those leaks introduces similar or smaller amount of air than is introduced through back-streaming 4007.

Applicants further recognize that, in the interest of cost of the pump, for low cost and/or moderate performance pumps it may be unnecessary to provide truly hermetic shaft seals, static seals, and/or impermeable materials configured to block air significantly better than the pump itself. Said differently, base pressure due to back-streaming may constitute a meaningful limitation, such that, from a cost perspective, it may be unnecessary to provide pump housing and shaft seals that produce leaks significantly smaller than that of the back-streaming.

Moreover, it may be unnecessary to include pump seals that are capable of sealing to a degree in excess of the outlet-inlet isolation developed by a given pumping mechanism. For example, if a relatively low cost permeable housing formed of cast aluminum may be suitable, and it may therefore be unnecessary to use somewhat more expensive housings, such as machined aluminum, if, for example the pump itself is configured to provide a base pressure of 0.01 Torr of outside air as the base pressure of the pump. It is noted that for a non-hermetic pump, residual air molecules may be introduced from either the pump outlet or through the various housing leaks. Again, while FIGS. 3 and 4 depict piston pumps, it should be understood that these figures are included to clarify various principles that tend to at least generally apply to other types of displacement pumps.

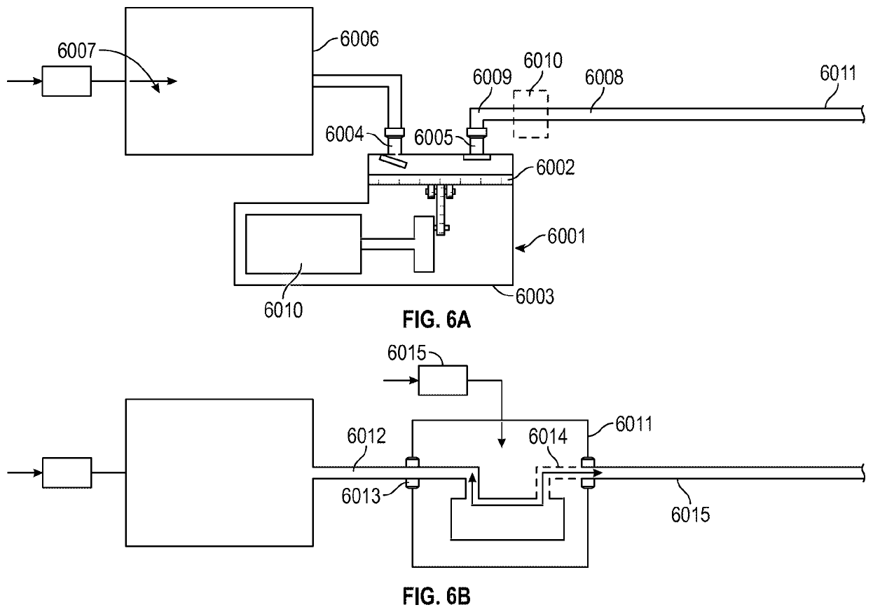

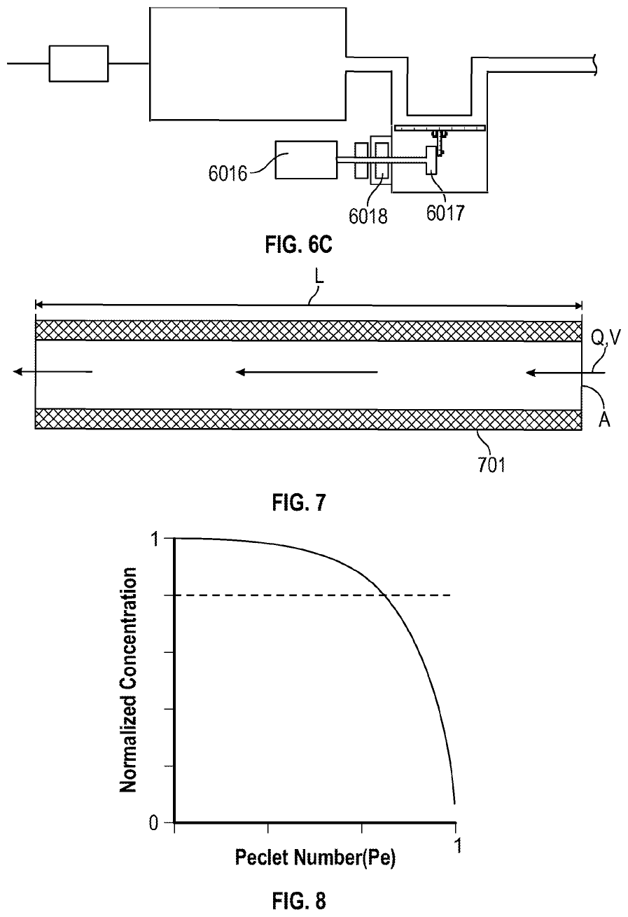

FIG. 5 illustrates a pump 5001 having a hermetically sealed pump housing 5002 composed of an impermeable housing material such as non-porous steal or aluminum and hermetic static seals 5003 such as an o-ring, and an exemplary drive mechanism 5004 (for converting rotary motion of a motor to linear motion of the piston) having no shaft seal and thus no resulting shaft seal leak. For purposes of this disclosure when we refer to a hermetically sealed pump housing it should be understood that any leakage through the housing is at least one order of magnitude lower than outlet-inlet back streaming exhibited by that pump. Applicant routinely produces hermetically sealed pumps that exhibit 3 to 6 orders of magnitude less leakage (through housing, shaft, and static seals) as compared to the outlet-inlet back-streaming. FIG. 6A shows a pumping system 6001 that may utilize a mechanical vacuum pump mechanism 6002 within a hermetic pump housing 6003 that hermetically isolates the mechanical vacuum pump mechanism to achieve sufficient sealing and overall system outlet-inlet isolation of ppm, ppb, or better vacuum processing chamber purity with a relatively low cost pump including a low cost pump mechanism that operates with high back-streaming and thus exhibits relatively poor base pressure (PB), for example in the range of 0.001 Torr to 1 Torr, 1-10 Torr, 10-100 Tor, 100-300 Torr and 300-750 Torr. FIG. 6A shows a piston style pump mechanism of the sort illustrated in FIG. 5 having a hermetic pump housing 6003 with impermeable housing walls and hermitic pump housing seals at any joints in the housing to hermetically isolate the mechanical vacuum pump mechanism 6002 from outside ambient air.

In this embodiment, the motor 6010 may be contained within the hermetic pump housing in part in order to avoid using a potentially leaky shaft seal. A pump inlet 6004 is hermetically sealed to the hermetic pump housing 6003 and serves as an inlet path to the vacuum pump mechanism 6002. A pump outlet 6005 is hermetically sealed to the hermetic pump housing 6003 and serves as an outlet path from the mechanical vacuum pump mechanism 6002. The vacuum pump system 6001 produces a vacuum in vacuum processing chamber 6006. A process gas 6007 may be injected into the vacuum processing chamber. A Peclet seal tube 6008 has a Peclet seal tube inlet 6009 hermetically sealed to the pump outlet 6005. By operation of the pumping system 6001 the process gas flows from the inlet of the Peclet seal tube towards an outlet 6011 of the Peclet seal tube 6008 to substantially isolate against the backflow of the ambient air through the Peclet seal tube 6008. The Peclet seal tube 6008 may optionally include a ballast volume 6010 arranged in gaseous communication with the inlet 6009 of the Peclet seal tube such that the ballast volume can reduce pressure fluctuations caused by pump pressure ripple. The mechanical vacuum pump mechanism 6002 may be a displacement pump. Examples of suitable displacement pumps include, without limitation, piston pumps, a diaphragm pumps and scroll pumps. The Peclet seal tube 6008 is preferably constructed from a material that resists condensation of contaminants. In certain embodiments, the Peclet seal tube is constructed from metal.

The pumping system of FIG. 6A that may provide sufficient sealing and sufficient outlet-inlet isolation to achieve ppm or even ppb chamber purity (relative to outside air) with a relatively low cost pump, for example a pump that exhibits relatively poor base pressure (PB) for example in the range PB=0.01 Torr to 300 Torr. The thin Peclet seal tube may be, for example, a ⅛″ diameter (e.g., ⅛″ inner diameter)×0.5 meters to several meters long metal tube. As there may be sufficient process gas flow to produce laminar flow within the Peclet seal tube, and as the Peclet seal tube may be sufficiently long and sufficiently thin, there may be no theoretical limit to the degree of Peclet isolation that can be achieved relative to the outside air at the outlet of the Peclet seal tube. (However there may be practical limitations and considerations, including offgassing of contaminants from the inner walls of the Peclet seal tube and considerations with regards to Peclet seal design and performance described below.) While the Peclet seal tube may not form a “seal” in the traditional sense, the tube may nevertheless be referred as a Peclet “seal” tube to emphasize the relatively high degree of outlet-inlet isolation, for example of outside air, that may be achieved between the outlet and the inlet of the tube. While the Peclet seal tube may provide ppm, ppb, or even better than ppb isolation, it may be considered reasonable to describe it as a “seal” in the sense that it inhibits flow and/or diffusion of air from the outlet from reaching the inlet. For any pure gas flow rate greater than 0.05 slm it may be straightforward to achieve ppm and ppb isolation of the Peclet tube inlet relative to the Peclet tube outlet. For process flow rates between less than 0.05 through the chamber and into the pump inlet it may be more challenging but may nevertheless be achieved through techniques described herein.

This overall system and method may provide advantages for achieving relatively high purity at relatively low cost, and this may be achieved in part because this method and system at least generally decouple the issue of base pressure and purity in the sense that the pump is no longer required to do all the work of achieving both vacuum and isolation as tends to be the case in traditional pumping systems where the pump system is generally relied on for both vacuum isolation between input and output. Unlike conventional systems that primarily rely on pumps to achieve high isolation (often characterized in terms of vacuum art as compression ratio), the systems and methods described herein may include a Peclet seal tube for establishing isolation between the outlet and the inlet of the pumping system, while the pump may be relied upon mainly to produce the desired vacuum, such that any additional outlet-inlet isolation against backflow achieved by the pump is considered beneficial but not necessarily required. Again, with regard to air at the outlet of the Peclet seal tube, the pump may provide for vacuum even if the pump does not exhibit impressive isolation against back-streaming, and the tube may provide much, or most, of the sealing and outlet-inlet isolation. It should be understood that even for a relatively low-cost low performance pump mechanism, the sealing of the pump housing may be hermetic, especially with regard to the embodiment illustrated in FIG. 6A. However, sealing of the pump housing need not be highly costly, even in cases where a very high degree of hermiticity is necessary. In general, static sealing may be relatively straightforward and cost effective if designed and executed properly in accordance with well-known vacuum sealing techniques. Relaxing specifications with regard to base pressure and compression ratio on the internal displacement pumping mechanism may allow for a relatively low cost and/or robust pumping mechanism configured to provide the vacuum pressure needed while the Peclet tube provides for high purity.

FIG. 6B illustrates an exemplary embodiment that may facilitate the use of an unmodified non-hermetic pump that does not require hermetic sealing of the pump body. In this embodiment, the pump may be contained in an external hermetic pump housing 6011 that is configured as a container with hermetic tube feedthroughs at the inlet and outlet of the hermetic pump housing. In this embodiment, there may be a pumping tube 6012 hermetically sealed to the pump inlet 6013 and similar pump outlet 6014 is optionally included. This pump outlet 6014 may prevent contamination of the hermetic pump housing but in the absence of contamination, the system may function as intended without this tube. For example, the pump may exhaust into the container, and the Peclet seal tube 6015 may continue to provide outlet-inlet isolation just as it would with the pump outlet hermetically sealed to an inlet of the Peclet seal tube. A sweep gas source 6015 injects an amount of sweep gas into the hermetic pump housing, which provides sweep gas flow through the Peclet seal tube similarly to the process gas of FIG. 6A. As was the case in the embodiment of FIG. 6A the embodiment of FIG. 6B may allow for the use of a relatively low cost pump to provide the vacuum pressure needed, while the Peclet tube 6015 may provide for ultra-high purity. To further clarify, ppm purity at the pump inlet may be achieved by operating in accordance with FIG. 6B with a relatively low cost piston pump or diaphragm pump (e g., a KNF or Welch brand diaphragm pump) having a relatively leaky plastic and rubber diaphragm that would normally be used in low cost low performance pneumatic applications and would normally be incapable of providing even parts per thousand (ppt) of outlet-inlet isolation. In this case, the pump used by itself might not be capable of providing for anything better than parts per hundred or perhaps even one part in ten.

FIG. 6C depicts a further embodiment in which a motor 6016 outside the hermetic pump housing drives the mechanical vacuum pump mechanism 6017 via a hermetic rotary coupler 6018. In certain embodiments, the hermetic rotary coupler is a magnetic rotary coupler.

For purposes of descriptive clarity, it can be useful to again clarify two distinct mechanisms by which displacement pumps provide for sealing and isolation. In one mechanism, the hermetic pump housing may provide sealing between the inside of the pump and the air outside the pump. This sealing may be thought of as housing sealing and for a pump with a hermetically sealed housing, the housing sealing integrity may be very high integrity, for example a hermetic pump housing may provide for a leak rate through the housing in the range of IE-6 Torr-liters per second (TL/S) to less than IE-9 TL/S. Another form of isolation can be described as the pump's outlet-inlet isolation between the outlet of the pump and the inlet and in general a pump with lower back-streaming may provide for better isolation in this regard. Isolation may correspond to a pump's “compression ratio,” and, in many cases, compression ratio and base pressure may be derived from one another. For example, a pump having a compression ratio of 1 E6 may be exhausted to air and the base pressure would be roughly 0.001 Torr. Mechanical pumps with state-of-the-art low base pressure may also provide for high state-of-the-art outlet-inlet isolation which in many cases goes hand in hand with state-of-the-art high compression ratio. Compression ratios, such as a compression ratio of 1E6, may be readily attained in expensive best-in-class displacement pumps. By contrast, low-cost pumps, such as diaphragm pumps, or low-end dry piston pumps, may only achieve compression ratios of 10, 100, 1000, or 10,000, and the cost of a given pump may tend to drop with lower compression ratio.

In at least some aspects of this disclosure, a relatively low cost pump having a hermetic pump housing and a relatively modest base pressure of 0.01 Torr to 100 Torr may be hermetically sealed at the pump outlet to a Peclet seal tube such that the pumping system and the Peclet seal tube cooperate to provide for isolation of ppm to 0.1 ppb at the inlet of the pump relative to outside air.

In at least some aspects of this disclosure, based on FIG. 6A and/or FIG. 6B, systems with at least 0.1 slm of gas flow, 1 ppm pump inlet purity (relative to outside air) may be attained with a low cost pump that has a compression ratio of 10 sealed to a Peclet seal tube with Peclet isolation of 10 ppm relative to outside air. The pumping system may be configured to contribute roughly a factor of 10 additional outlet-inlet isolation in addition to that of the Peclet tube seal.

In at least some aspects of this disclosure, based on FIG. 6A and/or FIG. 6B, with at least 0.1 slm of gas flow, 1 ppm pump inlet purity can be attained with a low cost pump that has a compression ratio of 100 sealed to a hermetic Peclet tube with Peclet isolation of 100 ppm relative to outside air. The pump may be configured to contribute roughly a factor of 100 additional outlet-inlet isolation in addition to that of the Peclet tube seal.

In at least some aspects of this disclosure, based on FIG. 6A and/or FIG. 6B, with at least 0.1 slm of gas flow, 1 ppm pump inlet purity may be attained with a low cost pump that has a compression ratio of 1,000 hermetically sealed to a Peclet seal tube with Peclet isolation of 1,000 ppm relative to outside air. The pump may be configured to contribute roughly a factor of 1,000 additional outlet-inlet isolation in addition to that of the Peclet tube seal. While exemplary embodiments (using a pump with 0.001 Torr base pressure) is described for completeness, it may be unnecessary, and perhaps even excessive, to use pumps with compression ratio of 1,000. Indeed, as described below, there may even be disadvantages to using pumps with an excessively high compression ratio (and low base pressure) at least for the reason that such pumps can be sensitive to contaminants and more difficult to decontaminate as compared to lower cost designs that are better suited to the approach described herein. Accordingly, it may be preferable to use pumps that have sufficiently high compression and sufficiently low base pressure to provide the desired vacuum, and not a significantly stronger vacuum.

In at least some aspects of this disclosure, based on FIG. 6A and/or FIG. 6B, with at least 0.1 slm of process gas flow (for example pure argon), 1 ppb pump inlet purity (relative to outside air) may be attained with a low cost pump that has a compression ratio of 10 hermetically sealed to a Peclet seal tube with Peclet isolation of 10 ppb relative to outside air The pumping system may be configured to contribute roughly a factor of 10 additional outletinlet isolation in addition to that of the Peclet seal tube.

In at least some aspects of this disclosure, based on FIG. 6A and/or FIG. 6B, with at least 0.1 slm of gas flow, 1 ppb pump inlet purity may be attained with a low cost pump that has a compression ratio of 100 hermetically sealed to a Peclet seal tube with Peclet isolation of 100 ppb relative to outside air. The pumping system may be configured to contribute roughly a factor of 100 additional outlet-inlet isolation in addition to that of the Peclet tube seal.

In at least some aspects of this disclosure, based on FIG. 6A and/or FIG. 6B, with at least 0.1 slm of gas flow, 1 ppb pump inlet purity may be attained with a low cost pump that has a compression ratio of 1,000 hermetically sealed to a Peclet seal tube with Peclet isolation of 1,000 ppb relative to outside air. The pumping system may be configured to contribute roughly a factor of 1,000 additional outlet-inlet isolation in addition to that of the Peclet tube seal.

The outlet-inlet isolation may be quantified as a unitless ratio of the amount of air from the outside at the inlet of the pump divided by the amount of air outside the pump and at the outlet of the pump.

In general applicants recognize that commercially available mechanical vacuum pumps (i.e. roughing pumps) are not intended to provide impressive isolation against outside air. For example, dry pumps such as piston pumps, scroll pumps and diaphragm pumps only exhibit a compression ratio insofar as they reduce pressure but they do not provide for any degree of isolation in the absence of process gas flow since the entire base pressure under no-flow conditions consists of air from the outside. In one exception, it may be possible to obtain wet rotary vane pumps that use pump oil as a sealant. However, such pumps may tend to introduce hydrocarbon gases. Moreover, oil pumps low in contaminants may be relatively expensive with cleanliness that is short-lived when exposed to contaminants.

Applicants further recognize that in traditional vacuum systems, a high performance vacuum pump such as a turbo molecular pump having high compression ratio (>1EA) may be relied upon to provide vacuum pressure and to provide for isolation between the inlet of the pump and the air outside the pump and/or at the exhaust of the pump. However, in exemplary approaches described herein, the function of the pump and the Peclet tube seal may be allocated such that (i) the pumping system may be relied upon for providing vacuum pressure at the inlet of the pump while providing for little if any contribution to isolation, and (ii) the Peclet seal tube may not produce no contribution to the vacuum but may provide for the majority of isolation between the pump inlet and the ambient air outside the pump and/or at the outlet of the Peclet seal tube.

As described above, the Peclet tubes were described only insofar as necessary for purposes of including Peclet tubes in a pumping system. It is noted that Peclet seals may allow for numerous dimensional variations, and it is practical considerations and features that tend to determine actual practical performance. This section discusses basic principles of operation as well as details of Peclet tube seals with respect to design and practical implementation Exemplary equations for designing a Peclet tube seal as illustrated in FIG. 7 are as follows.

### Definitions

L=length of Peclet tube (m)
A=cross sectional area of tube (m2)
V-average flow velocity of the sweep gas in the tube (m/s)
D=Diffusivity s (m2/ s)
Pe=dimensionless Peclet number I=Isolation (unitless)
Q-volumetric flow rate of sweep gas through the tube (mA 3/s)

Where diffusivity may be the diffusivity of one gas in another at a given temperature and pressure. For example, at room temperature and atmospheric pressure, the diffusivity of oxygen in argon is approximately D (O—Ar)=0.3 cmA 2/s=3E-5 mA 2/s. More elaborate calculations can be performed if tracking multiple species. Furthermore, a person skilled in the art having access to literature on diffusivity can readily account for various levels of complexity including accounting for temperature effects, pressure dependence and non-linear effects such as turbulence. For example, one of many potentially useful references in the literature are R. B. Bird, W. E. Stewart, and E. N. Lightfoot, Transport Phenomena 2nd ed., New York: John Wiley & Sons, 2002.

The dimensionless Peclet constant may be a dimensionless ratio Eqn

$$1. P e = {V}^{*} L / D$$

This Peclet number may be useful to the extent that the larger the Peclet number, the better the sealing in accordance with the following equation Eqn
2. I−exp (-Pe) It is noted that equation 1 may be rewritten to include flow rate: Eqn

$$3. P e = {Q}^{*} L / ( {A}^{*} D )$$

Having these equations and concepts as disclosed herein, a person of ordinary skill in the art may be able to use these insights to generate numerous embodiments and examples of Peel et tube seals and will appreciate that this one-dimensional model and approximation reveals Peclet tube sealing to be an effective technique, such that it may be possible to generate highly varied solutions with massive theoretical margin. For example, even given a very small process and/or sweep gas flow of 0.1 slm of argon (0.1 mA 3/s at stp), a tube of 3 mm diameter and length approximately 6 mm may, according to equations 1 and 2, provide for isolation between inlet and outlet of I˜2E-31 which is twenty orders of magnitude better than 0.01 ppb. FIG. 8 illustrates a curve calculable based upon the above equations that represents the normalized ration of concentration in a log-log plot at the inlet relative to the outlet of a Peclet seal tube for a given Peclet number at the inlet relative to the outlet of a tube for a given Peclet number.

It is to be understood here and throughout the application that process gas may be useful as contributing to a particular process as well as contributing to the sweep gas flow. PecletSweep gas may be injected the hermetic pump housing or at the inlet of the Peclet seal tube. Alternatively, a process gas may be serve as a sweep gas when injected into the vacuum processing chamber.

It is noted that the above analyses is applicable to flow paths having many different cross sectional shapes. For example, the above concepts and equations apply to planar flow of fluid in a gap defined by parallel plates having a gap height G and width W defining a cross sectional area G*W. For a flow path of length L the cross sectional gap area can be used in equation 1 with V=Q/(G*W). It is further noted that the equations apply very well at vacuum pressure insofar as the flow remains laminar. However, the diffusivity D is pressure dependent in approximate inverse proportion to pressure. In our calculations of Peclet seal performance vs. vacuum pressure we relied on the pressure and temperature dependent equation for D published on page 48 of “Vacuum Technology” by A. Roth published in his second edition by North Holland in 1988. Our models using this equation have born out rigorously under thorough empirical studies.

Applicants recognize that the above equations correspond to a relatively simple one-dimensional model. However, this model may generally correspond to physical pump systems configured to achieve ppb, and better, isolation using even relatively short and relatively large diameter tubes. Moreover, for reasonable tube designs, it may be desirable to evaluate various practical considerations beyond the theoretical design of the Peclet tube seal. Such practical considerations may tend to dominate performance limitations and can include consideration of off gassing of contaminants from inside the walls of the Peclet seal tube and also may include leaks through various seals such as O-rings and or metal gasket seals for example sealing a pump outlet to a Peclet tube inlet. In order to achieve ppm and ppb purity in a low cost and practical manner, it may be advantageous to be mindful of various considerations described below.

One exemplary approach is to use tubes that are one or two meters long and set the diameter of the tube such that the tube does not limit or otherwise choke the displacement velocity of the pump and/or the sweep gas. Thus, it may be desirable to make the tube as small as possible without significantly affecting the pump. By following this approach, tubes having 2 mm to 10 mm inner diameter for process gas flows between 0.1 slm and 10 slm, respectively, may be suitable. In such cases, predictions based on the above one-dimensional model may result in performance many orders of magnitude greater than necessary. For example, a tube of about one, two, or three meters in length, ranging from ⅛″ to 0.59″ (1.5 cm) diameter may be readily practical and not excessively restrictive. Indeed, the theoretical designs of tubes according to this disclosure may not be noticeably restrictive on pumping action and may tend to provide theoretical Peclet isolation at least ten orders of magnitude better than is required. In such cases, other practical aspects will tend to determine the system performance limits.

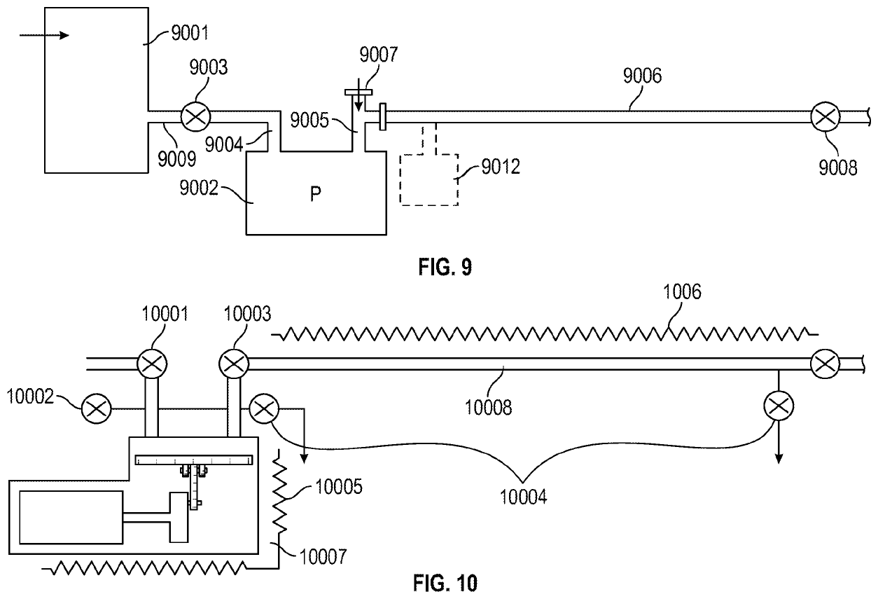

Based on the foregoing approach, practical aspects and/or considerations of significance may include the following, which are shown schematically in FIG. 8 and FIG. 9.
(1) Use of impermeable tubes such as metal tubes.
(2) Use of tubes that may be easily cleaned and/or replaced, such as stainless steel tubing, and replacing and/or cleaning the tube when it becomes contaminated. In some cases, this may include cleaning and re-installing the tube with every run (every sintering cycle, for example). In some cases, cleaning the tube may be done in situ by flushing solvent through the tube. Note that the pump may also be similarly cleaned in situ, if desired.
a. FIG. 10 illustrates relatively cleaner inlet 10004 and cleaner outlet valves 10005 that may be suitable for flushing cleaner through the pump and or the Peclet tube seal. In various embodiments, the pump inlet valve and the Peclet tube outlet valve may remain closed while cleaning solvent is flushed through the pump and or Peclet tube.
(3) Use of hermetic tube fitting at the hermetic pump housing and the Peclet seal tube outlet and any other part of the hermetic envelope of the system.
a. Swagelok fittings.
b. O-rings and KF or ASA flanges.
c. Copper gasket seals with conflat flanges.
(4) Keeping the inside of the Peclet seal tube sealably isolated from the outside, even between operating cycles when the chamber is not in service, (as described below) a. This may be achieved by including a hermetically sealed valve at the outlet of the tube.
b. This may also be achieved by continuously running pure inert sweep gas through the Peclet seal tube when the system is not in use.
(5) Maintaining a smooth laminar flow for at least a portion of the tube to compensate for pulsating action of pump.
a. This may be achieved with a ballast volume at the inlet of the tube which is shown as an option in FIG. 9 as ballast volume 9009.
b. This may be achieved by making the tube longer, such that the tube itself smooths pressure variation as the gas flows along its length. Lengthening the tube may not be necessary (e.g., in at least some applications, a length of one meter may be more than ten or even a hundred times the theoretically desired length). (If longer lengths are desired the tube may be coiled to avoid taking up excessive space.)
c. Immediately preceding techniques, for example, a and b, may be combined.

For metal and hermetically sealed tubes, such as stainless steel tubes, and Swagelok fittings a predominant practical issue may be contamination and off-gassing of the Peclet seal tube itself, particularly in the section closest to the pump. It may take hours, or even days, for moisture and other contaminants to be flushed out by Argon, a process that may be accelerated using a low cost heater, such as nichrome wire heaters, to “bake off” contaminants. The use of a hermetically sealed valve may be successful at maintaining cleanliness between runs.

It may be desirable to provide high hermiticity of the connections and the Peclet tube seal (for example, Helium leak rates less than IE-10 Torr Liters per Second TL/S) and thus, the need to replace tubes frequently, even as often as every run, may not be burdensome in most applications.

FIG. 9 depicts another embodiment pumping system. A vacuum processing system is connected to a vacuum pump system via a pumping tube 9009 which is separated from the pump inlet 9004 via a valve 9003. Pump outlet 9005 is hermetically sealed to Peclet seal tube 9006. A sweep gas source 9007 is configured to inject sweep gas into the Peclet seal tube 9006 such that the sweep gas flows through the Peclet seal tube from an inlet 9010 of the Peclet seal tube 9006 towards an outlet 9011 of the Peclet seal tube 9006 to substantially isolate against the backflow of the ambient air through the Peclet seal tube. A ballast 9012 as previously described may be employed. A valve 9008 placed at the outlet 9011 of the Peclet seal tube may be used to seal the Peclet seal tube from the ambient air as described above when sweep gas is not being injected.

Injecting gas at the inlet of the Peclet seal tube, as shown in FIG. 9, may allow the systems and methods of this disclosure to be executed even in medium vacuum systems having little or no process gas flow. Furthermore, contributions to sweep gas in the Peclet seal tube can addition be provided by from process gas and/or sweep gas injected into the pump housing. As mentioned previously, the systems and methods described herein may achieve relatively high purity without the use of relatively costly high purity pumps. These systems and methods may allow for the use of a pumping mechanism that is sufficient to provide the desired vacuum, but not necessarily capable of providing the needed isolation. Thus, the role of the pump may be largely reduced to just maintaining vacuum. In the case of FIG. 9, the job of the pump may not be diminished by the injection of gas after the pump, as long as the pressure at the point of injection is only slightly above atmospheric pressure, which may be relatively easily achieved due to the robustness of the Peclet sealing mechanism.

The systems and methods described herein may offer additional advantages in comparison to the use of serial stages and/or multiple pumps connected in series. As described above, pumps themselves may tend to limit purity as contamination builds up inside the pumping mechanisms. In many cases, stacking pumps in series can do little or nothing to overcome contamination within the pump that is directly connected to the chamber. Furthermore, best-in class-pumps may tend to be relatively sensitive to contamination and in fact may be difficult to clean. In contrast, the requirements on pumps described herein may be relatively minimal (e.g., orders of magnitude lower than the requirement in conventional approaches). Accordingly, pump systems described herein may incorporate pumps that are relatively simpler and less prone to contamination and that can be easily cleaned, or even self-cleaned, in situ. For example, for a system than runs at 10 Torr, it may be possible to employ a relatively simple Teflon coated oil free piston pump that is relatively small in size and that can be self-cleaned by circulating alcohol through the pump, as is depicted in FIG. 10.

FIG. 10 depicts another embodiment pumping system in many ways similar to FIG. 6A and the disclosure relating to FIG. 6A will be generally applicable to FIG. 10. Valve 10001 controls flow from a vacuum processing chamber (not shown) into a hermetic pump housing 10007. Valve 10003 controls flow from the hermetic pump housing 10007 to the Peclet seal tube 10008. Pump cleaning heaters 10005 and tube cleaning heaters 10006 can be activated both during and between runs to drive out moisture and other contaminants. The relaxation of performance specifications (e.g., relaxation of base pressure and/or compression ratio requirements) may increase and enhance freedom to design and/or obtain pumps that tend to remain clean and/or can be easily cleaned in situ. For example, suitable pump designs may be operated at 50 C-100 C, 100 C-200 C, 200 C to 300 C and even greater than 300 C, and these otherwise challenging pump designs may be achievable at least in part due to the relaxed specifications on base pressure, which may allow for large gaps and loose mechanical tolerances that would be incompatible with typical high performance high compression pumps.

Techniques, such as in situ solvent flush and/or in situ heating, may tend to be less practicable in high performance displacement pumps, such as rotary vane pumps, scroll pumps, and roots blowers.

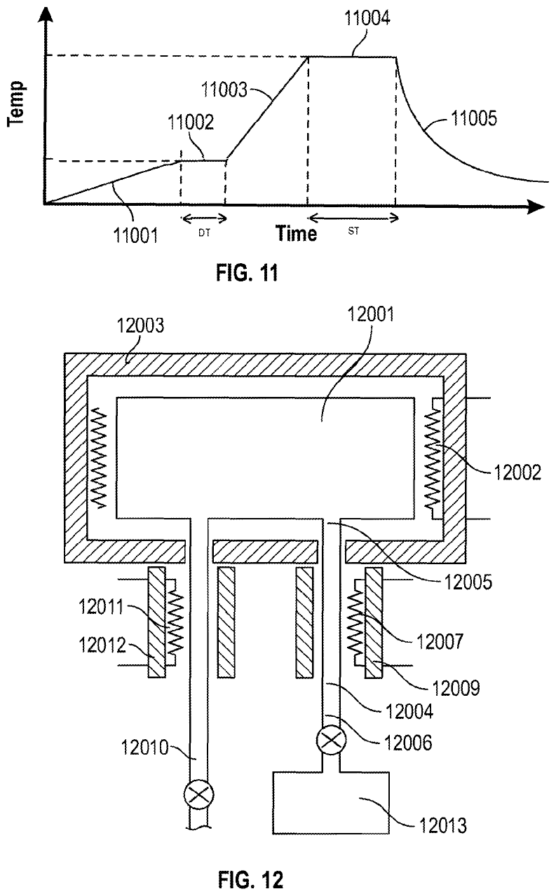

FIG. 11 illustrates a plot of processing chamber temperature (vertical axis) vs. time (horizontal axis) for the hot zone in a vacuum processing chamber of a typical two stage debinding and vacuum sintering cycle that can be executed in a vacuum processing chamber for debinding and sintering powder metal parts. The plot illustrates a ramp up 11001 in processing chamber temperature from an initial temperature (for example room temperature) to a debinding temperature 11002. In two stage debinding-sintering processes the parts can be debinded during a debinding cycle for a dwell time DT at a debinding temperature sufficient to remove binder from one or more parts in the processing chamber during which time binder byproducts can off gas from the parts. The parts processing temperature can then be ramped up 11003 to sintering temperature 11004 which can be maintained during a sintering cycle for a sintering time ST before cooling 11005 is initiated by controllably lowering the power and/or de-activating furnace heaters. It is to be emphasized that this disclosure relates generally to low cost to vacuum atmosphere and not atmospheric pressure. With respect to the descriptions for metal sintering it is to be emphasized that high purity is often desired during the sintering cycle and may or may not be important during debinding. For debinding (as opposed to sintering) it should be understood that the multi-step sintering systems and methods in this disclosure can be configured to operate during the debinding cycle at any pressure including vacuum, atmospheric or even slight positive pressure. The emphasis throughout these descriptions is upon sintering systems and methods that minimize or eliminate the presence of oxygen and debinder byproducts during sintering and only optionally eliminate oxygen (or other contaminants) during debinding. For example, in the case of certain steels it may be acceptable for the chamber atmosphere to have high oxygen content during debinding but not during sintering. On the other hand, for titanium and/or aluminum sintering it may in some cases be important to maintain ultra-low oxygen levels during debinding as well as during sintering. It must be further understood that in all cases within this disclosure that describe powder metal sintering, the debinding systems and methods described are configured such that the system and method can minimize and/or prevent condensation of debinding byproducts within the vacuum chamber and any portions or extensions of the vacuum processing chamber including inlet and outlet tubes. While the foregoing description focuses on a two-step process it should be appreciated that many variations are possible including a plurality of steps divided between multiple time spans and there are many possible variations in which debinding is performed prior to sintering and for which debinder byproducts can be eliminated or minimized to below a predetermined threshold. The forgoing description focuses on a simple example and in should be understood that in addition to multiple steps there can be cases where temperatures can be controlled to vary continuously in complex ways within a predetermined range throughout a given time span for example responsive to open and/or closed loop process controls. For example, in some cases debinding temperature can be feedback controlled to vary within a predetermined range responsive to continuously measured variations of pressure increase due to debinding. In many cases the predetermined threshold requires that there be no observable or measurable residue of debinder products within the chamber or the tubes at least during the sintering cycle. Applicants routinely achieve this threshold using the systems and methods described herein. Again, is to be yet further emphasized that for non-sintering applications and processes including semiconductor processing and other vacuum processing processes not related to metal sintering, the systems and methods described herein for achieving ultra-high purity and for reducing condensation of various contaminants can be applied.

FIG. 12 includes a schematic embodiment of a vacuum processing system including a vacuum processing chamber 12001 in which parts can be processed, furnace (or oven) heaters 12002, and thermal insulation 12003. The vacuum processing chamber 12001 includes a pumping tube 12004 having a pumping tube inlet 12005 and pumping tube outlet 12006 and the pumping tube 12004 can optionally be heated with a heater system 12007 which may be a tube heater and optionally insulated with tube insulation 12009 in order to eliminate and/or reduce condensation within the pumping tube 12004 of contaminants, including but not limited to debinder by-products, to a predetermined threshold. In many cases the predetermined threshold is simply that no visibly or nasaly detectable or otherwise humanly observable buildup of residue remains within the chamber or the tubes. Applicant routinely achieves this remarkable threshold result and additionally is often unable to chemically or microscopically measure any clear presence or influence of debinder byproducts within out-processed parts. Applicants knows of no other sintering furnace equipment that is able to achieve such a low threshold for condensation in all portions of the processing chamber and also simultaneously in pumping tubes during and therefore following debinding processes. The vacuum processing chamber 12001 can also include an inlet tube 12010 that can be heated with an inlet tube heating system 12011 and that can optionally be insulated with inlet tube insulation 12012. The inlet tube 12010 can be utilized for injecting process gas which in turn can contribute to serve as Peclet sealing sweep gas in one or both cases: (i) when it is exhausted through the pumping tube 12004 and/or (ii) when it contributes to sweep gas flow of a Peclet tube seal at the outlet of a hermetic pump (not shown) such as the pumps systems of FIG. 6A-6C.

The embodiment of FIG. 12 can be operated in accordance with many different processes for many different purposes and applications where high purity and low condensation is desired. As described above the process gas can be injected into the vacuum processing chamber 12001 through one or more input tubes 12010 and depending on vacuum pressure and depending upon the diameter of the pumping tube 12004 the process gas may act as a sweep gas in the pumping tube 12004 to provide at least some degree of Peel et sealing. In many cases, as described above this Peclet sealing can achieve ppm or even ppb or better isolation between the outlet 12006 and the inlet 12005 of the pumping tube 12004. For example, Applicant routinely operates a ⅛″ to ⅜″ diameter pumping tube 8″ long with 1-3 slm of process gas flow to achieve ppm and ppb levels of purity. For various combinations of process gas flow rate, tube length, tube diameter and vacuum pressure, the pumping tube 12004 can provide for excellent Peclet sealing of parts per million or better and even parts per billion. For example, in the context of a 10 liter chamber Applicants routinely demonstrate Peclet sealing, of the inlet relative to the outlet, of ppm to ppb at chamber vacuum pressures in the range 5 Torr-100 Torr for a pumping tube having a ⅜″ Inner diameter pumping tube 8″ long and with 0.5-5 slm of process gas flow serving as the Peclet sweep gas. As described above in reference to FIGS. 7 and 8 it is readily possible to estimate Peclet sealing over these pressure ranges as long as conditions for laminar flow are maintained.

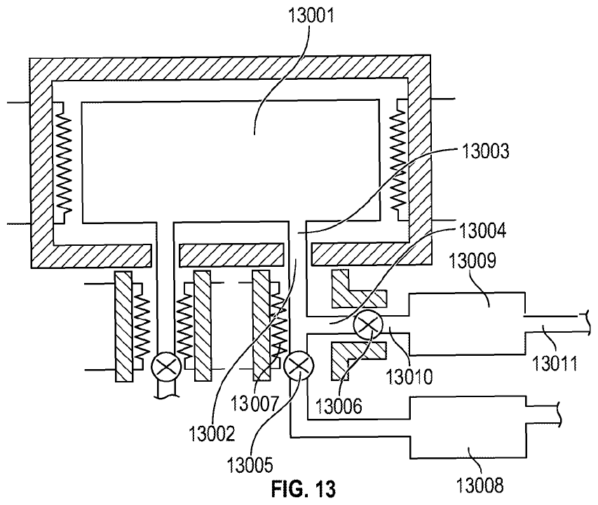

While the embodiment of FIG. 12 can be applied to many applications, Applicants recognize that it can provide for especially remarkable advantages in the context of two stage debinding and sintering applications for example in sintering of metals and/or ceramic powders including for aluminum sintering and titanium sintering. In various methods during debinding the chamber maintains debinding temperature while the pumping tube 12004 and/or the inlet tube 12010 can be simultaneously heated somewhat below, at, or even above debinding temperatures so as to prevent or reduce condensation of binder within the inlet tube 12010 and the pumping tube 12004. For a given binder material Applicant often empirically establishes a condensation threshold temperature for avoiding humanly observable (i.e. by eye, touch, and smell) condensation and sometimes that threshold temperature is below the actual debinding temperature. In such cases Applicant often controls one or more of the tube heaters to ensure that the tube temperature remains above that empirically established condensation threshold temperature. For example, for certain binders Applicant performs the above mentioned lab tests for measuring condensation threshold temperature to be in a range between 300 C-400 C and then routinely debind various bound powder metal parts at debinding temperatures of 400 C-500 C with the pumping tube heated to a temperature between 300-400 C. In these cases, Applicant has yet to detect evidence of any condensation whatsoever. In other cases, the design threshold for overheating the tube connectors is greater than 500 C and Applicant employs air debinding at roughly 300 C while maintaining the tubes at or above this temperature to very thoroughly prevent condensation therein to within empirically established thresholds. This has enabled Applicant to provide for vacuum sintering of metals that are highly susceptible to oxygen as well binder contamination, including even sintering high quality Aluminum alloys. Remarkably Applicant has achieved excellent powder aluminum sintering at pressures between 10 Torr and 400 Torr using the 8″ pumping tube described above. Aluminum alloys are generally thought to be among the most sensitive and difficult to sinter metals at least for the reason that it oxidizes easily such that even ppm levels of oxygen tend to frustrate sintering. Our success at sintering aluminum alloys in these systems using these methods can be regarded as a testimony to the remarkable advantages thereof. It is noted that in many cases a low cost low performance and even a highly contaminated vacuum pump can be employed to pump on the outlet on the pumping tube and yet by following the guidelines described above with respect to FIGS. 7 and 8 it is possible to achieve ppm or even ppb and better Peclet isolation for vacuum pressures between 10 and 100 Torr or higher. In cases where lower pressures or larger diameter tubes are needed or desired other embodiments such as that of FIG. 13 can be employed.

In some embodiments, the system of FIG. 12 operates as a furnace system for powder metallurgy with reduced contamination. The vacuum processing chamber 12001 is configured to perform a debinding cycle at a debinding temperature sufficient to debind at least one part such that debinding by-products are off-gassed from the least one part. The debinding cycle can be followed by a sintering cycle at a sintering temperature that is higher than the debinding temperature. The vacuum processing chamber 12001 has a pumping tube 12004 having an inlet end 12005 that is sealed to the vacuum processing chamber 12001 and an outlet end 12006 that is separated from the vacuum processing chamber 12001 by the pumping tube 12004. The heating system 12008 includes at least one heater configured to heat the pumping tube 12004 at least during the debinding cycle to at least a temperature sufficient to reduce condensation of contaminants within the pumping tube 12004, including the debinding byproducts outgassed from the vacuum processing chamber 12001 during the debinding cycle, to a predetermined threshold. A pumping system 12013 is sealed to the outlet end 12006 of the pumping tube 12004 and is configured to produce a vacuum in the vacuum processing chamber 12001. A process gas source (not pictured in FIG. 12, but pictured in FIG. 6A) is configured to inject a sweep gas into the vacuum processing chamber 12001 at least during the sintering cycle such that the pumping tube 12004 provides an amount of Peclet sealing during sintering.

FIG. 13 illustrates an embodiment similar to that of FIG. 12 that can provide yet further advantages especially for multi-step processing including in the context of multi-step processes such as debinding-sintering furnaces. In this system the outlet of the pumping tube 13002 is sealed to a first heated debinding valve 13005 that is sealed to the inlet of a debinding pump 13008 and a heated sintering valve 13006 that can be sealed to the inlet of a sintering pump 13009 including but not limited to a low cost high purity pumping system as described previously with reference to FIGS. 6A, 6B and elsewhere throughout this application. In this embodiment the high temperature hot valves 13005 and 13006 can be heated by the same heater system 13007 that is relied upon to heat the pumping tube 13002. During debinding the heating of the pumping tube 13002 and the hot valves 13005 and 13006 substantially reduces and/or prevents condensation of binder by-products inside the pumping tube 13002 and inside the valves 13005 and 13006. Many variations are possible within the scope of this disclosure. For example, two pumping tubes can be employed with the debinding hot valve sealed to the outlet end of a first pumping tube and the sintering hot valve sealed to the end of a second pumping tube.

This embodiment can provide benefits in many multi-step processing applications. For example, it can be configured to operate as a furnace system for metal powder metallurgy with reduced contamination. A vacuum processing chamber 13001 is configured to perform a debinding cycle at a debinding temperature sufficient to debind a part such that debinding by-products are off-gassed from the part. The debinding cycle can be followed a sintering cycle at a sintering temperature that is higher than the debinding temperature. The vacuum processing chamber 13001 has a pumping tube 13002 having an inlet end 13003 that is sealed to the vacuum processing chamber 13001 and an outlet end 13004 that is separated from the vacuum processing chamber 13001 by the pumping tube 13002. There is a first valve 13005 arranged as a debinding valve to be open during for debinding and a second valve 13006 arranged as a sintering valve to be opened during sintering, each of which is sealed to the outlet 13004 of the pumping tube 13002. A heating system 13007 includes at least one heater configured to heat the pumping tube 13004, the first valve 13005 and the second valve 13006 at least during the debinding cycle to at least a temperature sufficient to reduce condensation of contaminants within the pumping tube 13002 and within the first valve 13005 and the second valve 13006, including the debinding by-products outgassed from the vacuum processing chamber 13001 during the debinding cycle, to a predetermined threshold. A first vacuum pump system 13008 (a debinding pump) is arranged as a debinding pump to be pumping during debinding and is connected to the first valve 13005 (the debinding valve). The first vacuum pump 13008 is for pumping on the vacuum processing chamber 13001 during debinding through the pumping tube 13002 by way of the first valve 13005. A second vacuum pump system 13009 (a sintering pump) is connected to the second valve 13006 (the sintering valve). The second vacuum pump 13009 is for pumping on the vacuum processing chamber 13001 during sintering through the pumping tube 13002 by way of the second valve 13006. The second vacuum pumping system 13009 can include a second mechanical vacuum pump mechanism within a hermetic pump housing configured to hermetically isolate the second mechanical vacuum pump mechanism from ambient air outside the hermetic pump housing. The second vacuum pump system 13009 includes a second pump inlet 13010 connected to the second valve 13006 and a second pump outlet 13011. The second pump outlet 13011 can be hermetically sealed to an inlet of a Peclet seal tube in accordance with the above descriptions for example for FIGS. 6A-C. A sweep gas source is configured to inject a sweep gas into the second hermetic pump housing and or the inlet of the Peclet seal tube (as shown in FIG. 6B and FIG. 9). A process gas source may be configured to inject process gas into the vacuum processing chamber 13001 (as shown in FIG. 6A). The sweep gas flows through the Peclet seal tube from the inlet of the Peclet seal tube towards an outlet of the Peclet seal tube to substantially isolate against the backflow of the ambient air through the Peclet seal tube. A controller can be configured to, during at least a portion of the debinding process, cause the first valve 13005 to be in an open position and the second valve 13006 to be in a closed position and operate the first mechanical vacuum pump 13008 to produce a vacuum in the vacuum processing chamber 13001. During at least a portion of the sintering process, the controller is configured to cause the first valve 13005 to be in a closed position and the second valve 13006 to be in an open position and operate the second mechanical vacuum 13009 to produce a vacuum in the vacuum processing chamber 13001.

Applicants do not intend the forgoing embodiment (system and method) to be limiting and many variations are possible including for example the use of air debinding to “burn off” binder during debinding at atmospheric pressure in which case the same functional advantages are brought to bear including prevention of condensation and Peclet isolation during sintering. A person of ordinary skill in the art having the advantage of this description in hand can be expected to engineer many modifications to allow for different debinding cycles yet maintain the scope with respect to high purity and low condensates during sintering. Furthermore, as will be described later for example in reference to FIG. 22, the above described combination of a heated pumping tube with multiple heated valves and pumps can result in sweeping benefits when applied to a wide range of furnace and vacuum processing systems.

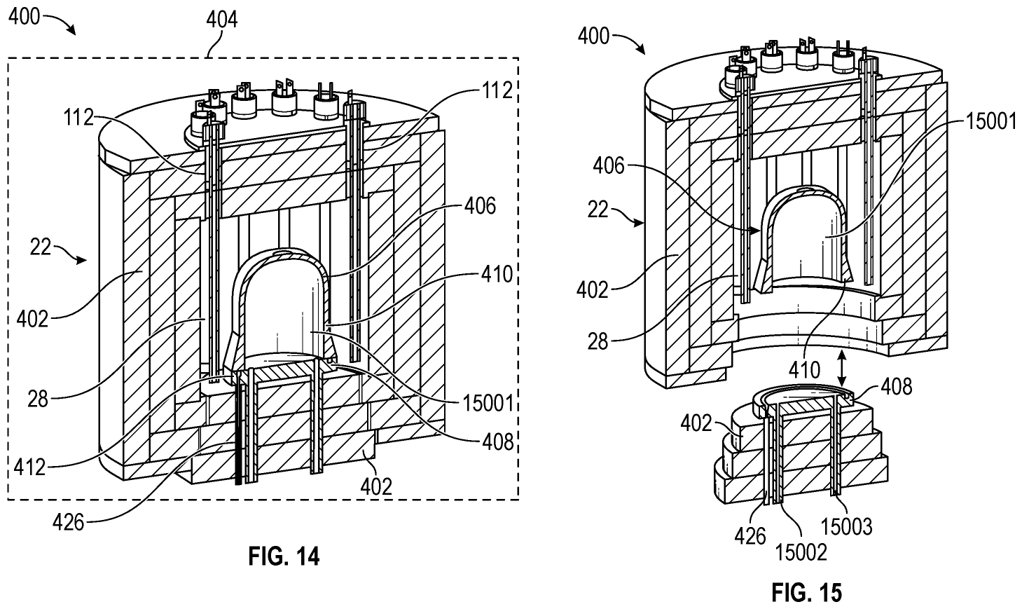

FIGS. 14 and 15 illustrate details with respect to one embodiment that can be applied to the systems of FIGS. 12 and 13. A furnace 400 includes heaters 112 and insulation 22. The furnace 400 can includes an optional protective cover 404 that could be merely a mechanical shield but can also optionally be arranged to be at least somewhat sealed for containing somewhat pure and somewhat oxygen free gas in the manner of a glove box and in some cases could be arranged as a somewhat sealed vacuum chamber. A hot zone 28 heats a vacuum retort 406 that includes a retort body 410, a retort base 408 and a retort seal 412.

The system is shown in the closed and sealed position in FIG. 14 and in the open position in FIG. 15 for loading and/or unloading parts. The system includes a vacuum processing chamber 15001 with inlet tube 15002 and extreme temperature pumping tube 15003 integrally sealed thereto by welding (in the case of metal chambers) and monolith bonding and/or forming in the case of ceramics. In this embodiment the pumping tube can be regarded as “extreme temperature” tube insofar as the input end of the tube is presumed to be operable at sintering temperatures far above debinding temperatures. As will be described in further detail, during debinding we routinely run the entire length of inlet and pumping tubes well above 200 C and typically between 300 C and 500 C in order to prevent condensation and/or contamination of the inside of the tubes during debinding. During sintering portions of both tubes operate at far yet higher temperatures as compared to debinding temperatures. Furthermore, as will be described in detail in appropriate portions of this disclosure, we have designed the extreme temperature pumping tube 15003 with long enough length and small enough inner diameter to achieve ppm and better Peclet isolation against gaseous contamination at the inlet of the pumping tube from the outlet. In conjunction with the main retort seal described immediately below, the use of Peclet sealing, high temperature during debinding and extreme temperature during sintering in the pumping tube 15003 has contributed to our success at routinely producing ultra pure atmosphere as we utilize non-porous sintered SiC chambers in accordance with the design illustrated here that are routinely operated at temperatures up to 1500 C. Applicant can successfully sinter Aluminum alloys in low cost embodiments of FIGS. 14 and 15 using low cost ceramic for the chamber and/or low cost high temperature steel. It is emphasized that the processing chambers 150001 illustrated in FIGS. 14 and 15 can be arranged to serve as a vacuum chamber in the absence of any other external vacuum chamber. In these embodiments it can be advantageous that the chamber material should be non-porous and impermeable to gases especially outside air that in some embodiments directly surrounds vacuum processing chamber 150001. In other embodiments as will be described in reference to FIG. 22 below, the same or similar structure can be utilized as a retort within an external vacuum chamber and it may be acceptable that the retort material can be somewhat porous and permeable within acceptable limits. In such embodiments, though we have not pursued them as of yet, the retort may serve as a partial vacuum chamber in cases where some pressure difference can be developed intentionally or otherwise between the inside and the outside of the retort. In yet other embodiments the chamber may serve as a vacuum chamber and can be surrounded by gas at atmospheric pressure with an external chamber that at least acts as a glove box for blocking oxygen from outside air. In general, we have found no need as of yet and we have uncovered no application that would require us to include a glove box around the insulation and we routinely run with outside ambient air directly surrounding processing chamber 150001.

In other embodiments at high sintering temperatures above 800 C Applicant routinely sinters high quality titanium in an embodiment of FIGS. 14 and 15 using a SiC chamber (or retort) 406 with SiC heaters and high-grade high temperature insulation suitable for operation up to 1500 C. In particular Applicant has built multiple embodiments using sintered alpha phase SiC with sintering chamber sizes in excess of 1.5 cubic feet. Applicant is presently preparing for the purchase of a system with a sintered alpha SiC chamber (or retort) according to the designs of FIGS. 14 and 15 having a 4 cubic foot volume therein as the vacuum processing chamber. Applicants have successfully pursued the purchase at reasonable cost of such chambers despite a great deal of advice that such parts could not and would not be available except at exorbitant and commercially impractical prices. In this regard Applicant considers that it is surprising as well as remarkable to demonstrate vacuum sintering furnaces in accordance with these descriptions that operate at 1500 C with volumes greater than 1.5 cubic feet. Furthermore, such furnaces, for example configured in accordance with FIGS. 14 and 15 having several cubic feet of volume can be expected to demonstrate sweeping technical and commercial advantages relative to conventional industrial sintering furnaces.

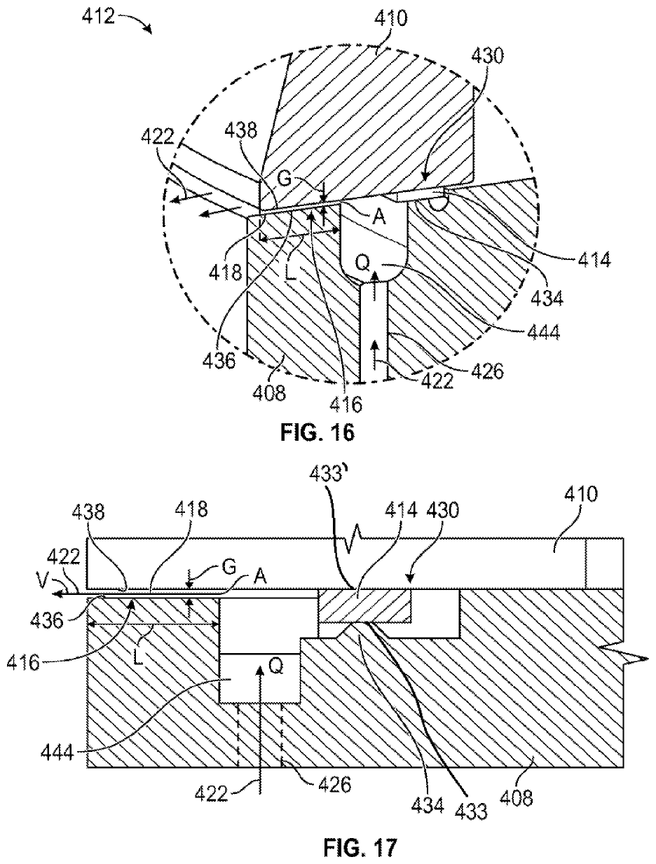

FIG. 16 illustrates a main retort seal that can be utilized in various embodiments herein including that of FIGS. 14 and 15. It is noted that the term retort and chamber are interchangeable in the context of these descriptions and in many applications Applicant routinely uses this retort as a vacuum chamber with no external vacuum chamber other than the retort itself such that the retort is surrounded by outside ambient air. In such configurations the retort acts as a vacuum chamber and serves as the processing chamber 12001 and 13001 as represented in FIGS. 12 and 13. It is noted that the system of FIG. 14 and FIG. 15 can be operated as one embodiment of the systems and methods schematically illustrated in FIGS. 12 and 13. A retort and/or vacuum chamber body 410 has a main retort seal system 412 at a retort base 408. The retort and/or chamber seal 412 includes an internal seal 430 such as a high temperature gasket and an external seal 416 such as the Peclet gap seal illustrated in the figure. The high temperature gasket can be a gasket 414 biased against a gasket ledge 434 that can protrude upward for easy access when grinding gasket sealing surface 433. It is noted that that there is no requirement for the gasket ledge to protrude upward as long the gasket surface (preferably precision ground) is present for supporting the gasket to be compressed thereagainst the gasket sealing. For example, for metal sintering using a non-porous sintered alpha SiC chamber Applicant routinely utilizes graphoil at temperatures up to 1500 C or even higher in some cases. Graphoil gaskets tend to be leaky as compared to conventional elastomeric vacuum o-ring gaskets and Applicant has found it challenging to identify any high temperature and extreme temperature gaskets that are cost effective and operate above 400 C without detectable and unacceptable leak rates. Applicant can eliminate and detectable air leakage through the gasket leakage into the chamber by arranging for a double seal that includes an external Peclet gap seal 416 isolates the internal seal from the outside ambient air and that can provide for ppm or even ppb isolation within the groove such that outside air is isolated from the gasket such that the leak becomes inconsequential to purity within the chamber. In other words, if there is no detectable outside air in the groove than leakage from the groove into the chamber can become inconsequential. The Peclet gap seal operates in accordance to the principles described above in reference to FIGS. 7 and 8: a sweep gas tube 426 can inject sweep gas 422 into a Peclet gap 418 formed between defining faces 436 and 438 that allows the sweep gas to flow freely into the Peclet gap such that these surfaces can be regarded as Peclet sealing surfaces that face one another with gap G as a spacing therebetween. This can ensure high purity within groove 444 such that the gasket leak does not affect the process at least for the reason that the leak only consists of highly pure oxygen-free process gas. For example, with a gap thickness 418 of 0.005″ and a sweep gas 422 flow of 2 slm of Argon Applicant routinely observes ppm and even ppb isolation for a gap width of roughly ½″ as will be described in greater detail with reference to FIG. 17.

FIG. 17 is a schematic of the previously described high temperature chamber and/or retort sealing arrangement including an internal non-hermetic gasket seal 414, sandwiched between gasket sealing surfaces 433 and 433′, and an external Peclet gap seal 416 having a gap size G and a gap length L such that a cross sectional area A of the Peclet seal can be estimated as the product of groove 444 perimeter (circumferential for round chambers) times gap height G. Sweep gas 422 can be introduced by way of a hermetically sealed sweep gas feed tube 426 and such that the sweep gas flows into groove 444 and then through the Peclet gap to provide isolation with respect to outside atmosphere such as outside air. The principles and equations described with respect to the Peclet seal (FIGS. 7 and 8) are directly applicable with Area A being a cross sectional area of the gap perpendicular to the direction of sweep gas flow Q (gap size G multiplied by the circumference of the groove 444). As mentioned in the discussion with respect to FIG. 7 the gap here is defined by parallel Peclet sealing surfaces 436 and 438. It is noted that the groove 444 can be arranged to have sufficient cross sectional area such that sweep gas enters the Peclet gap at approximately uniform pressure around the entire circumference (it is noted that for a thin gaskets of less than 0.030″ this condition will generally not be met without a groove). A person of ordinary skill in the art having this disclosure in hand can readily design a groove that provides for highly uniform feed pressure throughout the entire Peclet gap.

In general applicants recognize that it can be difficult, costly and/or impractical to obtain or employ a single conventional vacuum sealing gasket for high temperature operation for temperatures above 300 C where elastomers tend to degrade and especially for temperatures above 400 C where even expensive and state of the art metal vacuum seals can begin to fail. However, applicants recognize that imperfect “leaky” gaskets such as graphoil are readily available at low cost and Applicant developed the above high performance double seal arrangement in order to use a leaky gasket and nevertheless achieve ppm and even ppb isolation between the inside of a chamber and the surrounding atmosphere including but not limited to outside ambient air. For chambers having volumes between 0.25 cubic feet at 4 cubic feet Applicant can readily achieve ppm and even ppb or better chamber isolation, relative to outside ambient air, using a Peclet sweep gas between 1 to 5 slm a gap size of 0.003-0.012″ through the outer Peclet gap seal.

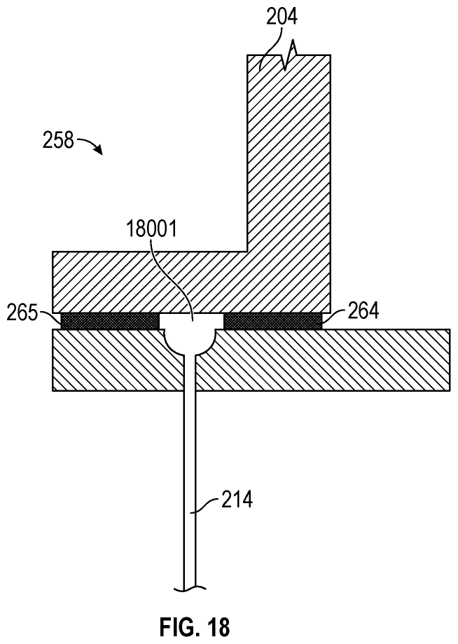

FIG. 18 schematically illustrates another embodiment of a seal arrangement with a retort and/or chamber body 204 and a high temperature double seal 258 including an inner gasket seal 264 and outer gasket seal 265 with a space 18001 therebetween that can employed for sweeping away at least some of any outside air, contamination or gas that leaks through the outer gasket into the gap. For example, 1 slm of sweep gas (such as Argon or Nitrogen) can be introduced through a sealed tube 214 and pumped away from a separate tube (not shown) at an opposing side of the chamber. In another embodiment one or more tubes can be utilized for vacuum pumping of the gap to pump away at least some of any outside air, contamination or gas that leaks into the gap. It is noted that the inner and outer seals of FIG. 18 could be arranged within embodiments similar to of FIG. 16 and FIG. 7.

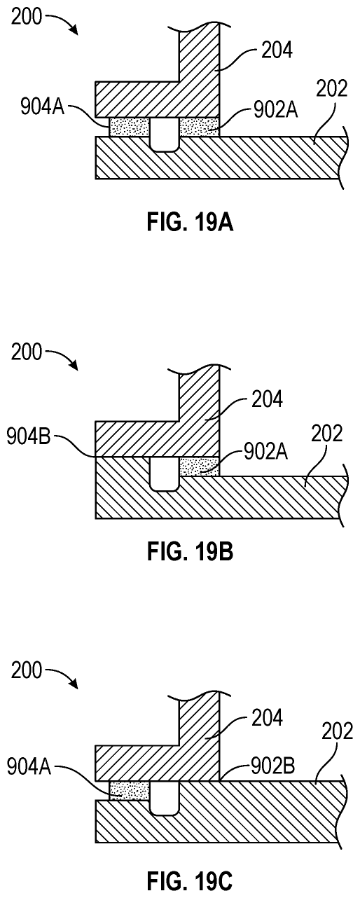

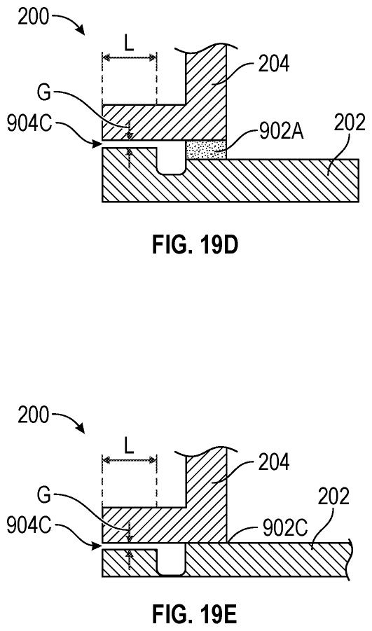

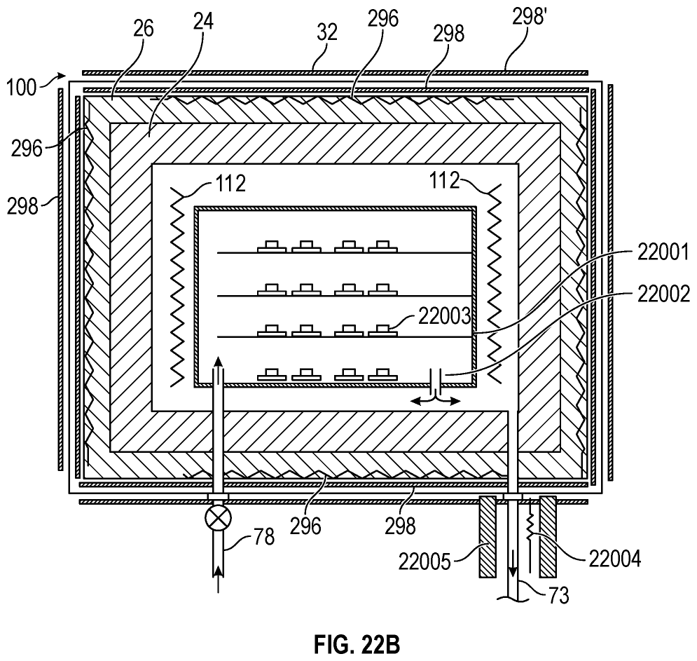

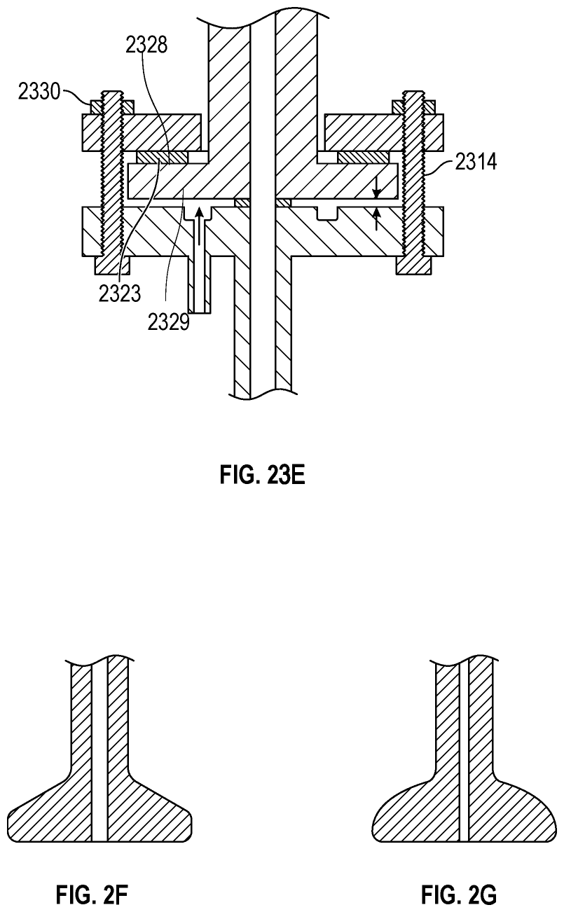

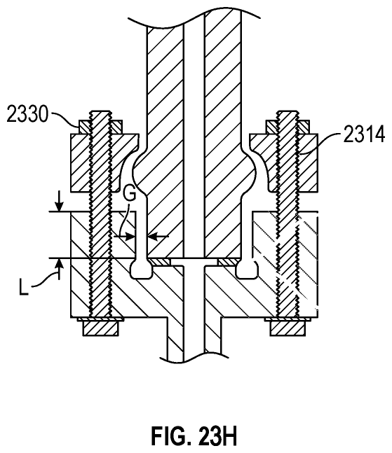

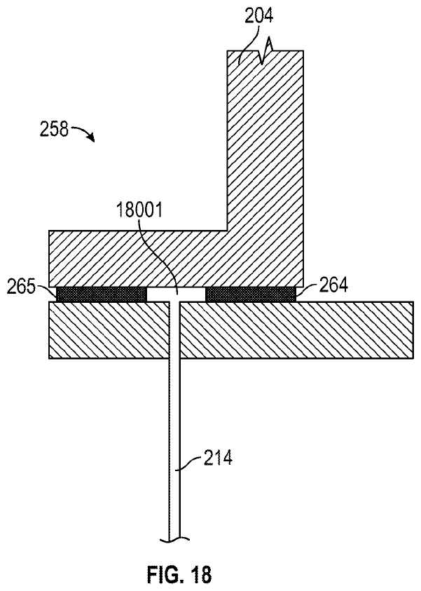

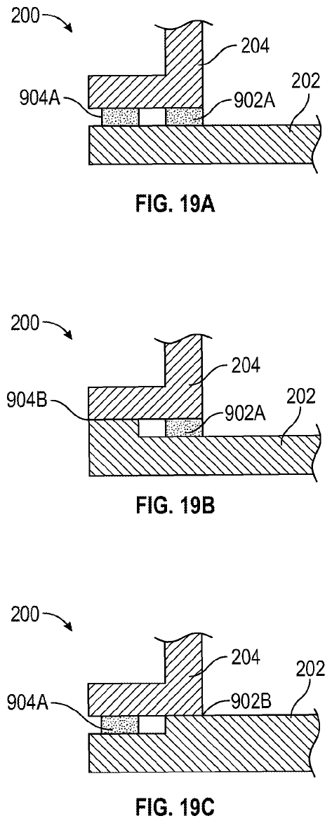

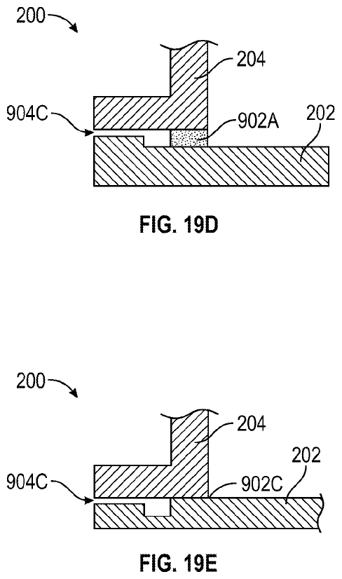

FIGS. 19A-19E are cross-sectional views of portions of exemplary retort and/or vacuum chamber configurations 200 that represent embodiments of double seals that may be implemented with a vacuum processing chamber to seal a retort body 204 to a base 202. In each of FIGS. 19A-19E, a left side represents an outside of the chamber, which may be any environment immediately surrounding the retort and/or vacuum processing chamber. In each of FIGS. 19A-19E, the seal on the right represents an internal seal (902A, 902B, 902C), and the seal on the left represents an external seal (904A, 904B, 904C). In each of the exemplary configurations illustrated in FIGS. 19A-19E, and also in FIG. 18, the chamber may include a groove (indicated with dotted lines) (allowing sufficient conductance for sweep gas flow or vacuum pumping) between the seals and/or the gaskets may be sufficiently thick (e.g., about 0.05 inch to about 0.1 inch) to create a space between the seals such that no groove is required. Contact seals often called “lap seals” may be formed by opposing surfaces in direct contact with one another. Lap seals may generally be formed by contact between surfaces that have been machined and/or ground to a relatively high degree of flatness. For example, in the case of metal chambers such as SiC chambers, flatness may be about 0.001 inches to about 0.0005 inches, about 0.001 inches to about 0.002 inches, etc. In the case of SiC or other ceramic retort materials, the flatness of lap seals or lap joints may be about 0.0001 inches to about 0.0005 inches, or about 0.0005 to about 0.0015 inches. It is emphasized that in all cases 19A-19E a sweep gas or vacuum pumping can be applied as described with reference to FIG. 18.

As shown in FIG. 19A, internal seal 902A and external seal 904A may each be gasket seals. With reference to FIG. 19B, internal gasket seal 902A may be combined with an external lap seal 904B. FIG. 19C illustrates an inner lap seal 902B positioned internally with respect to an external gasket seal 904A.

FIG. 19D illustrates an inner gasket seal 902A positioned internally with respect to a external Peclet gap seal having a Peclet gap 904C in accordance with the Peclet seals described above (e.g., with respect to FIGS. 14-17) having a gap thickness G and a Gap Length L. FIG. 19E illustrates an inner lap seal 902C positioned internally with respect to external Peclet gap 904C. Regarding the configurations of FIGS. 9D and 19E, Peclet sweep gas may be applied in the groove or space in accordance with previous descriptions of Peclet sealing. In each configuration including a gasket (e.g., gasket 902A, 904A), the gasket may be a graphoil gasket or another suitable high-temperature gasket, such as ceramic felt or fiber. Although not illustrated, here one or more additional outer seals may be included to form a third, a fourth (or more), inner and/or outer seals.

Having discussed techniques for providing hermetic sealing at extreme temperatures for example in ranges above 800 C and high temperatures above 300 C and below 800 C, it is noted that the high temperature sealing techniques described above and those described below with respect to high performance tube furnaces can also be employed for providing ceramic tube to metal seals and/or metal tube to metal seals for example at the outlet end of the pumping tube. Scaled down smaller diameter designs are routinely being employed by the Applicant to seal the ends of both the inlet and outlet tubes as well as the outer end of the Peclet feed tubes. The same designs and principles are found to scale down and miniaturize easily such that 1″ diameter to 2″ diameter tube seals are routinely and successfully produced for example using an internal graphoil seal and an external Peclet gap seal. It is noted that the amount of sweep gas required to achieve ppm or ppb and better performance tends to be very low compared to the sweep gas requirements for the chamber seal, and Applicant routinely provides for state of the art leak free joints passing at <1E-10 Torr liters/sec of Helium leak rate and Applicant routinely does so using only 0.1 slm of sweep gas. It is further noted that Applicant routinely fabricates high temperature valves (for example the hot valves in FIG. 13) that are built of all metal and ceramic construction. Commercial high temperature valves typically avoid the use of elastomers in and around the valve seat and often they include a very long valve stem with an elastomeric seal that is spatially distance from the hot valve seat and operates at temperatures under 300 C. Such high temperature valves are readily available and can be custom designed by persons skilled in the art of valve design and fabrication.

Applicants recognize that the techniques described above can be utilized to great advantage by modifying various conventional furnaces to add the features described herein. For example, as will be described immediately below, remarkable performance advantages can be achieved by applying these teachings to otherwise conventional tube furnaces.

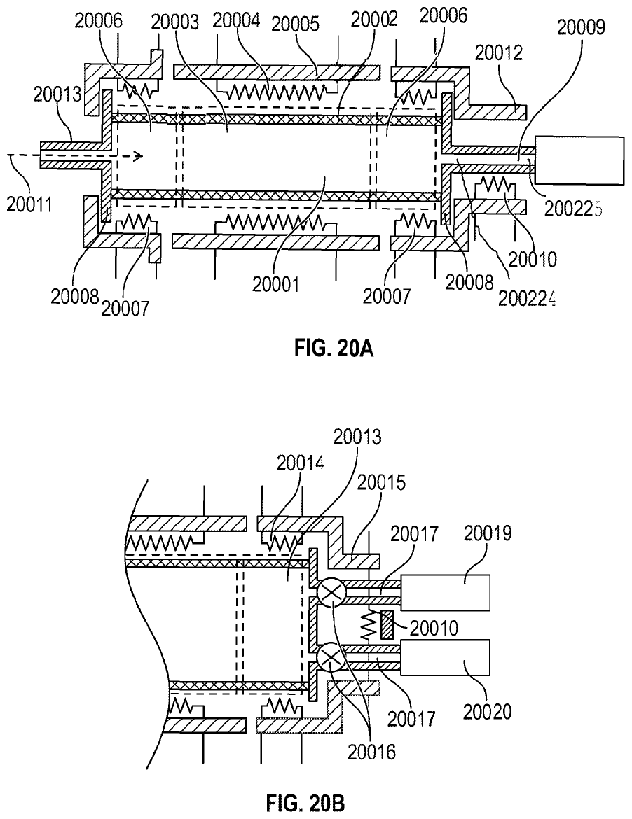

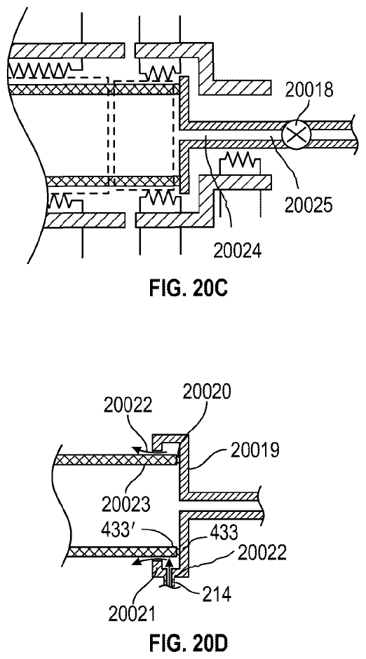

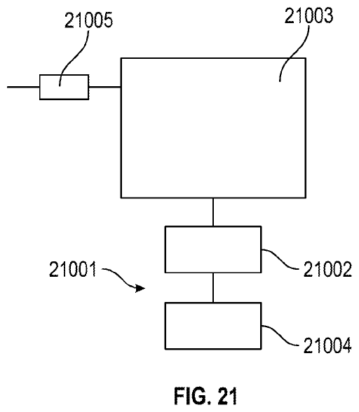

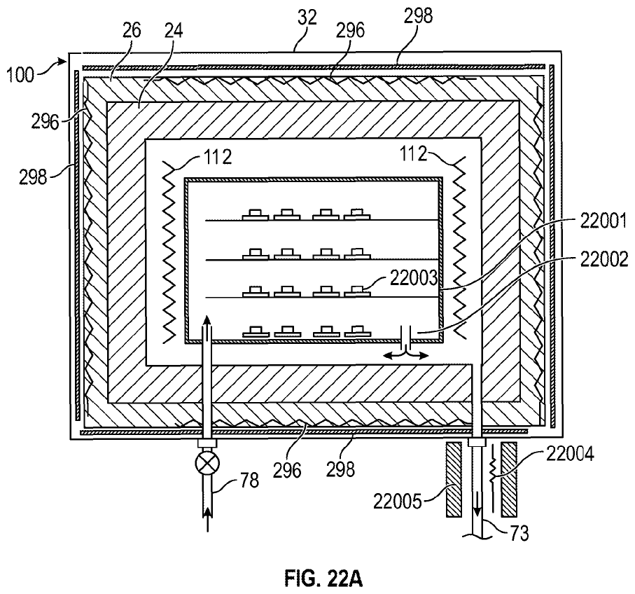

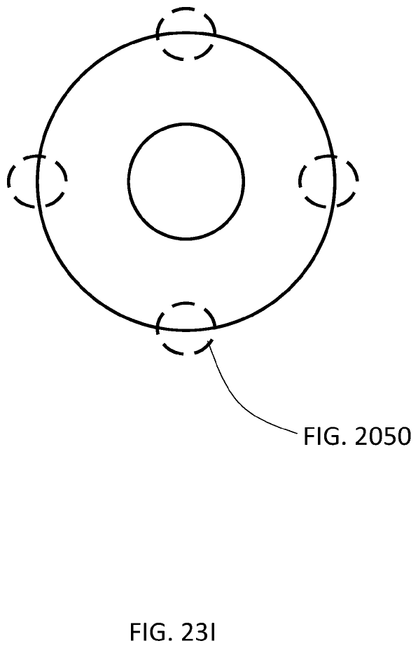

FIG. 20A illustrates an embodiment of an advanced high-performance high-purity processing chamber based in part on tube furnace technology that can be useful in many applications including but not limited to two stage debinding and sintering applications (i.e. FIG. 11). The system includes a vacuum processing chamber 20001 within a ceramic or metal tube 20002 spanning a central tube portion 20003 that is surrounded by extreme temperature furnace heaters 20004 and extreme temperature furnace insulation 20005, capable of withstanding sintering temperatures, with chamber extensions 20006 extending in two directions (for double ended tube furnaces) having the same or similar cross sectional shape and area as the vacuum processing chamber 20001. It should be understood that the central portion of the tube and the extensions can all be part of one single tube, and we can nevertheless designate these portions of the tube using different terms for descriptive purposes. For the case of a tube furnace the cross-sectional area and shape is substantially the same give or take a degree of distortion intentioned or otherwise in the tube.

Applicant has operated such tube furnaces with one or two additional high temperature extension heater systems 20007 surrounding one or both ends of the processing chamber that can heat the chamber extensions 20006 at one or both ends at least during debinding to prevent or at least reduce contamination of binder by products within the chamber extensions including one or more sealed high temperature end caps 20008. The extension heaters 20007 can heat the extensions 20006 and end caps 20008 based on the principles previously described in reference to tube heaters for heating pumping tubes, to prevent or at least minimize condensation therein of debinder byproducts below a predetermine threshold. These measures can ensure cleanliness at least with respect to debinder byproducts as well as other contaminants, after debinding and during sintering, of the atmosphere within the vacuum processing chamber. As was described previously with respect to FIGS. 12 and 13, the furnace can include a high temperature pumping tube 20009 that is configured in accordance with above teachings such that it can be heated with a high temperature pumping tube heater 20010 and optionally surrounded by high temperature tube insulation 20012 in order to prevent or reduce contamination of binder products during debinding. Furthermore, as was the case in those embodiments, the high temperature pumping tube 20009 can be configured with sufficiently small diameter and long enough length to provide for a at least some predetermined degree (based at least on principles and teachings of FIGS. 7 and 8 and described in more detail hereinafter) of Peel et sealing provided sufficient flow of process gas 20011 is injected in the inlet tube 20013 of the system. In the context of the previous descriptions (for example FIGS. 12 and 13) the arrangement of FIG. 20A can be regarded as a furnace system with the processing chamber (in this embodiment central to the tube as central portion 20003) capable of extreme temperature operation for example during sintering, and transitioning to chamber extensions 20006 (in this case at the inlet and outlet) having the same or similar cross sectional area as the central tube portion 20003 and the chamber extensions 20006 can be heated by a high temperature heating system 20007 configured to heat them at least during debinding to prevent condensation therein including within the caps. While extreme temperature conventional tube furnaces are routinely employed for powder metallurgy including for debinding as well as sintering, commercially available tube furnaces are typically prone to contamination by air as well as by binder byproduct. Furthermore, conventional tube furnaces often rely on elastomeric seals that are non-hermetic at least insofar as they allow significant diffusion of oxygen therethrough which limits purity of sintering atmosphere inside the tube. By contrast the systems and methods described herein have been demonstrated to provide for tube furnaces with sintering atmospheres orders of magnitude more pure than those sealed with conventional non-hermetic elastomeric seals. In general, the systems and methods escribed herein are able to provide for sufficiently high degree of atmospheric purity that we regard conventional elastomeric o-rings and askets as non-hermetic. We recognize that porous materials such as graphoil are so can be so permeable as to be regarded by practitioners of vacuum technology as demonstrating gross leakage that is far below the normal standards of hermiticity. On the other hand, the same experts may in certain contexts refer to elastomeric seals as being hermetic. For example, in applications involving medium vacuum and hence medium purity with respect to air, this is reasonable. However, in the context of ultra high vacuum systems having ultra high purity, this is not the case. For the remainder of this application, especially in the context of high temperature hermetic tube adaptors employing Peclet seals, we will generally refer to all elastomeric seals as being ‘non=-hermetic’. Applicant has shown that the configuration of FIG. 20A can be configured with respect to pumping tube and/or using multiple hot valves with separate debinding and sintering pumps, to provide the same remarkable advantages described previously with respect to the furnace embodiments configured according to FIGS. 6A-C, 9-10 and 14-17 many of the advantages including but not limited to high purity atmosphere and low oxygen content, despite the use of low cost vacuum pumping systems and/or mechanisms, and minimal condensation of binder. For example, the extension heater systems 20007 and the tube heater system 20010 can be kept at, near or above debinding temperature to prevent or reduce condensation of binder byproducts and the pumping tube 20009 can be configured such that process gas 20011 injected at the inlet tube can provide for a predetermined degree of Peclet sealing for achieving ppm or even ppb or better purity. As was the case in previous embodiments the central tube portion 20003 can be controlled to operate during sintering at much higher temperatures than the extensions 20006 as the inlet tube 20013 and pumping tube 20009. It is emphasized again that pumping tube 20009 can be configured and operated with sufficient amount of process gas flow therethrough such that the pumping tube serves as a Peclet seal to isolate contaminants at an outlet 20025 of the pumping tube from impinging upon the inlet of that pumping tube 20024.

In one method power to the extension heaters 20007 and the tube heater(s) 20010 can be deactivated or controllably reduced after debinding as the central tube portion 20003 ramps up to sintering temperature such that the extensions 20006 and tube(s) remain at or below the temperature they were held to during debinding. These high performance tube furnaces can demonstrate remarkable utility when they are employed as low cost process development furnaces

FIG. 20B illustrates an embodiment of an advanced high performance tube furnace which could be a tube furnace wherein an extension 20013 of the furnace chamber can be heated with an extension heater 20014 with optional insulation 20015 surrounding it and high temperature tolerant all metal and or metal and ceramic valves 20016 which lead to a first vacuum pump system 20019 and second vacuum pump system 20020 (which can be as previously described a pump for debinding and a separate pump for sintering). It is noted that the high temperature valves 20016 can be sealed at the inlet end of the pumping tubes 20017, the outlet ends, or at various points between the inlets and outlets of the pumping tubes 20017. Pumping tubes 20017 can be heated at least during debinding by tube heaters 20010. Applicants appreciate that the inclusion of a processing chamber extension 20013 allows the one or more end caps to be utilized at much lower temperatures as compared to the processing chamber thus allowing the valves 20016 to be integral or in close proximity to the end cap. For purposes of descriptive clarity FIG. 20C indicates an embodiment wherein a valve 20018 is located towards the outlet end of a pumping tube.

The above advanced tube furnace embodiments are intended for descriptive purposes and are not intended as being limiting. These systems and methods can be applied to provide advanced high performance tube furnaces based on many variations including for example vertically oriented single ended tube furnaces. With ongoing reference to FIG. 20B it should be appreciated that not all tube furnaces are double ended nor are they always oriented in a horizontal orientation. For example, a tube furnace may be single ended with only one end cap and the opposing end of the tube can be closed and can be closely proximate to or fully contained within the processing chamber insulation such that the lose end forms part of the processing chamber. Applicant recognizes that single ended tube furnaces can be configured to be operated in any orientation vertical, horizontal or otherwise, in full accordance with the teachings herein for example with one of the tubes in FIG. 20B being utilized as an inlet tube and another one being utilized as a pumping tube.

FIG. 20D illustrates an end cap 20019 that can be configured with an high temperature double seal to provide for high temperature sealing above the maximum temperature limits of typical commercially available elastomeric seals. Here and throughout the application the term “high temperature” in reference to seals, end cap flanges, and tubes will can be interpreted as being operable at or somewhat above debinding temperatures as opposed to the extreme temperatures associated with sintering. An internal high temperature gasket seal 20020 such as a graphoil gasket seal can be combined with an external Peclet gap seal 20021 in accordance with the principles described in reference to FIGS. 16 and 17. Sweep gas 20022 can be fed using a feed tube 214 into the end cap to feed a Peclet gap seal 20021. At various points hereinafter we may interchangeably refer to feed tube 214 as an injection channel 214 or as a sweep gas tube 214 or similar language. Various other high temperature double seals can be implemented with an end cap including but not limited to the variations described in FIG. 19A-19E. It should be understood that double seals need not be each located in one coplanar surface. For example, any internal seal could sealably engage the tube face or even on the inside or outside surface of a tube and any given external seal could sealably face and/or engage the end face or an outer surface of the tube end As is illustrated in the figure the gasket can be sandwiched between gasket sealing surfaces 433 and 433′. For example, the internal seal 20020 of FIG. 20D is a gasket that faces and sealably engages the end face of tube 20023 (a first gasket sealing surface) and the external seal 20020 is a Peclet gap seal that faces the outer surface of the tube end, each of the double seal embodiments of FIGS. 19A-19E can be oriented accordingly.

With ongoing reference to FIG. 20D it is again noted that the high temperature sealing techniques described immediately above with respect to high performance tube furnaces can also be employed for providing ceramic tube to metal seals and/or metal tube to metal seals for example at the outlet end of the pumping tube. Scaled down smaller diameter designs based on the foregoing figure are routinely being employed to seal metal tubes and or valves to the ends of both the inlet and outlet tubes as well as the outer end of any sweep gas feed tubes. The same designs and principles are found to scale down favorable such that 1″ diameter to 2″ diameter tube seals are routinely and successfully produced for example using an inner graphoil seal and an outer Peclet gap seal.

With respect to the forgoing descriptions and embodiments Applicant appreciates that persons of ordinary skill typically utilize expensive high performance ultra-high vacuum pumps in applications that require ultra-high purity especially ppm or ppb and better. For example, typical systems designed for high purity processing (ppm, ppb or better) often employ expensive high compression turbo molecular pumps having compression ratio for oxygen (i.e. Compression C>1E6 or even C>1E8 in some cases), diffusion pumps, ion pumps or cryopumps. Such high vacuum pumps generally having much higher cost as compared to the high purity pumping and processing systems and methods described herein. Applicants have discovered that in some cases, contrary to conventional intuition and rules of thumb, the use of high and ultra-high vacuum can create additional unanticipated and even surprising problems resulting in inferior and/or compromised processes as compared to the systems and methods herein. For example, various practitioners have sought to sinter titanium using ultra high vacuum and in some cases this imposes process challenges and compromises in part due to the increased rate of diffusivity of within the system of whatever residual contaminants are present. In other words, high vacuum pumps can sometimes cause systems to exhibit greatly heightened to small trace quantities of contamination in comparison to the systems described herein. Thus, counter to common beliefs and intuition of persons of ordinary skill, when high purity is demanded there are cases where surprisingly superior performance can be achieved at higher pressure than is typically associated with high vacuum technology and products. For example, Applicant has discovered, remarkably, that for high purity sintering of aluminum and titanium there can be great benefits to sintering at pressures of 1 Torr or greater while on the other hand other practitioners often espouse the processing of these materials at pressures of 0.001 Torr or even much lower. Applicants have discovered that the systems and methods described above, including but not limited to embodiments of FIGS. 12, 13, 14, 15 and 20A-D can provide for sweeping advantages as compared to high vacuum low pressure (<0.1 Torr) when sintering aluminum, aluminum alloys, Titanium, high carbon steel alloys and many other sensitive and difficult-to-sinter metals and alloys. In particular Applicant routinely sinters aluminum alloys and titanium alloys in furnaces configured in accordance with all of these embodiments.

FIG. 21 illustrates an embodiment of a vacuum processing system that utilizes a two-stage pumping system 21001 for achieving ultra high purity at low cost. This system could be employed in a variety of applications including but not limited to semiconductor processing systems including but not limited to sputtering and etching plasma processing systems. In this embodiment a low cost low performance and/or extremely rugged but still low cost turbo molecular pump 21002 having unusually poor compression can be disposed between a vacuum processing chamber 21003 and a low cost high purity mechanical pump 21004 as described previously including a hermetically sealed mechanical pump having a Peclet seal at the outlet with sweep gas flowing therethrough. This embodiment can achieve ultra-high purity at lower cost than traditional multistage systems at least for the reason that the turbo pump can have a very poor compression ratio and yet the system can nevertheless achieve ultra-high purity including parts per billion or better. The use of the low-cost high purity mechanical pumping system 21004 can enable the use of a lower cost “de-rated” turbo molecular pump 21002 having a compression ratio of less than 1E6, less than 1E5, less than 1E4, or less than 1E3. For example, this embodiment could be configured as a sputtering system that operates at IE-4 Torr and ppb purity could be achieved even if the low compression turbo pump only exhibits a compression ratio of 1000 or even 100 with respect to Oxygen. Conventional turbo pumps are readily available having compression ratios of 10E8, 10E9 and even greater and applicants recognize that such high compression ratio's can result in very high cost and yet they are considered desirable in order for achieving ultra high purity. Applicants further recognize that derated turbo pumps can be designed with lower mechanical precision of internal mechanisms and superior ruggedness and reliability as compared to state of the art high compression pumps. It is noted that processing gas may be optionally introduced into the vacuum processing chamber 21003 via a process gas source 21005 and may contribute to the Peclet sweep gas in accordance with previous descriptions. It is further noted that sweep gas can be injected into the pump housing and/or the inlet of the Peclet tube as in previous descriptions with respect to low cost high purity mechanical pump systems.

As mentioned previously above, the systems and methods described herein can be adapted to provide for sweeping benefits even when retrofitted into many furnace embodiments. FIG. 22 depicts a vacuum sintering furnace 100 having inner insulation 24 and outer insulation 26 within vacuum chamber wall 32. Furnace 100 can include outer external heater 298 and/or outer heater systems 296 that can be embedded in the insulations configured to heat the outer insulation 26. Both options for outer heaters are included here and applicant have had success with both choices. Furnace 100 includes inner heaters 112, an inlet tube 78 and a pumping tube 73. The steel chamber containing high temperature insulation surrounding furnace heaters arranged for heating a sealed or semi sealed parts retort such as a ceramic, refractory metal or graphite retort that could be non-porous or somewhat porous. It is noted that in the context of FIG. 22 the retort does not generally need to serve as a vacuum chamber at least in cases where the outer chamber 32 is serving that purpose. In some embodiments the inlet tube 78 may be used to inject process gas and the sealed, or semi sealed and/or semi porous retort 22001 may include a retort pumping tube 22002 that can receive at least a portion of the process gas flow to pump the retort 22001 and to provide at least some degree of Peclet sealing between the outside and the inside of the retort. This Peclet sealing by the retort pumping tube can provide a degree of isolation against ingress to the retort of any air or other contaminants that may be present in the steel chamber and outside the retort. The system can include additional outer heater systems 296 and or 298 including heaters 296 embedded in outer layers of the insulation or can be placed as heaters 298 outside the insulation, and in certain instances outside of the. In some embodiments the outer heater systems 298 could be installed just outside the vacuum chamber. These outer heaters can be activated at least during debinding of parts 22003 to maintain the outer insulation 26 at sufficiently high temperatures to reduce or prevent binder condensation on the insulation and on the inside to the vacuum chamber. Furthermore the vacuum chamber pumping tube 73 can be heated at least during debinding with a pumping tube heater 22004 and insulated with optional tube insulation 22005. Applicant has observed that furnaces having insulation and no outer heaters within a sealed vacuum chamber as illustrated in FIG. 22 can be prone to heavy binder condensation on the outside of the insulation and on the inside of the vacuum chamber, and Applicant has installed outer heaters in various embodiments (embedded in the insulation, outside the insulation on either inside or outside of the vacuum chamber wall). In various methods the outer heaters and/or pumping tube heaters are controlled in conjunction with the furnace heaters such that the outer insulation and/or pumping tube is heated during debinding to sufficient degree to greatly reduce condensation during debinding of debinder byproducts, and this use of outer heaters results in substantially improved part quality. Applicant has successfully utilized the valve, pump and pumping tube of FIG. 13 in conjunction with the chamber embodiment of FIG. 22. Various combinations of the features and methods of that combination has provided sweeping benefits for atmospheric purity in retort 22001. Applicant has implemented this combination in the context of many systems including vacuum sintering furnaces that employ water cooling during sintering of chamber wall 32. In that configuration Applicant has purged the water cooling lines prior to and during debinding such that the chamber wall is heated during debinding to reduce or eliminate condensation of binder by products during debinding. In some embodiments applicant installed conventional water cooled sintering furnaces and retrofitted the system with the heated pumping tubes of FIG. 12 and the semi sealed retort 22001 and retort pumping tube 22002 and has operated during sintering with sufficient process gas flow to achieve a high degree of Peel et sealing with the retort pumping tube 22002. In that combination Applicant was able to achieve exceptionally high atmospheric purity as compared with operation of the as received conventional sintering furnace. In another embodiment Applicant yet further modified the furnace to include the heated pumping tube and the two heated valves as in the embodiment of FIG. 13 and installed and used the two pumps separately during debinding and sintering and thus achieved yet further advantages allowing Applicant to sinter parts with superior metallurgical properties as compared to the parts sintered in the as-installed conventional furnace. The combination of the chamber of FIG. 22 and the features therein in combination with the vacuum manifold of FIG. 13 including the heated pumping tube and the two heated valves and two separate pumps has demonstrated remarkable benefits especially with regard to preventing condensation of binder byproducts.

In addition to advanced systems and methods for vacuum pumping, the application above discloses a number of vacuum furnace systems for debinding and/or sintering with emphasis throughout on systems and methods for avoiding buildup of contamination during debinding as one of several factors that can contribute to achievement of unprecedented ultra-high atmospheric purity especially during sintering. It is noted that these systems can be referred to with the term of art “batch furnaces”; a batch sintering furnace can be so-called on the basis of the method of usage including loading the furnace with one batch of parts per run for debinding and/or sintering in one single chamber—for example in accordance with a time—and temperature cycle depicted in FIG. 11. The term of art batch furnace is often intended to distinguish such systems from so called continuous or conveyor furnace that move parts through a long chamber having different temperature zones distributed along the path of motion. Applicants are unaware of any other batch sintering furnace systems and methods that can provide for sintering atmosphere purity at the levels we routinely achieve using the various described embodiments for example PPM, parts per 10 Million, parts per 100 million or PPB and even better as needed, all of which purity levels we routinely demonstrate-following debinding and during sintering-using these methods and embodiments. Furthermore, we believe that the aforementioned methods and embodiments, discussed in general and schematically in FIG. 12 and with specific embodiments and aspects described in FIGS. 14, 15, 16, 17 and 19 can provide for superior atmospheric purity even when compared to the most advanced state of the art conventional systems and methods. For example, even when used solely for sintering of fully and separately debound parts, contamination that enters the furnace from the atmosphere or from prior runs tends to collect on the inner vacuum chamber walls and insulation of conventional furnaces and continuously contaminates the sintering atmosphere during sintering. The systems described herein and throughout this disclosure, our systems have no cold spots on which contaminants readily condense during debinding and also during sintering.

It is noted that many of our systems and methods employ binder traps that capture binder vapor to prevent it from impinging on a vacuum pump. We have developed advanced systems and methods for preventing back streaming of binder vapor from binder traps back into a given sintering chamber, aspects of which include but are not limited to advanced use of Peel et isolation in the pumping tube during and sometimes after debinding to completely isolate the inlet of a vacuum pumping tube—in gaseous communication with the chamber—from any back-streaming of binder from the trap and/or the pumping tube. This aspect can include providing for sufficiently high temperature heating of the Peclet tube to prevent any detectable buildup therein. With respect to this refinement, it is noted that properly executed outlet tube heating, especially during debinding, provides benefits far beyond the mere prevention of vacuum tube clogging and we routinely demonstrate that this technique, when coupled with Peclet sealing, can prevent any observable or detectable buildup within an inlet section of a given vacuum pumping tube. In order to draw attention to this aspect we may hereinafter refer to the pumping tube as a high temperature vacuum pumping tube or as an extreme temperature vacuum pumping tube wherein the term “high temperature includes temperatures as high or somewhat higher than debinding temperatures, generally well under 800 C, whereas “extreme” is intended to indicate temperatures at or above 800 C such as those that can be required for sintering.

In the context of traditional conventional batch type furnaces and methods the conventional vacuum chamber and furnace insulation arrangement (especially the outer portion of insulation and the inner chamber wall) is very commonly a major and/or dominant source of binder contamination during sintering even in cases where external separate debinding has been done prior to loading a batch of previously debound parts, and to our knowledge little attention has been paid to reducing let alone eliminating contamination in the conventional chamber pumping tubes which tend to be oversized compared to ours (perhaps to allow buildup without clogging) and are often unheated especially during debinding. In conventional batch sintering furnaces, the chamber (especially the vacuum chamber inner walls and insulation therein) tends to be so highly contaminated that backstreaming from the inlet of a conventional pumping tube can present during sintering in significant amounts but nevertheless provides little or no noticeable addition to the much greater degree of contamination of conventional sintering atmosphere coming from the vacuum chamber and furnace insulation. As mentioned previously, in conventional systems and methods the systems tend to be configured with large outlet tubes often providing for avoidance clogging due to buildup of condensed binder material.

We believe that in the design and operation of traditional furnaces there has therefore been less attention paid to eliminate comparatively small amounts of contamination in the pumping tube that may backstream back into the chamber from the pumping tube and/or binder trap—at least because back-streamed contamination typically amounts to no more than a small factor for contaminating an already highly befouled chamber and atmosphere. Whereas our embodiments tend to exhibit sufficiently negligible contamination in the sintering chamber and therefore we turned our attention to the further step of reducing or even completely eliminating the outlet tube as a source of any detectable contamination. Heating of the vacuum pumping tube during debinding can contribute to this goal by reducing or preventing altogether any condensation of binder therein during debinding. As a given parts processing cycle progresses from debinding to sintering the binder contaminants are largely or completely gone except for those that are on the outlet end of the tube such that Peclet flow from an inlet of the tube towards the outlet can completely suppress any back-streaming into the sintering chamber.

Applicants recognize that Peclet sealing when executed properly can result in literally no back streaming. This may seem counter intuitive to a reasonable person of ordinary skill in the art and even top experts can tend to lose sight of intuitive understanding of this truly remarkable element of applied physics. One metaphorical image that can help a person of ordinary skill in the art to gain intuitive access to the extreme efficacy of Peclet sealing (when properly executed) is to imagine a school of fish swimming upstream within a large water pipe. Assuming some average maximum speed that any of the fish can travel, if the speed of the water flow greatly exceed this speed (for example by an order of magnitude) then not one fish will be expected make it from the outlet of the pipe to its inlet for even a relatively modest length of pipe. For example given water flow of 1 OOMPH through a large pipe with a 3′ diameter and a 10′ length, it would be reasonable to assume that for normal fresh water minnows, not one minnow could make it through the pipe irrespective of the size of that school of fish. So it is with gas molecules if and when the correct conditions are achieved. This metaphor is somewhat of an over simplification at least for the reason that laminar flow at the wall of the pipe will be slow, and if one fish were mentally savvy enough to closely hug the wall then that fish would stand a better chance and would certainly go farther than less intelligent members of the school. Fortunately for the metal sintering industry, gas molecules are not blessed with any mental intelligence and they ambulate only by way of random diffusive motion. As long as the Peclet tube is much longer that the diameter (or as long as gap length L is much longer than gap size G) then the statistical likelihood of a given molecule remaining close to the wall for an entire trip becomes vanishingly small. Extensive laboratory testing in our facility has been executed in order to completely validate the claimed performance and our models have been well proven to hold as described.

Here and throughout the description we describe systems and methods that result in no detectable impurity. By this we mean that we have been unable to detect contamination either by way of instruments (such as state of the art spectrometers and He leak detectors) or by way of indirect evidence such as contamination within our parts. For example, we routinely sinter aluminum and Titanium using these systems and methods and in subsequent metallurgical studies we have been unable to detect any discernible contamination that can traced directly or indirectly to impingement of contamination though our hermetic seals. In general, when our systems are functioning properly any contamination we detect and any effects we observe have been traceable to one or both of (i) contamination within the processing gas from its initial source such as a liquid argon dewar and (ii) the powder metal parts themselves for example if the raw powder insluces some trace impurities. As such, we routinely produce parts that indicate no measurable degradation as a result of leaks through the main seals, tube furnace seals, or our high temperature tube adaptors described and claimed herein.

In addition to the forgoing considerations, the powder metallurgy industries in general have driven towards increasing focus on low cost, space-saving compactness, lower power usage and lower maintenance costs with higher ease of use-all factors that are well addressed with the disclosed embodiments.

Turning to the Figures, a sintering furnace system can include a sealable vacuum chamber for vacuum heating and debinding parts therein, the parts being composed of powder that is bound together in the shape of the part using at least one organic binder that contains carbon, to a predetermined range of chamber temperatures including a range of thermal debinding temperatures that are high enough to induce off-gassing of organic binder vapor from the part including for purposes of debinding. The furnace can be vacuum pumped through a vacuum pumping tube that can be heated to well over 250° C. and even over 450° C. during debinding and can be sealed with and in gaseous communication with the vacuum chamber and configured such that vacuum pumping therethrough can induce outflow therethrough of furnace exhaust flow that during debinding is contaminated with the binder vapor. A tube heater can be provided and configured for maintaining at least a portion of the length of the vacuum pumping tube in a range of tube temperatures sufficiently high to not only prevent clogging but in fact to inhibit any directly and/or indirectly observable buildup and/or condensation therein thus limiting build up of binder material to prevent contamination, especially within an initial inlet length of the vacuum pumping tube the portion of which is in close gaseous communication with the chamber. The system can include a vacuum pump that can provide for the pumping action that can at least contributes to said outflow of furnace exhaust and simultaneously provide the vacuum in the chamber within a predetermined range of vacuum pressure.

With regard to the levels of contamination within the pumping tube the tube temperature should be maintained at a high enough temperature (ie. 250-600° C.) such that it is impossible or at least highly challenging to directly or indirectly detect any contamination especially including carbon and any carbon-based molecules from binder evaporation. As mentioned previously in the absence of contamination measured by gas analytic instruments, indirect detection can include evidence of contamination by parts during processing. An expert in material science can be expected to find a variety of highly sensitive techniques for direct and/or indirect detection of contamination. For example, experimental sweeps could be done where initial runs intentionally are done at insufficient purity by intentional introduction of carbon and/or oxygen based impurities after which run the parts examined in a materials lab to detect measurable quantity of carbon and/or oxygen contaminated with carbon. This will be straightforward for ultra-sensitive sample materials such as Titanium. In subsequent runs the extreme temperature pumping tube temperature, at least during debinding could be increased from run to run until a temperature is established wherein no detectable carbon and/or oxygen contamination can be observed in the sintered test parts. This is one of many ways that a measurable temperature could be arrived at whereby the pumping tube can be considered free of any indirectly detectable contamination. We recognize that the concept of zero contamination can be regarded as unphysical at least for the reason all materials including high purity stainless steel contain some finite amount of atomic and/or molecular contamination. While a “theoretical” definition of zero contamination is indeed unphysical, we intend that the concept of zero contamination is intended for practical and functional purposes and should be taken as roughly meaning one or more of the following:
(i) Contamination due to either oxygen or carbon simply cannot be detected directly (with absolute state of the art gas analyzers sampling the sintering atmosphere) or indirectly (using metallurgical laboratory instrument to characterize parts such as titanium parts. Again, this is to be regarded as a practical and functional statement as opposed to theoretical conceptualization of ultimate absence to any infinite degree.
(ii) As another functional conceptualization, our system can be considered for practical purposes to contribute no impurities insofar as the amount of impurities introduced directly by way of the ultra pure processing gas injected through the inlet is larger than any amount introduced (or condensed and subsequently re-introduced) by our system. For example, if there is an order of magnitude or greater difference then for all practical purposes the system should be considered as free of any unintended or unpredicted contamination.
(iii) It is well known to experts in vacuum science that when operating at pressures of 10E-9 Torr or less the atmospheric purity typical vacuum systems tend to be limited by contamination that is physically emanating from deep inside the actual steel vacuum chamber by way of solid state diffusion. This is by no means a species analogy as we do seem to achieve parts per billion and better purity when desired when operating an empty or nearly empty chamber at a approximate sintering pressure of 1 Torr. It should be understood that a high vacuum system operating at 10E-9 Torr can be expected to contain the same number of impurities per cubic centimeter as we are believed to be experiencing when operating at 1 Torr chamber pressure and PPB purity. While it is difficult to pin down our performance to this degree we believe that this is indeed the condition that we are likely experiencing in our systems and is completely consistent with all our measurement both direct and indirect. For example, contamination at the inlet of our steel pumping tubes is likely to be limited to this effect (solid state diffusion) as opposed to resulting from oxygen diffusing up the pumping tube or from trace binders left on the surface thereof.

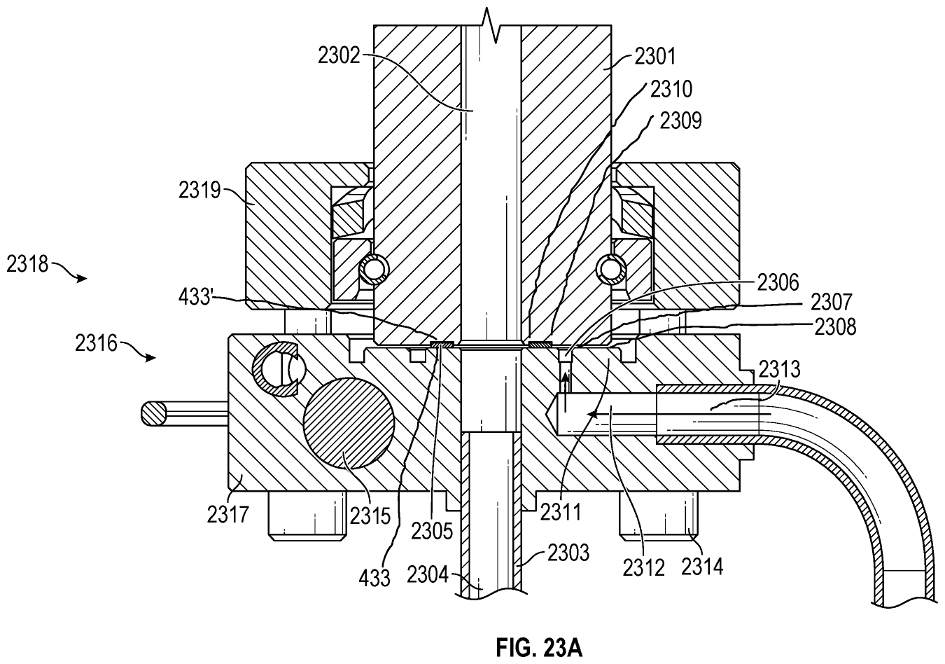

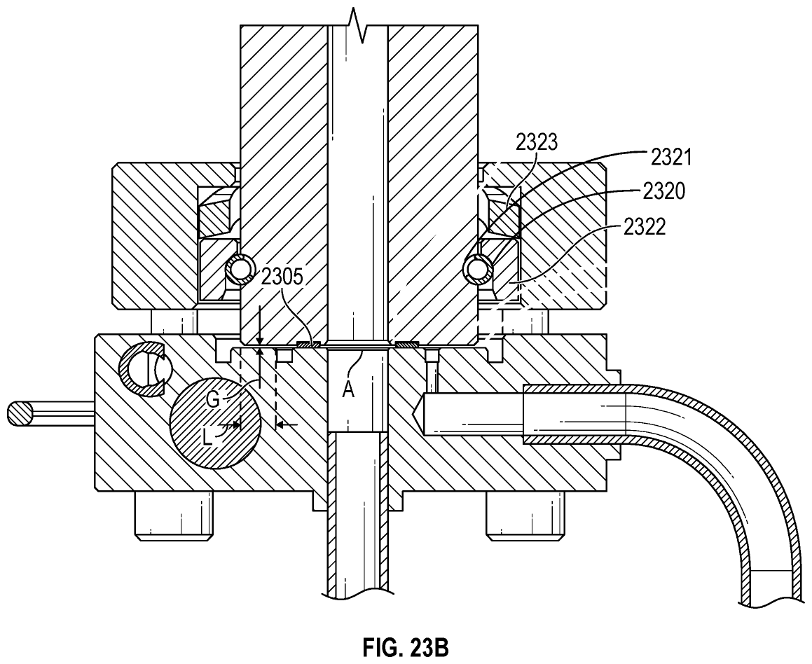

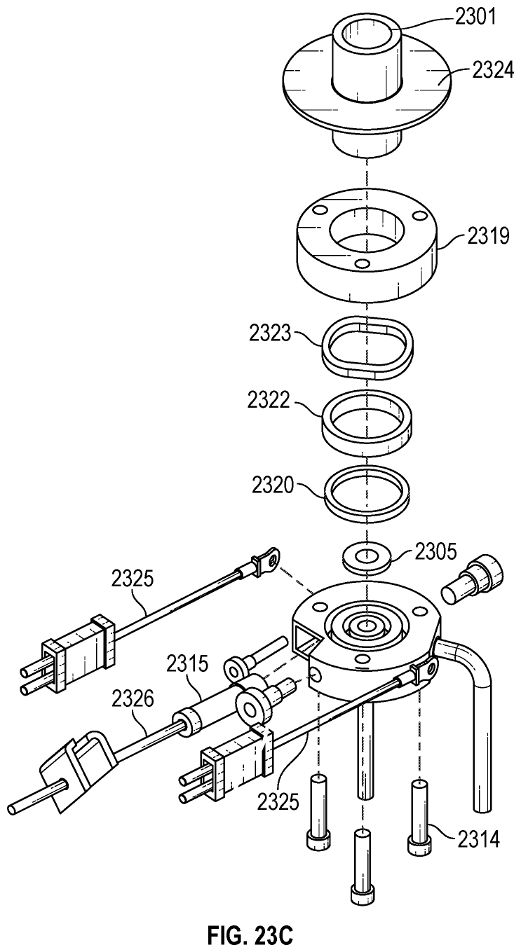

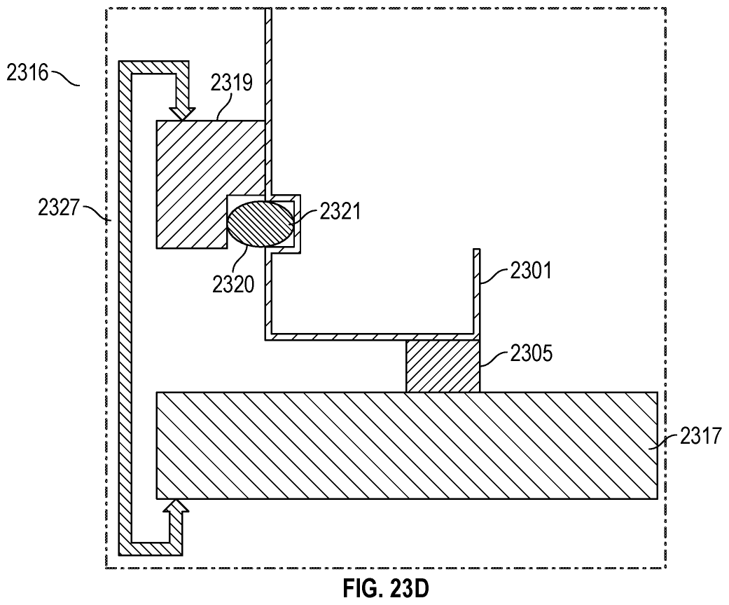

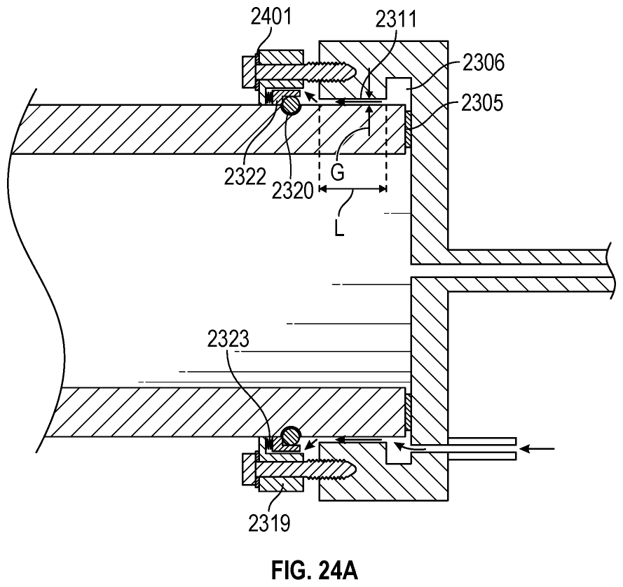

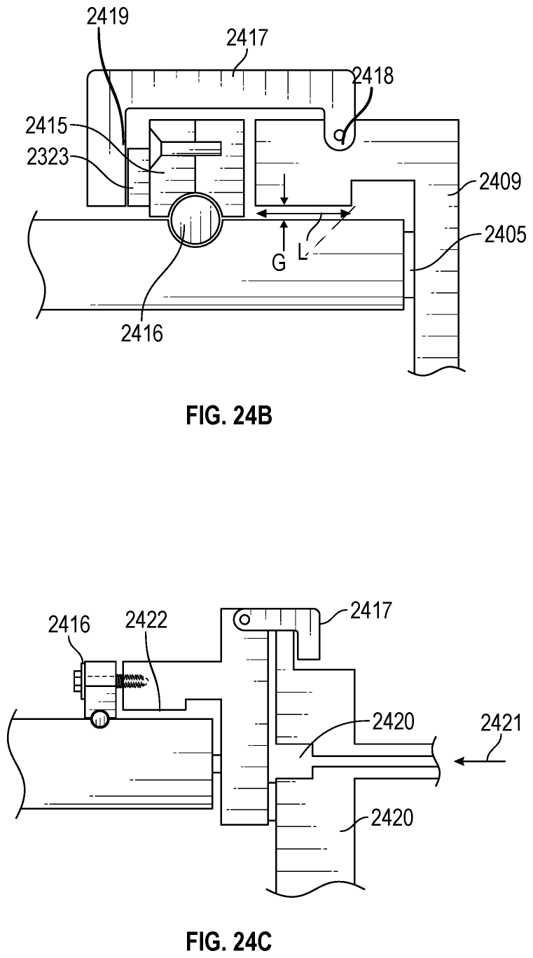

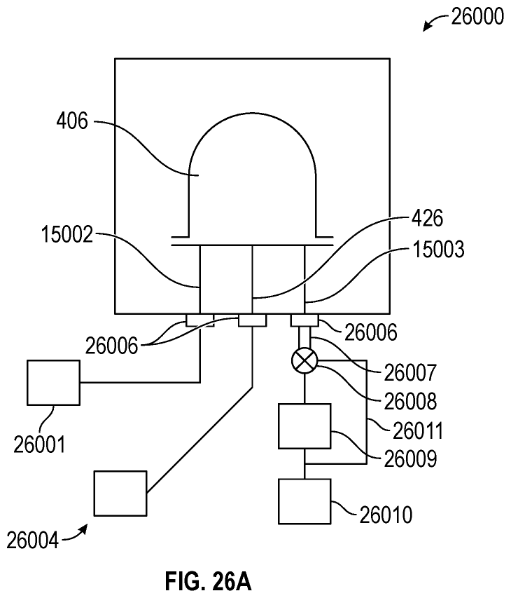

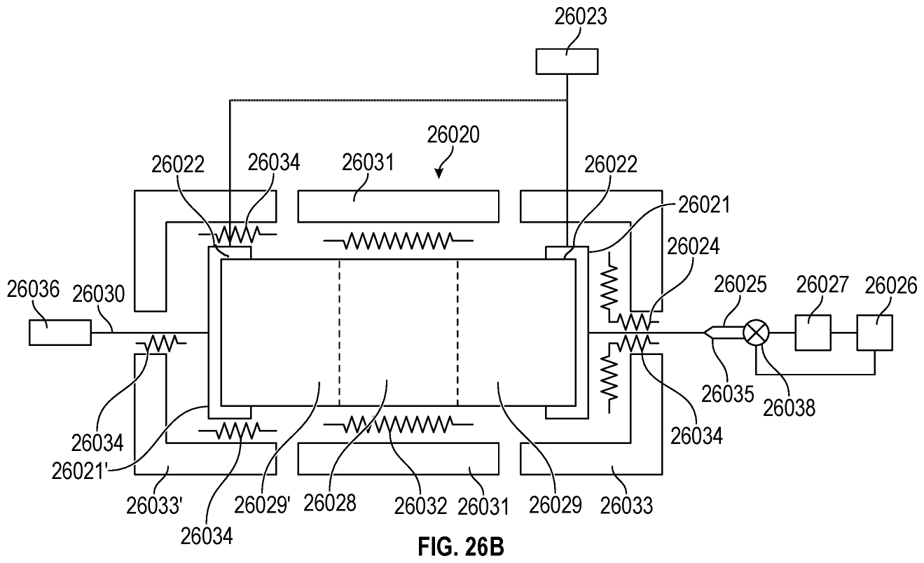

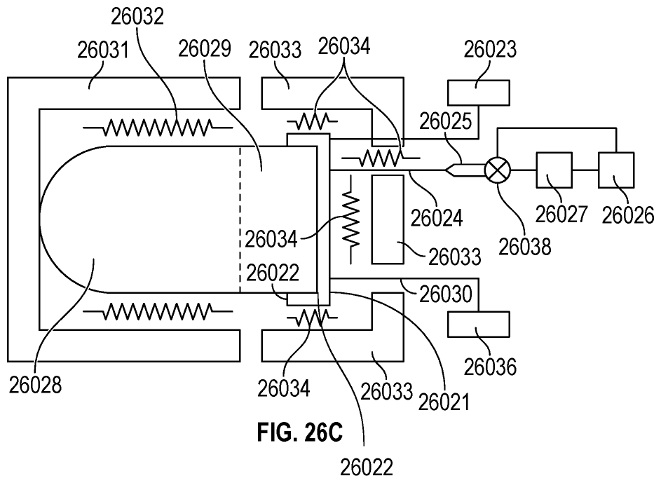

In various embodiments, a hermetically sealed vacuum chamber can be inside a hot zone that contains extreme temperature furnace heaters both within the insulation and outside the chamber, and which is surrounded by outside ambient air, as is illustrated in FIG. 14. In other embodiments, the chamber could be a single or double ended tube furnace also as is described in reference to FIGS. 20A-D, FIGS. 26B-26C with supporting details of implementation also discussed in reference to FIGS. 24A-24B and 24D with yet further techniques described in reference to FIGS. 23A-23D.

Focusing on the former, the hermetically sealed vacuum chamber may require a main chamber opening that maintains a highly isolating seal (with respect to the air and or gas surrounding the outside of the sealed chamber) even at sintering temperatures which tend to be extreme. Nobody else has ever developed and/or demonstrated hermetic door seals for use above 800° C. prior to our development of the physical system embodiments depicted in FIGS. 14,15,16 and 17. In this configuration, the vacuum pumping tube can protrude from inside the hot zone defined by the heaters and furnace insulation, through at least an inner portion the insulation and towards the outside of the insulation. In these cases, the vacuum pumping tube can be composed of an extreme temperature material that is hermetically impervious to diffusion of gasses therethrough and that is capable of withstanding extreme temperatures (i.e. sintering temperatures). An arrangement of furnace insulation (operable at extreme temperatures with furnace heaters disposed inside it) can be configured to heat the vacuum chamber therein to a temperature that exceeds 800° C. for at least a sintering portion of a furnace heating cycle including for a cycle that includes sintering. It is noted that in this configuration (FIGS. 14,15,16,17) the vacuum chamber can be surrounded by outside ambient air (including oxygen and other contaminates) while maintaining ultra-pure oxygen free sintering atmosphere therein. The chamber can (and often must) be composed of a material that is hermetically impervious to diffusion of outside gases, and capable of withstanding vacuum pressure from outside air (ie 1 PSI) throughout the furnace heating cycle. With the chamber closed (for example during debinding and/or sintering) the inner volume can be vacuum sealed from the outside ambient air by a main hermetic retort seal that is within the hot zone and the seal blocks leakage of outside ambient air into the inner volume, to a sufficient degree to prevent adverse effects on parts quality by the outside ambient air.

In other embodiments the sealed vacuum chamber may be a tube furnace as described in reference to FIG. 20A with the vacuum pumping tube 20009 being arranged and operated in accordance with aspects of the descriptions immediately below. In such embodiments the end plates of the tube furnace may be metal flanges capable of withstanding high temperatures including debinding temperatures. Also inlet and/or vacuum pumping tubes that can be connected to those flanges may be hermetically connected to and/or co-fabricated with the flanges and composed of a high temperature tube material that is also capable of withstanding debinding temperatures. In various systems and methods sintering process gas flow may flow into the tube furnace though an inlet tube and a balanced quantity of the process gas may simultaneously flow out the vacuum pumping tube to provide Peclet isolation of any contaminants impinging on the outlet of the vacuum pumping tube. Such contamination can include binder vapor emanating from the binder trap, vacuum pump or other downstream elements of a given vacuum manifold. In such applications if an adequate rate of process gas flow is provided, this outflow of process gas, from the inlet to the outlet of the pumping tube, can be relied upon to provide the Peclet seal that isolates the outlet of the pumping tube from it's inlet as well as the chamber. In reference to the tube furnaces described herein, we describe the vacuum pumping tube as operable at “high temperature” in order to emphasize that the tube can be designed to withstand debinding temperatures that can exceed the range of common room temperature vacuum components such as elastomeric o-rings.

In various embodiments including at least some of those above, heating of the vacuum pumping tube can be provided indirectly by way of the same furnace heaters that are disposed within the furnace insulation. In many of our embodiments it can be provided by a separate tube heater in thermal contact with the vacuum pumping tube. In the former case (where the heat is provided by the furnace heaters) thermal conductivity of the vacuum pumping tube must be sufficient to transport sufficient heat along the tube. Irrespective of the above two configurations, a high temperature hermetic tube adaptor (described below) can support and include yet an additional separate heater that heats the adaptor and can simultaneously contribute to maintain high tube temperature (i.e. greater than 300 C and typically 450 C-500 C) along the vacuum pumping tube including during debinding.

The vacuum pumping tube can protrude, from inside the furnace insulation towards the outside of the insulation, through the furnace insulation such that the furnace insulation, in addition to insulating the chamber and furnace heaters, also provides thermal insulation for maintaining the elevated temperature of the extreme temperature pumping tube including during debinding. For embodiments such as those of FIGS. 14 and 15 at least a portion along the inlet end of the pumping tube must be operable at sintering temperatures often exceeding 800 C. In the context of conventional vacuum tubes and seals most commercially available off the shelf hardware is composed of stainless steel with copper gaskets that are not operable above a few hundred degrees Celsius. In the case of the tube furnaces the furnace tube can be considered as having a main portion that operates as a sintering portion and at least one end portion as a tube extension that extends from the hot zone where sintering is achieved, and extend to a less extreme thermal zone that nevertheless can operate at high temperature where a high temperature hermetic flange (such as a steel flange is connected). On the one hand this section of the furnace tube can be regarded as a vacuum pumping tube even though it may not be relied upon for Peclet sealing. In this case a second smaller diameter tube can also be regarded as a vacuum pumping tube in which Peclet sealing can be implemented. The flange in this case can be described as a high temperature tube adaptor that can hermetically adapt from the extending section of the furnace tube to a smaller pumping tube as shown for example in FIG. 24A. Consistent with the descriptions throughout this disclosure, it can be highly advantageous to maintain high temperature (ie debinding temperature) of all three of (i) the end portion(s) of the tube furnace, (ii) the flanges that serve as end plates and (iii) the high temperature vacuum pumping tubes.

As mentioned previously above, the vacuum chamber and or tube furnace chamber can be configured to include an inlet tube for injecting, at least during sintering, a sintering process gas that in some cases can be highly purified that can include inert gas such as Argon and/or Nitrogen, in a range of flow rates Qmin to Qmax. In some cases Q min could be as low as 0.01 slm for every cubic foot of chamber volume and as high as 10 slm for every cubic foot of chamber volume. Many of our embodiments are bounded between 0.05 and 2 slm for every cubic foot of chamber volume. The vacuum pumping tube can have an inlet end that can be sealed to the vacuum chamber and an outlet end, and the vacuum pumping tube can be arranged to utilize outflow of process gas to provide for a “Peclet seal” that isolates the input end of the vacuum pumping tube (and therefore the chamber as well) from any contaminants that may be present at the outlet end of the vacuum pumping tube. For this mode of isolation and at least a portion of the pumping tube (for example the initial inlet portion of the tube length) can be characterized as having a cross sectional area A, a length L with A and L selected such that at least for a predetermined range of process gas flows at a given vacuum pressure Pe (Q, A, L, D) is less than 10E-6 for D (air) of oxygen within the process gas flow and for D (CX) of molecules of binder vapor for a given pressure. While we employ tubes of uniform shape and cross section there certainly can be variation of A along the tube in which case the calculations get more complicated but the functionality and principles in play can be maintained as set forth throughout this disclosure.

In general this configuration works remarkably well even at vacuum pressures and provides highly effective Peclet sealing for any vacuum pressures for which laminar flow is maintained. As pressure is decreased below the regime of laminar flow, the Peclet isolation tends to be undermined when vacuum pressure is so low that transition flow sets in and it can be undermined quite badly if pressure drops into the milliTorr or lower pressures. It should be noted that the unique pumps in the incorporated reference were designed for applications where deeper vacuum is needed. For many products we can operate at pressures of 1 Torr and higher where the Peclet isolation from a properly heated and properly designed vacuum pumping tube maintains better than ppm purity at the inlet of the vacuum pumping tube.

Summarizing with respect to design and dimensions of the vacuum pumping tube: for a predetermined range of vacuum pressures and process gas flows, the vacuum pumping tube can be designed such that for any given process gas flow within a specified range (0.05 slm to 10 slm) the tube is made long enough and with a small enough internal diameter (ID) to provide better (and in many cases much better) than ppm and often even ppb or better isolation by relying on flow of process gas within the vacuum pumping tube (during sintering) to act as the sweep gas for the tubular Peclet seal. It is noted that the details of such a tube design considerations and equations were set forth in detail in reference to FIGS. 7 and 8 and discussed at various points in the description including paragraphs 56-67 as well as in paragraph 77 and 78.

A vacuum chamber with the above described parameters can be operated with the inlet of the vacuum pumping tube, and therefore the chamber, at vacuum pressure anywhere from 0.1 Torr to 759 Torr and we routinely operate at 1 Torr to 500 Torr while maintaining ppm or better including sometime ppb or better purity.

In one furnace system embodiment (described in FIGS. 22A-B) The sealed chamber may be outside the furnace insulation as is often the case in conventional batch sintering furnaces. As we mentioned above, we are unaware of any sintering furnace having a heatable vacuum pumping tube that is sized and operated to employ pure process gas and or sweep gas during sintering to provide for Peclet sealing by the vacuum pumping tube to isolate the vacuum pumping tube inlet from contamination present at the vacuum pumping tube outlet as is illustrated in FIGS. 22A-B. Pumping tubes in conventional systems generally tend to be very large and with no tube heaters. As we mentioned above it has been our experience with conventional furnaces that during sintering the interior walls of the vacuum chamber and the furnace insulation off-gas large quantities of contamination especially including (but by no means limited to) binder vapor that condensed thereon and therein during debinding. Moreover, the quantity of that outgassing tends to be so high—especially in the early stage of sintering—that a perfectly designed and implemented vacuum pumping tube (providing better than 10E-6 isolation) would make little to no difference with respect to contamination of parts. However, as we illustrated in FIGS. 22A-B and as described, we have achieved remarkable benefits by including a heater arrangement inside the chamber and outside the insulation or embedded in an out portion of the insulation. In one method of use this “outer heater” is run at approximately the binding temperature provided for the parts by the furnace heater. This technique greatly reduces and in some cases completely prevents condensation of binders in the insulation and in the chamber walls during debinding. Combining this setup and process with designing and operating the vacuum pumping tube in accordance with the above disclosure for a Peclet sealed heated vacuum pumping tube results in sweeping advantages and we have found at relatively low cost the purity levels within otherwise conventional furnaces can be increased by many orders of magnitude.

In various embodiments illustrated by FIGS. 22A-B a sintering furnace system can include a sealable vacuum chamber for vacuum heating and debinding parts therein under vacuum to a predetermined range of chamber temperatures including a range of thermal debinding temperatures that are high enough to induce off-gassing of organic binder vapor from the part. The vacuum chamber can contain therein furnace insulation and furnace heaters that define a hot zone into which parts can be loaded and unloaded through a furnace door (not shown). The furnace can be vacuum pumped through a heatable vacuum pumping tube that can be sealed with and in gaseous communication with the vacuum chamber and configured such that vacuum pumping therethrough can induce outflow therethrough of furnace exhaust flow that during debinding is contaminated with the binder vapor. An outer chamber heater can be provided (shown in the figure as being inside the chamber and in or on an outer portion of the furnace insulation, or it could alternatively be disposed outside the vacuum chamber (see FIG. 22B), and the outer heater could be activated and operated during debinding to reduce and/or eliminate condensation of binder on and in the insulation and within an inner surface of the vacuum chamber. It can be activated soon enough and for long enough duration to ensure that the entire thickness of the insulation is at or near debinding temperature at least towards the last portion of debinding and/or the onset of sintering. In order to maximize the benefit and provide yet better purity during sintering, a heater can be provided and configured for maintaining at least a portion of the length of the heatable vacuum pumping tube in a range of pumping tube temperatures sufficiently high to inhibit any buildup and/or condensation therein thus limiting build up of binder material to prevent contamination especially within the initial inlet length of the tube that is in close gaseous communication with the chamber. The system can include a vacuum pump that can induce said outflow of furnace exhaust and simultaneously provide the vacuum in the chamber within a predetermined range of vacuum pressure.

With ongoing reference to the embodiment of FIGS. 22A-B the vacuum chamber can be configured to include an inlet tube for injecting, at least during sintering, a sintering process gas that in some cases can be highly purified that can include inert gas such as Argon and/or Nitrogen, in a range of flow rates Qmin to Qmax. In some cases, Qmin could be as low as 0.01 slm for every cubic foot of chamber volume and as high as 10 slm for every cubic foot of chamber volume. The vacuum pumping tube can have an inlet end that can be sealed to the vacuum chamber and an outlet end, and the vacuum pumping tube can be arranged to utilize outflow of process gas to provide for a “Peclet seal” that isolates the input end of the vacuum pumping tube (and therefore the chamber as well) from any contaminants that may be present at the outlet end of the Peclet tube. For this mode of isolation and at least a portion of the vacuum pumping tube (for example the initial inlet portion of the tube length) can be characterized as having a cross sectional area A, a length L with A and L selected such that at least for a predetermined range of process gas flows at a given vacuum pressure Pe (Q, A, L, D) is less than 10E-6 for D (air) of oxygen within the process gas flow and for D (CX) of molecules of binder vapor for a given pressure. There can be variation of A along the tube in which case the calculations get more complicated but the functionality and principles in play are maintained as set forth throughout this disclosure. In general, this configuration is highly effective for any pressures for which laminar flow is maintained in the pumping tube and the isolation tends to be undermined only when vacuum pressure is so low that transition flow sets in and it can be undermined quite badly if pressure drops into the milliTorr or below range. It should be noted that the unique pumps in the incorporated reference can be utilized for applications where deeper vacuum is needed. For our main products we can operate at pressures of roughly 1 Torr and higher.

Summarizing with respect to design and dimensions of the vacuum pumping tube: for a predetermined range of vacuum pressures and process gas flows, the vacuum pumping tube can be designed such that for any given process gas flow within a specified range (0.05 slm to 10 slm) the tube is made long enough and with a small enough ID to provide better (and in many cases much better) that ppm isolation for the vacuum pumping tube inlet with respect to any gaseous contaminants present at the vacuum pumping tube outlet by relying on flow of process gas within the vacuum pumping tube (during sintering) to act as the sweep gas for the tubular Peclet seal. It is noted that the details of such a tube design were set forth in detail in reference to FIGS. 7 and 8 and discussed at various points in the description including paragraphs 56-67 as well as in paragraph 77 and 78.

A vacuum chamber with the above described embodiment and operating conditions can be operated with the inlet of the vacuum pumping tube, and therefore the chamber, at vacuum pressure anywhere from 0.1 Torr to 759 Torr and we routinely operate at 1 Torr to 500 Torr while maintaining ppm or better including sometime ppb or better purity.

In order to extend the range of temperatures in operation the vacuum pumping tube—especially in the case of a ceramic tube—we have developed high temper hermetic tube adaptors at least for the inlet tube 15002 which can be composed of ceramic and a flange which can be formed from a high temperature steel or a refractory material such as a refractory metal. In the systems of FIGS. 14 and 15 we configure the flange of the adaptor assembly out of high temperature 300 series steel or similar materials and to produce a hermetically sealed tube adaptor that can operate across the full temperature range that the steel can withstand. While we employ 300 series steel allows in the assembly discussed below, higher temperature refractory metals could be employed if higher temperature was desired. In general typical supply gas manifolds can be built or purchased that deliver process gas through hermetically sealed metal tubes, valves and manifolds. In the context of ultra high purity sintering any metal tube that delivers process gas to a ceramic inlet tube (for example SiC ceramic) tends to require a tube adaptor that is highly hermetic, in order to avoid contaminating process gas with outside air, including for use at high temperatures including high tube temperatures above 200 C and up to 600 C or roughly the maximum service temperature of typical 300 series steels. We have identified our tube adaptor hermiticity requirements for the inlet tube adaptor to be similar to the specifications normally associated with high vacuum systems and hardware; that is any leak or diffusion through the adaptor during vacuum service should be undetectable by conventional He leak checkers having 10E-9 sensitivity and preferably better. This result has been achieved in a robust, low cost, manufacturable and reliable way in the manner described below and we apply it to the inlet tube, the vacuum pumping tube, and the sweep gas injection tube 426—which are all attached to the processing chamber base plate in FIG. 14. Having much less than IE-9 He leak rates for the inlet tube we apply the same technique to the vacuum pumping tube adaptor and the Peclet sweep tube adapter as well as for the main sweep gas seal 412 described in FIGS. 16 and 17.

Illustrated in FIGS. 23A and 24A each are an embodiment of a high temperature vacuum tube adaptor arrangement that mechanically adapts between a high or extreme temperature tube 2301 (having an inside 2302) and a conventional metal tube 2303 (having an inside 2304) and is configured to provide a sealing arrangement in a manner that allows some minor leakage of high purity sweep gas into the tube while substantially blocking leakage and/or diffusion of outside air into the tubes.

With reference now to FIGS. 23A-I, there is a tube 2301 having a hollow inside 2302. There is a high temperature metal tube 2303 having a hollow inside 2304. A non-hermetic gasket 2305 serves as a non-hermetic vacuum seal between a first gasket sealing surface 433′ and a second gasket sealing surface 433.

Reference numeral 2306 is a groove between an exposed internal perimeter 2307 of the Peclet seal (there being external perimeter 2308 of the Peclet seal in direct gaseous communication with outside air) and an isolated external seal perimeter of the gasket seal 2309 (there being an internal perimeter of the gasket seal 2310 in direct gaseous communication with the hollow interior of the tube 2302). Reference numeral 2311 denotes the external seal (i.e., a gap that is used as a Peclet seal, labeled in FIG. 23B having a flow path length L and a Peclet gap size G). Reference numeral 2312 denotes an injection channel for sweep gas (in many cases this can be configured as a tube). Reference numeral 2313 denotes the flow of sweep gas. Reference numeral 2314 denotes bolts for clamping the assembly. Reference numeral 2315 denotes a heater cartridge for optionally applying heat to the adaptor arrangement 2316 for example during debinding. Reference numeral 2316 denotes the adaptor arrangement which can include flange 2317. Reference numeral 2318 denotes the outside air [puffy cloud] surrounding the assembly. Reference numeral 2319 denotes the rigid retainer body.

Now with reference to FIG. 23B, the adaptor arrangement 2316 includes a retainer latch 2320 extends into indention 2321 and protrudes partially past the immediate outside of tube 2301. The retainer latch may be a split ring. Reference numeral 2322 denotes a retainer into which the extending portion of the retainer latch extends when in place. Reference numeral 2323 denotes a compliant element such as a wave spring.

Now with reference to FIG. 23C which is a blow up of parts of the embodiment of FIGS. 23A-B, reference numeral 2324 denotes a dust shield. Reference numerals 2325 denote thermocouples. Reference numeral 2326 denotes a power supply to heater cartridge 2315.

The tube can have one or both of (i) a flat end face circumscribing the hollow inside of the tube and (ii) a sealing surface around the outside of and end portion of the tube. The adaptor includes one or both of a flat confronting surface at faces the flat end face and a sealing surface that closely surrounds the outside end portion of the tube. The tubes and the adaptor flange are all composed of hermetically impermeable solids.

The seal includes a non-hermetic vacuum seal surrounded by an external Peclet seal, the Peclet seal being interposed between the internal seal and the outside ambient environment (for isolating the internal seal from any outside air including any oxygen, moisture or any other gaseous contaminants therein) such that in order to reach the non-hermetic vacuum seal any trace amount of outside air (or any gaseous contaminants therein) must first diffuse, leak, or otherwise pass first through the external Peclet seal before impinging on the internal seal.

The non-hermetic seal employs somewhat permeable, non-hermetic, vacuum sealing material. The gasket material could be a porous material such as graphite or graphoil, or it may be a elastomeric material including Silicone, Buna or viton all of which elastomers tend to exhibit significant gaseous diffusion and for purposes of this description can be regarded as non-hermetic. As a point of reference it is noted that copper gaskets used in ultra high vacuum systems can be considered as hermetic but they typically are not operable at the high temperatures (for example above 400 C) demanded by many of the systems and methods described herein.

The non-hermetic gasket can be sandwiched or otherwise disposed between a gasket facing internal sealing surface of the tube and a corresponding internal gasket sealing surface of a flange of the adaptor1 and the adaptor flange and vacuum pumping tube can be formed of a metal (such as 300 series steel or nickel) that can withstand high temperatures greater than 300 C and when vacuum is applied and the tube is surrounded by air the gasket can exhibit a gasket leak, at least in part due to the permeability, that would be of unacceptable magnitude if the internal seal were the only seal. Applicants have found various gasket materials, such as graphoil, that perform well enough for the system to achieve the base pressure of our vacuum pump, but not well enough to prevent contamination if the non-hermetic seal was surrounded by outside air with no Peclet seal. As is the case with our main retort seal of FIG. 14-FIG. 17, the internal non-hermetic seal described here allows us to operate across our desired range of vacuum pressures and the external seal provides by far the majority of blockage of outside air. In other words, the internal seal “does some of the work” by enabling the pump to pump down the system to the base pressure of the roughing pump (a rotary vane pump) and the external seal does “the rest of the work” by keeping oxygen and/or any outside air out to ppm or even to better than ppb levels of impurity inside the tube. The adaptor flange and/or the ceramic tube can include a groove disposed between the entire outside perimeter of the non-hermetic seal and the inner perimeter of the Peclet seal. A flange of the adaptor arrangement can include an injection channel that receives highly pure inert sweep gas and injects the sweep gas into the groove such that the entire exposed perimeter of the internal seal is entirely surrounded by sweep gas, and the external seal is a Peclet seal that is formed as a gap between a Peclet sealing surface portion of the tube and an opposing Peclet sealing surface portion of the adaptor body such that the sweep gas sweeps, through the gap from the groove to the outside ambient air, with sufficient velocity and for a sufficient flow path length L to suppress diffusion of outside air into the groove such that the groove is sufficiently uncontaminated by outside such that any sweep gas surrounding the inner seal gas leaking through the inner seal into the tube is acceptable. Isolation can be ppm or better, parts per 10M or better, parts per 1 OOM or better, or PPB or better. Sweep gas is typically high purity argon but can at times be another inert gas. In our systems the Peclet gap G is typically 0.001″ to 0.010″ and the injection flow rate is typically 0.01 slm to 0.2 slm for every two or three inches of circumference of the isolated perimeter of the Peclet seal. We often use a liquid argon container as the source since that gas tends to be very clean as long as the liquid argon dewar does not have significant air leaks. Any person of skill in the art, familiar with gaseous transport and diffusion phenomenon and having this disclosure in hand, including the above descriptions with respect to FIGS. 6-8 can readily determine the parameters to achieve sufficient sealing (isolation of air) in the contexts set forth above.

It is to be emphasized that the above description of the sealing mechanism for the adaptor of FIG. 23 applies to the main retort seal (in FIGS. 14 and 15) as well, and the principles of design and operation are equivalent. Remarkably, in both cases the performance with respect to isolating outside air from entering inside the chamber and tubes, respectively, is similar and in some cases better than the isolation provided by crushed copper gasket in the context of ultra-high vacuum systems. However, applicants remind the reader that the internal seal does allow some leakage and we note that in both cases the leak rate (of pure sweep gas from the groove to the inside of the chamber and/or tube) would typically be considered a gross leak that would be grossly unacceptable in the context of high vacuum systems (for example systems that operate at or below IE-6 Torr). In the applications described herein (such as metal sintering) the leak would be similarly unacceptable if the non-hermetic gasket were surrounded by outside air as opposed to high purity inert sweep gas.

In one embodiment shown in FIG. 23 a high temperature and/or extreme temperature pumping tube can have a flat gasket sealing face an inner portion of which can serve as an internal non-hermetic gasket sealing surface, and an outer portion of which can serve as the external sealing surface for example as an external Peclet sealing surface. Similarly, the adaptor body includes an opposing flat sealing surface (facing in a confronting relationship with the flat surface of the tube) an inner portion of which can serve as an internal gasket sealing surface of the adaptor, for example on the flange, and an outer portion of which can serve as an external Peclet sealing surface of the adaptor.

As shown in FIGS. 23A, 23B and 23C a flange of the adaptor arrangement can serve as one portion of the overall hermetic tube adaptor assembly that includes a retainer arrangement with a main retainer body supporting bolt holes for receiving bolts (either through-bolt holes or tapped) that can be used as illustrated to provide for sandwiching the gasket with a clamping force between the gasket surface of the main adaptor body and the gasket surface of the vacuum pumping tube. In the illustrated embodiment one or more retainer latch indents can be indented into outside surface of the vacuum pumping tube to receive one more corresponding high strength retainer latch objects. In this illustrated embodiment there is one continuous latch indent that circles contiguously around the tube and there is one corresponding hollow retainer latch ring (one latch object) that extends into a corresponding retainer latch indent and is supported thereby such the latch ring extends radially outward proud of the indent such that an outer perimeter of this latch ring is radially displaced outward from the adjacent outer surface of the vacuum pumping tube. A retainer lock can be configured to slide over the protruding porting of the latch object at least partially enclosing this protruding portion and in contact with at with at least some of this protruding portion in a way that constrains and therefore locks (prevents) the latch from exiting the latch indent as long as the retainer lock remains in place. The main retainer body can be forcibly biased against the retainer lock by bolt forces that are transferred through the retainer lock to press in against the latch to provide the constraining forces necessary to keep it in place. The opposing reaction force of the bolts provides clamping force of the gasket sealing surface, of the adaptor body, against the gasket.

In this embodiment the retainer latch is a split ring whereby the split allows it to be expanded during installation for sliding and or fitting around the tube to enable insertion into the corresponding retainer latch indent. In another embodiment we could employ two or more latch objects such as ball bearings and/or short rollers with each being received by one continuous latch indent (as shown) or by several indents with one or more latches in each. Applicants appreciate that there are many variations of latch objects and corresponding indents that can share the basic feature that each latch object can have an inner portion that protrudes into and can be supported by its corresponding indent and an outer portion that protrudes out of the indent such that the latch can be constrained from exiting the indent by a retainer lock having a locking feature that receives the protruding portion, enclosing it in contact therewith, and can be forcibly biased into the constraining position by bolts that extend from and/or through the adaptor body using various variations of the technique illustrated in FIGS. 23A-C.

Applicants appreciate that complex, accurate and/or ground features in ceramic tubes can be expensive and or impractical to implement and we further appreciate that the mechanism in FIGS. 23A-C should be considered as a highly advantageous approach at least for the reason that it requires no ground or otherwise complicated or high precision features in the ceramic. For example in our products we “green machine” the latch retaining latch indent with the SiC in the green (unsintered) state with no subsequent grinding or shaping after sintering of the SiC, and this low precision low cost feature fit for purpose since the overall design is highly tolerant of minor shape distortions thereof.

It is noted that the embodiment of FIGS. 23A-C includes a stiff wave spring stack interposed between the main retainer body and the retainer lock. The bolt force is transferring through the wave spring from the main retainer body and towards the retainer lock which further transfers the bolt force against the retainer latch as described above. We included this wave spring feature as a compliance between the latch object that the retaining arrangement to provide sufficient compliance to maintain the bias force throughout an expected range of thermal expansion and contraction that occurs over each cycle. This compliance can also be advantageous to reduce and/or prevent stress concentrations that may otherwise develop due to mechanical variation of tolerances and non-uniform features. The wave spring as employed in the above descriptions is but one of many ways that compliance can be introduced and any person of skill in the mechanical arts should really be able to introduce compliance into the clamping force in many other ways. For example, springs and washers could be used in the bolts and/or each bolt could have a stack of Belleville washers. In addition, flexural elements could be introduces integrally into the retainer body and/or ring.

It would be impractical to attempt to itemize all possible design approaches so instead attention is drawn to FIG. 23D which omits any details of the various arrangement and concentrates conceptually on concepts that are common to all embodiments described herein. In addition to a extreme temperature tube 2301 and a flange 2317 most or all of the embodiments described herein have common features including but not limited to:
(i) non hermetic gasket 2305 that requires compression.
(ii) a rigid retainer body 2319
(iii) a protruding feature that can be a separate retainer latch 2320 as is shown here or that can be integral to the tube as will be shown in a subsequent drawing.
(iv) a clamping arrangement 2327.

We recognize that in order to accommodate thermally mismatched materials it can be advantageous for clamping arrangement 2327 to exhibit sufficient compliance, at least in the axial direction defined by the tube, to absorb thermal mismatches as well as possible mechanical tolerance variations. As mentioned above it is quite beyond reasonable scope of this document to set forth all possible variations and applicants consider that a skilled mechanical engineer can conceive of an unlimited variety of variants that embody the concepts depicted in this figure. With ongoing reference to FIG. 23D attention is drawn to the fact that we did not explicitly add a feature element that provides compliance. In this regard the clamping arrangement 2327 is assumed to exhibit compliance by one or both of (i) inherent flexural compliance of whatever bolt or clamp is utilized and (ii) explicit use of one or more compliant elements such as springs, wave springs, or Belleville washers.

Still referring to FIG. 23D the applicant recognizes that this conceptual approach is especially advantageous when used in conjunction with a ceramic tube at least for the reasons that the overall adaptor arrangement can readily be configured to ensure that the dominant internal stresses within the ceramic are compressive and/or shear forces as compared to tensile forces. Ceramics generally tend to exhibit extreme high strength in compression, and this has allowed us to fully torque the bolts to their designated torque limit without damage to the ceramic. In fact, in some cases during stress testing we sheared the bolts without causing damage to the SiC. In general, this approach has proven highly robust and rugged and we find it to meet the standards that typical users expect from a piece of factory industrial hardware. We believe that this approach could be broadly useful for a range of ceramic to metal sealing applications and we further believe that it could prove useful in many applications where all that is desired is a thermally and mechanically robust connection between metal and any ceramic rod.

FIG. 23E illustrates one variation wherein a compliant element 2323 is interposed between rigid retainer body 2319 and a top surface 2328 of a protruding flange 2329 that protrudes radially outward from and is co-fabricated with the tube. A rigid nut 2330 tightens each bolt 2314. All other features of this hermetic adaptor are consistent with FIGS. 23A-C. It is noted that a compliant washer (such as a Belleville washer) though not shown could be used under each nut. There are various ways the flange could be configured as is illustrated FIGS. 23F and 23G which illustrate tubes that are terminated in flanges having tope surfaces of various contours.

FIG. 23H illustrates yet another variation in which the insertable latch of 23A is omitted and the tube is encircled by with a protruding portion fabricated therewith. The overall concept is similar to the flanged arrangement described immediately above and is operable in a similar way in which the retainer body bears down on the protruding section in similar manner as upon a radially protruding flange. The bolts can be tightened with nuts 2801 and could include Belleville washers disposed under each head of each bolt. As one of many potential variations that could be contemplated by a person of ordinary skill in the art, FIG. 231 illustrates (via top view) that engagement surfaces surrounding the tube do not necessarily need to encircle the tube in a continuous manner. Two or more engagement features 2050, having either protruding portions or indented portions or both, can be distributed around the tube and engaged upon by a matching retainer arrangement.

It is again noted that the main adapter body as shown in FIG. 23 can include one or more cartridge heaters inserted into the adaptor body. As described previously the heating of the adapter body can provide heating energy that can conduct into and up the vacuum pumping tube and this additional heating cooperates with heating power from the hot zone of the furnace to ensure high temperature, especially useful during debinding, across the entire length of the vacuum pumping tube. It is again noted that the high temperature maintained along the vacuum pumping tube can accomplish far more than simply preventing clogging. When employed in conjunction with Peclet sealing, it functions rather to prevent any buildup of contamination that could otherwise offgas back into the atmosphere during sintering, and this prevention of even small trace amounts of buildup facilitates the maintaining of ultra-high purity atmosphere within the inlet section of the extreme pumping tube and therefor contributes to purity of atmosphere in the chamber as well. While clogs can typically be avoided by maintaining tube temperatures well under 200 C, we have observed that prevention of trace amounts of buildup and contamination of the tube typically requires high temperatures well above 200 C very often above 300 C and commonly even above 400 C depending on the binder. We have generally stayed under 600 C at least in order to avoid stressing the metal parts (300 series steel) used in the adaptor assembly. Even for operating temperatures of under 500 C we consider it advantageous that the adaptor assembly allows for higher temperatures at least for the reason that this provides margin in the possible event of inadvertent over temperature for example during sintering. Without wishing to be bound or limited by precedent, we presently believe that best practice is to run with the pumping tube and the adaptor at peak debinding temperature which presently is 450 C for our current most frequently employed binder systems.

For use with the vacuum retort furnace of FIGS. 14-17 the performance of the tube adaptor is considered to be most critical on the inlet tube and on the sweep gas tube 426 that feeds sweep gas to the main retort seal. In the former case any leak directly contaminates the process gas and must be avoided. In the latter case any air that leaks into the sweep gas tube then can leak in through the somewhat porous internal gasket seal. We also use the same adaptor at the outlet of the pumping tube 10003 however we not that this use case is far less critical since some level of oxygen contamination at the outlet of the pumping tube is perfectly acceptable insofar as the pumping tube is operating as a Peclet seal to isolate its inlet from the outlet.

It is further noted, as was the case for the main retort seal, that the double seal variations with listed with respect to FIG. 19 all constitute examples of different arrangements that could be adopted with the tube adaptor with varying degrees of performance.

It should be understood that the above description readily scales to large sized tubes and could be applied to a tube furnace such the tube furnaces of FIGS. 20A-20D. In particular, the above technique can be applied to seal end cap 20008 against tube 20002. FIG. 24 illustrates various adaptations of the above described approach that can be employed for providing a high temperature seal connected a furnace tube to an end cap such as a flange.

FIG. 24A illustrates another embodiment of a high temperature tube adaptor that can also be utilized and adapted for small tubes such as high or extreme temperature pumping tubes, sweep gas feed tubes and inlet tubes. We have found this embodiment to be highly suitable for use in ultra clean tube furnaces such as those of FIG. 20A-20D to maintain a high performance seal to the end caps at high temperatures well above what elastomeric seals can tolerate. With reference to FIGS. 20A-D, 24 A-C and 26 B and C the tube furnace end cap can serve as an adaptor flange that can be sealably coupled and/or co-fabricated to a high temperature vacuum pumping tube which can be surrounded by insulation and/or heaters and utilized in accordance with above descriptions related to high temperature and/or extreme temperature vacuum heating tubes. The end cap of FIG. 24A can be operated at high temperature during debinding to minimize and/or prevent binder contamination thereon and to thus enable an ultra pure sintering atmosphere free of binder contamination and we are able to maintain ultra pure atmosphere during sintering. We have employed various variations of this technique enabling very low cost tube furnaces to sinter titanium, aluminum and other alloys that benefit from ultra pure sintering atmosphere. In other words, the flange and vacuum pumping tube in this context (tube furnace) can be employed to prevent condensation just as we do with the system of FIGS. 14-17. During debinding in these tube furnace embodiments the entire tube, end cap(s) and pumping tube can all be maintained at debinding temperature during debinding. For all our binders this has succeeded at preventing even trace amounts of binder contamination and we are able to maintain ultra pure atmosphere during sintering. Reference numeral 2401 may be a second compliant element as previously described.

FIG. 24B illustrates a variation that can be more easily removed for loading and unloading parts into and out of a tube furnace. As described earlier in reference to FIG. 23D, there are many ways clamping and compliance could be employed. In this illustration the semipermanent rigid retainer body 2415 can be split in two and fastened together using screws or bolts to capture the retainer body in place over and around a protruding portion of latch 2416 and prevent relative motion in either axial directions, so that it does not slide away while the user removes and replaces the end plate. This may be a more user friendly configuration that could the user to open and close the furnace more easily as compared with some previous embodiments. For example, two or more pivotable clamp mechanisms 2417 could be disposed around the door and could each be pivoted around hinge axis 2418 for releasing and re-clamping the hermetic tube adaptor. A compliant element 2411 could be introduced that compresses in a compliant way as the clamp is pivoted into final place. Alternatively, the pivotable clamp mechanism could include a flexural section that provides adequate compliance. The clamp mechanism includes an engagement surface 2419 that slides into contact with the retainer body and or the compliant element and this surface can be tapered in various ways (taper not shown) as necessary to facilitate smooth engagement and disengagement.

FIG. 24C illustrates yet another embodiment for implementing a door in a tube furnace that may be still easier for a user to manipulate. It includes a high temperature hermetic tube adaptor fixed adaptor flange attached and sealed, for example based on the techniques of 23 A-C with an internal gasket seal and an external Peclet seal. The fixed adaptor flange remains in place during loading and unloading while the latchable door also includes a double seal including a non-hermetic internal door gasket seal and an external Peclet seal. This configuration includes a door groove 2420 into which additional sweep gas 2421 can be injected with the groove surrounded by yet another Peclet seal 2422. Two or more user operable door clamps 2417 can be disposed around the perimeter of the door. These could be user accessible bolts (not shown) or pivotable clamps the same or similar to those described immediately above. Applicants are unaware of any other furnaces wherein a user operable furnace door can remain sealed at temperatures in the range of 350 C to 600 C as can readily be achieved in this embodiment.

As described previously vacuum pumping tubes can be configured to support ultra pure sintering atmosphere in part by preventing contamination from condensing in the tube during debinding. Additionally, high temperature vacuum pumping tubes can be configured to employ process and or sweep gas to provide for Peclet sealing/i solation between an outlet end thereof and the inlet end and can de so to ppm through ppb and even better if needed, also facilitating ultra high purity sintering. It should be understood that prevention of condensation of binder in the pumping tube can eliminate clogging with such high efficacy as to allow for inside tube diameters smaller than would be practicable in the presence of binder tube build up. Applicants recognize that this freedom to use a small tube is fortuitous at least for the reason that Peclet isolation along the tube length requires smaller amounts of gas flow as the tube diameter decreases. On the other hand, it can be beneficial to employ a binder trap that operates at low temperatures (for example room temperature). In addition to lower temperature binder trapping generally demands that the velocity of gas flow should be significantly slowed compared to the high velocity that is desired within the pumping tube. We have developed systems and methods for transitioning the pump flow from the high temperature adaptor to a modest temperature larger diameter exhaust tube that can be sealed to conventional vacuum hardware that uses elastomeric seals to connect to a binder trap or any other vacuum hardware such as valves, tubes, pumps and manifolds. Applicants have learned through operational experience that it can be important to provide an exhaust design that transitions from high temperature and small diameter (where binder condensation is prevented and Peclet sealing is facilitated) to a lower temperature and large diameter exhaust tube, lower “trapping temperature” inside a binder trap.

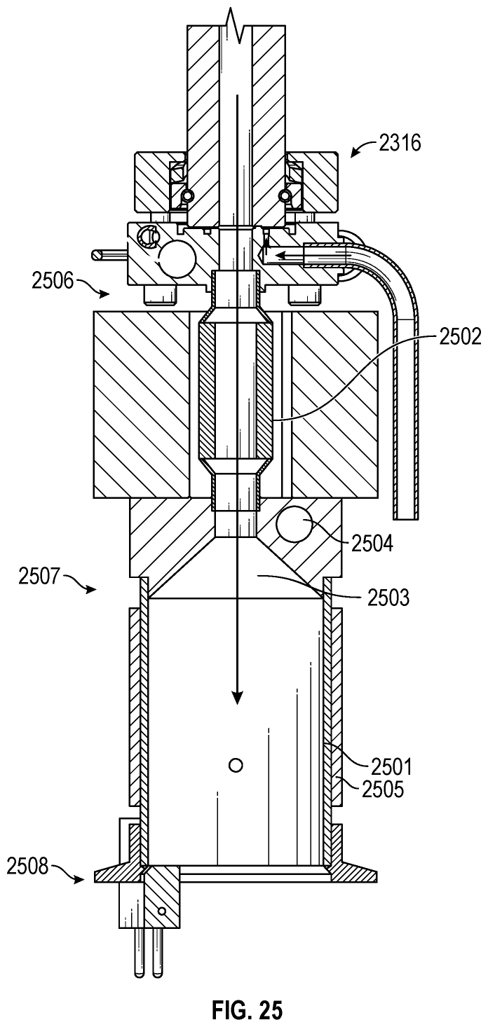

One embodiment of a such transition, from a high temperature tube adaptor (consistent with FIGS. 23A-C to a lower temperature larger diameter steel exhaust tube 2501, is illustrated in FIG. 25. With reference to FIG. 25, there is a high temperature or an extreme temperature pumping tube sealably arranged in gaseous communication with a high temperature tube adaptor arrangement (for example as described in FIG. 23A-B and reference numeral 2316), which in turn is connected to a high temperature flexible bellow 2502, a flange cartridge, is employed to control and maintain the flange at high temperature at least during debinding. The flexible bellows terminates in a tapered flange 2503 that includes a secondary heater cartridge 2504 that can be controlled to prevent excessive cooling of the downward end of the flexible bellows and therefore to prevent clogging therein. The tapered flange aggressively tapers to a much wider diameter in the shortest possible length span. This larger diameter is empirically and iteratively designed to be adequately large to prevent clogging. Exhaust tube 2501 has an inner diameter also large enough to prevent clogging and it can optionally include an exhaust tube heater 2505 that runs the tube at much lower temperature than debinding, for example 50C-80 C, but is also thermally compatible with elastomeric seals. At points 2506 and 2507 the exhaust is at a temperature such as 450° C. while at point 2508 the exhaust is at less than 130° C. [0148] Having described numerous systems and methods for facilitating ultra-pure atmosphere during sintering of parts, attention is returned to FIG. 12 which schematically illustrates the various fundamental concepts that have been enabled in a wide variety of different embodiment in the more detailed descriptions that follow it. Summarizing the key concepts that have been described:

Furnace insulation, in conventional furnaces, is regarded by applicants as one of the more pernicious sources of contamination during sintering. One reason is that the very nature of furnace insulation is to maintain a hot zone separate from an outer colder zone and it follows that during debinding the cold zone (outer insulation and inside surrounding vacuum chamber) tends to collect binder by condensation which tends to be re-emitted during sintering. Multiple approaches to eliminate furnace insulation have been described herein. In general, with no insulation in the chamber it becomes feasible to prevent even trace amounts contamination (for example from binder contamination) of the entire system by maintaining debinding temperature (for example 250-500 C) throughout all portions of the vacuum system that are in direct gaseous communication with the process chamber including inlet tube, the chamber, any chamber extensions thereof and the pumping chamber—in other words any section of the system in close gaseous communication with the sintering chamber. Having prevented contamination in the critical vacuum jacket (inlet tube, chamber, any chamber extensions, and pumping tube) the next concept is to prevent, at least during sintering, any back-streaming from the vacuum pump, binder trap, valves and other components of the vacuum manifold—this can be accomplished with Peclet sealing by the pumping tube.

In one embodiment that excludes insulation from the critical vacuum jacket, the vacuum chamber including the major opening (main retort seal) is within the furnace hot zone surrounded by furnace insulation and furnace heaters and the inlet and outlet tubes extend through the insulation. In order to achieve pure sintering atmosphere, the main seal is configured as a double seal having a leaky ultra-high temperature internal seal (a graphoil gasket) surrounded by and isolated by a high performance external seal (a Peclet seal). In such embodiments the critical vacuum jacket can be considered as the inlet tube, the pumping tube and the chamber defined by the retort dome and base plate. The pumping tube is configured to operate at extreme temperature along at least a major portion of its length and can be designed with appropriate diameter and length to operate, across a predetermined range of process gas flows (e.g., 0.05 to 10 slm), as a Peclet seal to isolate its inlet (and therefore the process chamber) from gaseous contamination at the outlet. In cases where the retort base and tubes are ceramic the inlet tube, extreme temperature pumping tube, and the sweep gas tube that feeds the main retort seal with sweep gas can all be terminated with a high temperature hermetic tube adaptors one of which adapts the pumping tube to a metal exhaust tube that can be heated but is designed to operate at progressively lower temperature as it transports exhaust towards the pump and/or towards an optional binder trap. It is noted that the exhaust tube is not considered as part of the critical vacuum jacket and in this configuration it can be highly contaminated with no deleterious consequence to the parts. It is noted that he tube adaptors enabled herein operate according to the same fundamental principles as the main retort seal.

In another set of embodiments that excludes insulation from the critical vacuum jacket, the vacuum chamber can be a tube furnace for which the critical vacuum jacket can be taken as including the inlet tube, the furnace tube, and the furnace end plate(s). The furnace tube can be comprised of one processing section where the parts are sintered at full sintering temperature and one or two chamber extensions that operate at progressively lower temperature as they extend towards and ultimately terminate at a corresponding end plate. In order to achieve pure sintering atmosphere, the end plate(s) are configured with a double seal having a leaky ultra-high temperature internal seal (a graphoil gasket) surrounded by and isolated by a high-performance external seal (a Peclet seal). The pumping tube is sealed to an end plate configured to operate at high temperature along at least a major portion of its length and can be designed with appropriate diameter and length to operate, across a predetermined range of process gas flows (i.e., 0.05 to 10 slm), as a Peclet seal to isolate its inlet (and therefore the process chamber) from gaseous contamination at the outlet. The chamber extension(s) and the end plates, both part of the critical vacuum jacket, can be controllably heated during debinding by separate heaters, and they can be thermally insulated by their own respective insulation arrangements separate from the main furnace insulation.

In the remainder of this section (entitled “Excluding insulation from the vacuum chamber”) we will set forth a number of combinations while in many instance omitting repetition and repeated descriptions of the details of the various aspects and elements. For all of the following combinations it is considered that the detailed features therein have been set forth in a manner that will enable a person of ordinary skill in the art to which the present application pertains and having the present disclosure to execute successfully. FIG. 26A Shows a ceramic retort furnace 26000 as in FIG. 14 having inlet tube 26002 for injected process gas from a process gas source 26001, a sweep gas feed tube 26003 for injecting Peclet sweep gas into the external Peclet seal of the main retort seal and supplied by sweep source 26004. (In some cases sweep gas and process gas may be the same and flow from the same source.) The chamber of the furnace can be vacuum pumped through extreme temperature pumping tube 26005 which terminates in heated high temperature hermetic tube adaptor 26006 and adapts the vacuum pumping tube to a metal exhaust tube 26007 that runs at progressively lower temperature as it extends toward and can be sealed to an optional three-way valve 26008. During debinding the valve can direct exhaust flow into a binder trap 26009 while vacuum pump 26010 provides vacuum pumping of exhaust while maintaining vacuum pressure in predetermined range of pressures. After debinding and during sintering the three-way valve 26008 can be activated to redirect the process flow gas to pump 26010 by way of bypass tube 26011. The retort serves as a vacuum chamber and is surrounded by furnace insulation and furnace heaters (not shown in FIG. 26A but it should be understood from other Figures such as, for example, FIGS. 14-15 the potential configurations of such elements). It is noted that the various components herein can be configured and operated together in accordance with detailed descriptions above. For example during debinding the high temperature tube adaptors can be heated by internal heater cartridges (not shown) such that all the tubes are maintained at high temperature for example >300 C and oftentimes being maintained approximately at the debinding temperature. Those cartridge heaters can be deactivated some time interval after debinding is complete as the upper portions of the tube approach sintering temperature of the parts that are being sintered inside the chamber.

FIG. 26B shows a double ended tube furnace 26020 as in FIG. 20A having metal end plates 26021 and 26021′ according to FIGS. 24A-26C using double seals 26022 fed by with sweep gas by sweep gas source 26023. The junction between the tube and each end plate serves as a hermetic tube adaptor and can be achieved in various ways as disclosed previously in this description for example in reference to FIGS. 24A-C. One end plate 26021 includes a high temperature heated vacuum pumping tube 26024 welded to or machined therewith and the high temperature vacuum pumping tube transitions to a vacuum pumping tube 26025 that supports a temperature gradient from one end to the other such that it operates at progressively lower temperature as it extends towards the pump 26026 through a binder trap 26027. The exhaust tube can be maintained just hot enough to avoid clogging but not necessarily hot enough to prevent binder contamination therein. As described previously highly purified process gas can flow through pumping tube 26024 to provide for Peclet sealing that prevents binder vapor and other gaseous contaminants from back streaming into the tube furnace. It is noted that in this description vacuum pumping tubes can be referred to interchangeably as exhaust tubes. During debinding the entire furnace tube, endplates and pumping tube are maintained at sufficiently high temperature, well above 250 C, to prevent binder contamination throughout the critical vacuum jacket that comprises the inlet tube, the processing section of the furnace tube 26028, the extensions 26029 and 26029′of the furnace tube that terminate in the end plates 26021 and 26021′, the inside of the end plates, and the high temperature metal pumping tube. The main section of the tube can be insulated by furnace insulation 26031 and furnace heaters 26032 and the extensions and tubes are surrounded by separate high temperature insulation 26033 and 26033′ and separate high temperature heaters 26034. The pumping tube and the exhaust tube can be co-fabricated or welded with one another with an appropriate flange 26035 to transition over any change in diameter and or shape. Inlet tube 26030 can supply process gas from a process gas source 26036 that also serves as sweep gas for the pumping tube. In some cases, the sweep gas for the end plates and the process gas for the inlet tube may be the same and may flow from the same source. End plate can 26021′ can be hermetically sealed and/or cofabricated with a metal inlet tube 26030 that receives process gas flow from process gas source 26036. T. In some cases process gas and sweep gas may be the same and flow from the same source. The exhaust tube can terminate in an optional three-way valve 26038 that can direct outflow of gases from the furnace through binder trap 26039 during debinding and after debinding can redirect the flow through bypass tube 26040

FIG. 26C shows A single ended tube furnace having one end plate that includes inlet tube tube and pumping tube. All features are numbered consistently with the numbers in 26A.

FIG. 26D shows a vertically oriented single ended tube furnace configured as in FIG. 26 but that uses the same basic double seal design of the system of FIGS. 14-17. This system allows for the tube to be held down by gravity and like the vacuum retort of FIG. 14 the double seal does not require clamping and retaining mechanisms.

FIG. 26C shows a vertically oriented tube furnace having a metal base plate that is configured as shown in FIGS. 14-17 but it is metal as opposed to ceramic. The single ended tube furnace can be configured as in FIG. 14. The vertical orientation eliminates any need for clamping and retaining mechanisms. All parts numbered consistent with prior figures.

As mentioned above, furnace insulation in conventional furnaces is regarded by applicants as one of the more pernicious sources of contamination during sintering. One reason is that a basic function of furnace insulation is to maintain a hot zone separate from an outer colder zone and it follows that during debinding the cold zone (outer insulation and inside surrounding vacuum chamber) tends to collect binder by condensation which tends to be re-emitted during sintering. We have described several embodiments that use additional and separate “outer” heaters outside the furnace insulation to eliminate the presence of any cold zone during debinding. These systems and methods do not tend to achieve the astonishing levels of purity associated with the insulation free solutions described herein above, but they have nevertheless proven to be very effective with respect to managing binder contamination and impressive results have been demonstrated. The reasons for this relative lower purity is are at least twofold. For one thing the door seal tends to be sealed by a large elastomeric o-ring or gasket (not shown) and this can prevent us from heating the door-adjacent portions chamber much above 250 C. As mentioned previously most common binders can generally be expected to condense and contaminate surfaces at the modestly hot temperature 250 C, although there will still be far less build up as much as will otherwise condense on the walls at a wall temperature of, for example, 30 C during debinding. It is possible to distribute the outer insulation and chamber heaters to run substantially hotter than this as long as measures are taken to protect the elastomeric seal, however this basic issue still remains and certain binders can condense somewhat on the chamber walls. Furthermore, compared to the insulation free embodiments, there will tend to be orders of magnitude more exposed surface area in the furnace insulation in the chamber. This surface area at 250 C will generally attract and retain greatly more than an insulation free furnace but far less than if the outer heater is not used. The full benefit of this approach generally cannot be realized without the use of a high temperature pumping tube that is arranged as a Peclet seal to isolate its outlet from its inlet. Without this step, the pumping tube tends to get contaminated or even clogged and in the absence of Peclet sealing contaminated portions of the tube tend to remain in gaseous communication with the vacuum chamber some of that contamination can diffuse therein.

FIG. 22B illustrates a system that operates according to this approach and combines outer heaters 298 with a high temperature vacuum pumping tube 73. There are three sets of dashes lines indicated the three possible positions of the outer heaters as described in reference to FIG. 22 above. Applicants recognize that high temperature hermetic door seal can be executed in the manner described herein such that the insulation and chamber can be heated during and after debinding to temperatures well above the 250 C-300 C limit common to elastomeric seals. In such a configuration excellent results are to be expected in regards to purity of sintering atmosphere.

Having Described various embodiments of hermetic tube adaptors we summarize various aspects with some additional clarifications.

We begin by clarifying the term “hermetic” as it is intended to apply in the context of these descriptions. We note that any person of ordinary skill in the art of vacuum technology should be familiar with Helium leak testers capable of detecting He leaks as low as 10E-9 Torr Liters per Second (TL/S) or below. In fact, state-of-the-art instruments now are available that reach sensitivity levels of 10E-12 TL/S for detection of He leaks which is an extremely fine leak by any standards. In practice, leaks are often referred to as gross leaks when they become so large that leakage of Helium therethrough saturates the leak detector. For purposes of these descriptions, it is to be emphasized that we do not consider elastomeric gaskets as being truly hermetic even when they are installed and operating properly. In this regard, we maintain similar standards as employed with state of the art semiconductor fabrication equipment where elastomeric gaskets are often disallowed in favor of all metal copper gaskets. As any person of ordinary skill in the art to which the present disclosure pertains will understand typical elastomeric o-rings and gaskets can register significant diffusion when tested using He leak testers wherein continuous exposure of 10 minutes or more to He gas will eventually result in a steady state signal of 10E-8 or greater depending on the elastomer and the seal geometry. We have described systems and methods herein that deliver orders of magnitude of better hermiticity even at high temperatures between 200-700 C for some embodiments, and for extreme temperatures above 800 C for others. For all the embodiments described herein we have routinely connected state of the art He leak testers to our system and have consistently achieved hermiticity two or more orders of magnitude better as compared to elastomers. In general, we routinely achieve hermiticity of 10E-9 TL/S and better when evaluated using He leak testers.

In cases where the gasket is highly porous and results in a gross leak, the leak rate can be detected and measured using a standard technique known to experts in vacuum technology wherein a vacuum valve isolates the pump and an operator monitors a resulting rate of rise over a period of seconds or minutes in chamber pressure. This technique is sometimes referred to as “leak up testing” and can be useful for detecting and measuring gross leaks that are so large as to saturate sensitive instruments such as Helium leak testers. We often utilize leak up testing to measure the leak rate through a given graphoil gasket.

Concerning the term “adaptor” it is emphasized that the adaptor arrangements described herein are configurable for operation at high temperatures and even extreme temperatures limited only by the gasket, flange and tube materials employed. Persons skilled in vacuum technology will appreciate that commercially available adaptors, especially ceramic-to-metal adaptors are generally not widely available for temperatures much above 400 C.

We have described tube hermetic tube adaptors, including ceramic-to-ceramic and ceramic-to-metal tube adaptors that operate at high and/or extreme temperatures limited only by the tube, gasket and flange materials employed. In particular, we describe adaptors that employ an inner non-hermetic gasket that is surrounded a Peclet seal that is fed by a highly purified sweep gas and arranged such that during operation the inner seal is surrounded by this purified sweep gas and not by outside air.

In one aspect this configuration ensures that any gas leaking into the tube from around the inner seal only contains (i) sweep gas and (ii) some trace gases that may have diffused from inside the tube and then leak in. Regarding sweep gas, an operator and/or system designer can provide for sweep gas to whatever degree of purity is required and can operate with confidence that the sweep gas is not contaminated by outside air to parts per billion or higher degree.

It is noted that the embodiments described herein are generally operable at high and/or extreme temperatures in part because these configurations tend to be tolerant of relative motions within the assembly that can result from coefficient of thermal expansion (CTE) mismatch. For example, the various embodiments of high temperature ceramic to metal adaptors described herein are generally tolerant of different rates and amounts of thermal expansion that arise between a ceramic tube and a metal flange. In general, these configurations can provide for hermetic connection up to and including the maximum operating temperature of the material employed by the tube, gasket and flange. In particular, the adapters tend to be operable as long as thermally induced melting, warping or other unpredictable or poorly behaved deformations that result above and beyond the expected degree of thermal expansion. We are unaware of any commercially available ceramic to metal tube adaptors that are so forgiving of CTE mismatch (between the ceramic and the metal) and that can deliver hermetic performance under such a range of temperatures.

In yet another aspect, it is to be understood that an adapter between a given tube and a given flange, can also be configured to adapt from a first tube to a second tube with the second tube being configured in gaseous communication with the flange. Indeed, for most of the embodiments described herein the intention has been to hermetically adapt between one tube and another and the hermetic adaption between a first tube and a flange (with flange connected to a second tube) facilitates this goal. The term flange has been used very broadly throughout the present disclosure and could be considered or described by other terminology such as “adaptor body” or “adaptor arrangement”. In this regard the term flange is not considered as being limiting with regard to shape or geometry insofar as that adaptor arrangement or body includes the features and functions described herein.

In still another aspect it is to be understood that “outside air” and “outside ambient air” should be regarded as whatever gas surrounds the outside perimeter of the Peclet seal. In most of the embodiments above this happens to be ambient air consisting of earth's natural atmosphere at ground level. However, we do not intend the present disclosure to be so limited and it is emphasized that the systems and methods described herein can be employed to hermetically isolate against ingress of any outside gas in which the assembly is employed.

With the above considerations in mind, we have described hermetic tube adaptors that can be configured to provide for hermetic sealing between a tube and an adaptor arrangement each of which is composed of material that can be the same or different and are both hermetically impervious to diffusion of gases therethrough. A hollow tube could be a double-ended or a single-ended tube and thus can include at least one open tube end such that a hollow interior of the hollow tube terminates at the open tube end which supports thereon a first gasket sealing surface that circumscribes the open termination of the first hollow interior. There is no requirement that the tube should have a circular cross section and the systems and methods herein can be readily adaptable to tubes of various cross sectional shapes.

The adaptor arrangement can include:
(i) A flange composed of a hermetically impermeable material. The flange can include a gasket sealing surface having a shape that matches and faces the gasket sealing surface of the tube such that a vacuum gasket can be sandwiched between the gasket sealing surfaces.
(ii) A gasket serving as a vacuum seal composed of a non-hermetic gasket material sandwiched between the first and second gasket sealing surfaces. The gasket need not be hermetic and needs only to provide for (a) a sufficient degree of gaseous blockage so as to avoid excessive load to a selected vacuum pump, and for (b) any leakage through the gasket should result in at least an order of magnitude less gas flow than is consumed by the surrounding Peclet seal. We consider that the gasket performs a primary function of making vacuum possible, for example, within reasonable range of the specified base pressure of a given vacuum pump, while the outer Peclet seal performs a primary function of hermetic isolation relative to the outside air. Regarding the former, any person skilled in vacuum technology will appreciate that any mechanical vacuum pump such as a scroll pump, rotary vane pump or piston pump typically exhibits a given base pressure that it can obtained in the absence of any leakage or other gas flow into the pump. In our embodiments, leakage through the graphoil gasket is typically small enough so as to allow any of these mechanical pumps to approach an inlet pressure equilibrium well within the order of magnitude of their specified base pressure. Nevertheless, in the absence of the outer Peclet seal that equilibrium pressure would predominantly consist of air from the outside and should be considered as far from hermetically isolated therefrom. Yet in these same embodiments utilizing the outer Peclet seal, the presence (inside the hollow tube and/or a chamber and system connected to it) of outside air can be rendered undetectable even with state of the art laboratory grade instruments such as Helium leak detectors and other vacuum based mass spectrometers.
(iii) A mechanical clamping arrangement that mechanically engages both the hollow tube and the flange and is configured for clamping the first and second gasket sealing surfaces towards one another to cause compression force upon the open gasket. Various embodiments of clamping arrangements are disclosed.

More particularly, the heretic tube adaptors herein rely upon a sealing arrangement that relies upon a series arrangement of serval features that can include the following three elements:
(i) The gasket and the Peclet seal in which the gasket, serving as a non-hermetic vacuum seal, exhibits at least some gasket leakage as a gaseous diffusion through and/or around the non-hermetic gasket of any gas that surrounds an outer periphery of the gasket.
(ii) A groove in one or both of the tube end and the flange disposed around an outer perimeter of the open gasket and configured to receive a flow of oxygen free sweep gas that is injected therein through an injection channel within the flange such that the sweep gas surrounds the outer periphery of the gasket. The injection channel can be a tube that is hermetically sealed to and or co-fabricated with the flange. In many of our embodiments we often utilize standard off the shelf SWAGELOK@ of Solon, Ohio brand tubes and fittings for this purpose.
(iii) The external Peclet seal surrounding the vacuum gasket and interposed in a series arrangement between the vacuum gasket and the outside ambient air, and configured to receive the flow of oxygen free sweep gas to provide diffusion sealing, by gas flow of the oxygen free sweep gas, from an interior perimeter of the Peclet seal, in gaseous communication with the groove, to an outside perimeter of the Peclet seal, gaseous communication with outside ambient air, such that the Peclet seal can hermetically isolate the open gasket from outside ambient air. It is again emphasized that the term outside air refers to whatever atmosphere surrounds the outside of the assembly. For example, during testing with a Helium leak checker, the outside air could be 100% Helium gas.

It is generally to be recommended that the Peclet seal be configured such that a majority of the flow of oxygen free sweep gas flows through the Peclet seal and only a trace minority of the oxygen free sweep gas flows through and/or around the gasket as the leakage. In other words, the gasket seal should be tight enough that only a tiny fraction of the Peclet flow escapes into the gasket as opposed to flowing through the Peclet seal. With this criterion being established a properly configured Peclet seal, designed in accordance with the theoretical equations presented in the above descriptions, can result in a mode of operation wherein the non-hermetic vacuum seal provides sufficient sealing to support and allow for a desired and pre-determined vacuum pressure within the hollow tubes, yet would not provide sufficient henniticity in the absence of the Peclet seal, while the Peclet seal provides for sufficient hermetic isolation from the outside air with sufficient velocity of flow such that the leakage through and/or around the non-hermetic gasket seal is hermetically free of outside air.

In general each Peclet seal has an inlet in gaseous communication with the groove for receiving the sweep gas therefrom, and an outlet in gaseous communication with the outside air. The sweep gas can flow along a Peclet flow path length L from the inlet to the outlet such that the sweep gas flow causes suppression of back diffusion of the outside air to provide for the isolation. The descriptions above include appropriate details such that a person of ordinary skill in the art to which the present application pertains can achieve this result provided that the Peclet gap G is very uniform throughout the gap. In our embodiments we achieve sufficient uniformity and flatness of the Peclet sealing surfaces by relying upon precision grinding as opposed to machining. For cases where the tube is ceramic we typically grind the Peclet sealing surface in a straightforward post processing step using conventional precision grinders with diamond abrasive tooling.

In some embodiments the hollow tube includes a first Peclet sealing surface that is on an end face of the tube perpendicular to the tube, and the flange of the adaptor arrangement includes a second Peclet sealing surface that faces and matches the shape of the first Peclet sealing surface such that the two Peclet sealing surfaces define a Peclet Gap G as a gap size therebetween. In other embodiments the Peclet sealing surface can surround the tube (for example in the tube Peclet gap seal 20021 of FIG. 20D); in particular, a first Peclet sealing surface (of the tube) can be disposed on an end portion extending along the tube axially from the rim of the tube for the path length L, so that it wraps around and encircles that end portion and faces radially outward. This seal surface can be surrounded and encircled by the opposing, second Peclet sealing surface also extending along the axial direction for the flow path length L and radially facing inward such that the two opposing Peclet sealing surfaces define the Peclet gap G as a gap size therebetween. IN our applications gap size G typically ranges between 0.003″ and 0.030″ with Peclet flow paths ranging from 2 mm to several centimeters. For larger gaps, such as a 0.030″ gap, longer length and greater flow can readily compensate for this expanded gap size, all in accordance with theoretical equations set forth earlier.

The hermetic tube adaptor can be arranged for hermetically connecting one tube to another so that the hollow tube serves as a first hollow tube and a second hollow tube is sealed and attached to and/or co-fabricated with the flange such that a hollow interior of the second hollow tube is arranged in gaseous communication with the hollow interior of the first hollow tube. In such cases the gasket can be configured as an open gasket having an inner perimeter that defines an opening that allows for the gaseous communication between the interior of the second hollow tube and the hollow interior of the first hollow tube. In these embodiments the open gasket can be configured as a peripheral gasket that extends around the open rim of the first hollow tube.

We recognize that the hermetic tube adaptors described herein can be operatable at various temperatures including room temperature and lower. However, these systems and methods are generally most advantageous for high temperatures (300 C and above) particularly when connecting thermally mismatched materials like a ceramic tube to a metal one having a very different CTE between them. Experts in vacuum technology will be familiar with highly hermetic ceramic-to-metal adaptors that employ brazing techniques to provide a hermetic joint between the two thermally mismatched materials. These designs require careful design and analysis in order that temperature variation does not result in stress fractures in the ceramic tube, and commercially available ceramic to metal adaptors typically cannot operate much above roughly 300 C-400 C depending on the specific design and application. Many of the embodiments described herein are employed to provide ceramic to metal seals that we routinely operate at far higher temperatures and these assemblies typically only fail when the temperature exceeds the maximum operation of the metal flange and/or tube. We have routinely employed these techniques using ceramic tubes composed of a refractory ceramic that can withstand temperatures at or above 800 C and is composed of one of (i) porcelain (ii) mullite (iii) alumina and (iv) SiC. These ceramic tubes can be extended into the hot zone of a sintering furnace configurations, insulated by extreme temperature insulation, with the adaptor being disposed outside the extreme temperature furnace insulation but nevertheless operated throughout a cycle at high temperatures for example ranging between 300 C and 700 C (for example to avoid condensation of binders). In such embodiments the hermetic the adaptor flange can be composed of a high temperature metal that can withstand temperatures at or above 300 C and in some cases as high as 700 C. In general, we select a gasket material that can meet and/or exceed the maximum operating temperature of the metal. If a gasket having a lower maximum temperature is selected, then the gasket material becomes the limiting factor in determining maximum operating temperature of the overall hermetic tube adaptor.

In order to facilitate clamping, the tube can include one or more engagement features, disposed around an outer surface of the tube, each of which features includes a ledge surface that tilt away from the end of the tube such that each ledge surface is engageable by the clamping mechanism such that at least a component of the clamping force can result as counteracting force that is balanced against the force of engagement upon the ledge.

In many of our embodiments there may be just one engagement feature that continuously encircles at least the majority of an outer diameter of the hollow tube to provide a corresponding ledge surface around the diameter. For example, in FIGS. 23A-D 2319 is illustrated. In some embodiments the engagement feature can includes an indentation having the ledge surface therewithin such that each ledge surface is inwardly recessed from the outside surface into the wall of the tube. For example, in FIGS. 23A-C and indented features 2321 are illustrated. A retainer arrangement can be provided that includes:
(i) A main retainer body can be provided that encircles the hollow tube and supports a first set of through-bolt conduits arranged in a bolt pattern that also encircles the hollow tube. The adaptor arrangement can include a second set of through-bolt conduits that matches the first set. A set of adaptor bolts configured to pass through the matching patterns of bolt holes thereby connecting the main retainer body and the adaptor arrangement and the set of bolts when tightened can provide clamping force to compress the gasket.
(ii) one or more latches each of which includes an inserted portion that extends into an associated indentation and a protruding portion that extends radially past the immediately adjacent outer surface of the tube, and the retainer arrangement can be positioned to surround the protruding portions of the latches to transmit at least a component of at least some of the clamping force from the main retainer body though the latches and upon the indented ledge surface

In one aspect the retainer arrangement can include a retainer lock configurable, when placed in final position, with the protruding portion of each latch in direct contact therewith such that the retainer lock radially contains the latch mechanism such that the inserted portion of the latch is fixedly trapped within its associated indentation. This approach has proven to be forgiving with respect to dimensional tolerances and highly robust with respect to axial force and gasket compression—so much so that in our prototypes excessive axial force cannot seem to cause removal of the trapped latch mechanism unless and until the clamping force exceeds the mechanical strength of at least one of the ledge, the latch, the retainer lock and the main retainer body. Even when we greatly overtighten the bolts nothing in the assembly fails until either a bolt snaps or one of the elements fails in shear. Remarkably we have yet to create a failure mode in which our SiC ceramic tube fails. As a general design rule we tend to size the bolts so as to fail in shear before any of the mechanical failure forces are exceed and this prevents loss and damage of parts in the event of over torque of bolts.

As mentioned above the approach can be very forgiving of geometric variation, including within the groove of the ceramic tube. This can be an important consideration since ceramic parts can tend to have somewhat sloppy as-sintered tolerances and we wish to avoid costly post process shaping by grinding. For embodiments that use an indented groove we have configured the latch as a ring shaped element thing that drops into the groove and is sufficiently bendable to conform to any irregularities of the groove and/or the ledge at a fraction of the final gasket compression force while being sufficiently stiff to withstand the compression force without mechanical failure. In some embodiments the groove is semi-circular with crude tolerances and we employ a latch consisting of a tightly wound extension spring composed of high temperature steel and the spring has an outer diameter that matches and is receivable within the semi circular cross section of the groove (e.x., reference numeral 2323 in FIGS. 23A-C).

Having just describe an indented engagement features we recognize that the engagement feature could forms a protrusion that continuously encircles an outer diameter of the hollow tube to provide a corresponding ledge surface around the diameter. This approach can reduce part count and simplify the overall mechanism.

A protruding engagement feature could be one that forms flange that extends radially outward from the tube and the ledge forms a major surface of the flange on an opposite side of the flange from the gasket sealing surface. Various embodiments of flanges should be readily apparent to a person skilled in mechanical design. Several such embodiments are illustrated in FIGS. 23E-H including (i) a flange that flat such that the ledge is generally perpendicular to the tube, (ii) a flange that is tapered such that the ledge tilts at an outward angle with radial components pointing away from the hollow tube, and (iii) flange is rounded in one of a convex or concave manner.

Various embodiments that rely upon a protrusion and/or a flange can employ a retainer arrangement that encircles the hollow tube in close proximity to the flange such that the retainer arrangement can contact the ledge, and the main retainer arrangement supports a first set of through-bolt conduits in a bolt pattern that encircles the hollow tube. The adaptor body can include a second set of through-bolt conduits that matches the first set. A set of bolts can be provided and arranged to pass through the matching patters of bolt holes thereby connecting the retainer and the adaptor arrangement with the set of bolts can be tightened to provide the clamping force between the retainer and the adaptor body and therefore upon the gasket. IN such embodiments it can be desirable to include compliance in part to provide tolerance against thermal expansion as well as physical impact. For example, spring mechanisms one end or the other of each bolt can engage the retainer arrangement and the adaptor arrangement, respectively, through a spring mechanism such as a wave spring or Belleville washer (ex. 2416) providing sufficient axial compliance (in the axial direction of each bolt) to absorb CTE mismatch along that direction throughout a full range of operating temperatures.

For any given type of engagement feature there is no particular requirement that the feature continuously encircle the entire circumference of the tube. As illustrated in FIG. 231 two or more engagement features (231, 2050), each forming a protrusion and/or an indentation in accordance with the above descriptions, can be spaced apart from one another so as to be distributed around the tube such that each engagement feature provides an associated ledge surface.

We have described various tube furnaces with an emphasis on high temperature tube adaptor operation for reducing contamination due to debinding. It should be understood that there are many possible applications where these systems and methods may be advantageous. Examples include and are not limited to (i) any application where ultra-high purity atmosphere is desired within a tube furnace, (ii) other applications in which organic and/or other volatile contaminants are temporarily introduced as part of a process but then must be eliminated, (iii) applications where is desirable to reduce the temperature gradient from the extreme temperature portion of a tube furnace to the end portion(s) of the tube. Concerning the last item, tube furnaces often fail due to the aforementioned temperature gradient, especially after repeated cycling. In many cases replacement tubes can be exceedingly costly in which case additional cost of employing our techniques could result in very large overall savings.

Having described systems and methods for providing tube adaptors that can exhibit truly remarkable atmospheric purity, it must be understood that for many applications it may be unnecessary to achieve the ultimately high sealing performance as set forth immediately above.

Just because these systems and methods can achieve the near perfect operation just set forth, that in no way means that they must at all times and applicants recognize that designers, builders and operators can and no doubt will conceive and discover ways to compromise the performance of these systems and techniques while still remaining within the scope of these teachings.

Compromises that could limit atmospheric purity—intentional or otherwise—include but are not limited to (i) feeding the Peclet seal at low flow rates to conserve gas usage, (ii) shortening the flow path length L for cost savings or due to manufacturing limitations (iii) employing an enlarged Peclet Gap in order to compensate for tolerance variation across the gap size, (iv) employing tube material or adaptor material that is slightly porous and thus not entirely hermetic (v) operating with a Peclet gap size that varies across the gap by more than a few percent, and (vi) operating with an excessively small Peclet gap size (for example to allow lower gas flow) thus rendering the gap to be excessively sensitive to size tolerance variations across and throughout the gap. Indeed the last compromise is one that we inadvertently discovered ourselves in our earliest laboratory tests and experiments.

We recognize that the term “non-hermetic” in reference to a given gasket seal could be regarded as somewhat nebulous at least for the reason that different applications may place the requirement for sealing integrity at entirely different orders of magnitude. We further recognize that the difficulty of measurement and characterisation of the ultimate limits of performance can pose challenges for monitoring and even just describing performance both in language and in practice. In much of our work the ultimate authoritative characterisation of performance resides in meeting the demands of a given application and in the results achieved with respect to material composition and quality. Indeed, in the course of sintering metals our own demands for sealing integrity can vary by several orders of magnitude. For example, when we debind and then sinter titanium we observe based on our data that it has been both possible and necessary to achieve in a routine way better than 10 parts per billion with respect to oxygen purity. On the other hand, when sintering copper, stainless steel and other more forgiving materials we find that parts per million purity can often be adequate. In the face of such variation in requirements, the term hermetic when applied to the tube seals described herein should be interpreted as specifying that the overall tube seal, using a non-hermetic gasket surrounded by a Peclet seal, isolates relative to outside air by AT LEAST one order of magnitude as compared to level of isolation that would be otherwise be achieved with just the gasket and with no Peclet seal. This definition serves as a very definite meaning for descriptive purposes as well as in practice at least for the reason that it is utterly straightforward to test and measure operation of a sealing arrangement in situ with and without Peclet sealing. Having assembled a tube adaptor in accordance with our teachings, a POOSITA can simply turn off Peclet flow of sweep gas and can use well known techniques to measure leak rate through the gasket and atmospheric purity. The operator can then incrementally increase sweep gas flow whilst continuously monitoring the atmospheric purity until such a time as the contaminant level becomes unmeasurable and/or reaches an acceptable level for a particular application. We routinely execute this test and we routinely arrive at results whereby the leak rate of outside air into the hollow tube improves by multiple orders of magnitude before becoming unmeasurable even with our state of the art Helium leak tester.

Insofar as any tube adaptor system as taught herein employs a given non-hermetic gasket, the overall combination of that gasket seal surrounded by a Peclet seal should be considered as functioning in accordance with these teachings for any mode of operation in which the leakage of outside air through that non-hermetic gasket contains an amount of outside air that has been substantially reduced, by way of this Peclet sealing, by at least one order of magnitude as compared to operation in the sustained absence of any Peclet flow in steady state operation. In accordance with our teachings, any non-hermetic gasket leakage exhibiting a given level of ingress of outside air due to leakage and/or diffusion around and/or through the gasket, can be substantially reduced by surrounding that gasket with a Peclet seal using the techniques and methods described herein to substantially improve the isolation of outside air, by one or more orders of magnitude, as compared to a steady state test mode in which the Peclet flow is deactivated.

Although the disclosed subject matter has been described and illustrated with respect to embodiments thereof, it should be understood by those skilled in the art that features of the disclosed embodiments can be combined, rearranged, etc., to produce additional embodiments within the scope of the present disclosure, and that various other changes, omissions, and additions may be made therein and thereto, without parting from the spirit and scope of the present disclosure.

What is claimed is:

1. A hermetic tube adaptor, comprising:
a hollow tube composed of a tube material that is hermetically impervious to diffusion of gases therethrough, having at least one open tube end such that a hollow interior of the hollow tube terminates at the open tube end which supports thereon a first gasket sealing surface that circumscribes the open termination of said hollow interior, an adaptor arrangement including:
(i) a flange composed of a hermetically impermeable flange material, that includes a second gasket sealing surface having a shape that matches and faces the first gasket sealing surface such that a vacuum gasket can be sandwiched between said gasket sealing surfaces,
(ii) a gasket serving as a vacuum seal composed of a non-hermetic gasket material sandwiched between said first and second gasket sealing surfaces
(iii) a clamping arrangement that mechanically engages both the hollow tube and the flange and is configured for clamping the first and second gasket sealing surfaces towards one another to cause compression force upon said open gasket, and
wherein the hollow interior of the tube can be hermetically sealed from outside ambient air employing a hermetic sealing arrangement including:
(i) the gasket serving as a non-hermetic vacuum seal that exhibits at least some gasket leakage as a gaseous diffusion through and/or around said non-hermetic gasket of any gas that surrounds an outer periphery of said gasket,
(ii) a groove in one or both of said tube end and said flange disposed around an outer perimeter of the gasket and configured to receive a flow of oxygen free sweep gas that is injected therein through an injection channel within said flange such that said sweep gas surrounds the outer periphery of said gasket,
(iii) an external Peclet seal surrounding the vacuum gasket and interposed in a series arrangement between said vacuum gasket and the outside ambient air, and configured to receive said flow of oxygen free sweep gas to provide diffusion sealing, by gas flow of said oxygen free sweep gas, from an interior perimeter of the Peclet seal, in gaseous communication with said groove, to an outside perimeter of the Peclet seal, in gaseous communication with outside ambient air, such that the Peclet seal can substantially isolate the gasket from exposure to outside air,
wherein a majority of said flow of oxygen free sweep gas flows through the Peclet seal and a trace minority of the oxygen free sweep gas flows through and/or around said gasket as said leakage such that the non-hermetic vacuum seal provides sufficient sealing to support and allow for vacuum pressure within the hollow tubes, yet would not provide sufficient hermiticity against outside ambient air in an absence of any surrounding additional seal, and the Peclet seal serving as a surrounding additional seal provides for sufficient isolation from the outside air such that said leakage through and/or around the non-hermetic gasket seal is substantially free of outside air.

2. The hermetic tube adaptor of claim 1 wherein the Peclet seal has an inlet in gaseous communication with said groove for receiving said sweep gas therefrom, and an outlet in gaseous communication with said outside air, and a Peclet flow path length L from the inlet to the outlet with sufficient flow velocity such that said sweep gas flow causes suppression of back diffusion of said outside air to provide for said hermetic isolation.

3. The hermetic tube adaptor of claim 2 wherein the hollow tube includes a first Peclet sealing surface and the adaptor includes a second Peclet sealing surface that faces and matches the shape of the first Peclet sealing surface such that the two Peclet sealing surfaces face one another in a confronting relationship to define a Peclet Gap G as a gap size therebetween.

4. The hermetic tube adaptor of claim 2 wherein for an end portion extending along the tube axially from the rim of the tube for said path length L, said first Peclet sealing surface wraps around and encircles said end portion and faces radially outward and is surrounded and encircled by the opposing, second Peclet sealing surface also extending along said axial direction for said flow path length L and radially facing inward such that the two opposing Peclet sealing surfaces define said Peclet gap G as a radial gap therebetween having a gap size of G.

5. The hermetic tube adaptor of claim 1 wherein said hollow tube serves as a first hollow tube and a second hollow tube is hermetically attached to and/or cofabricated with the flange such that a hollow interior of the second hollow tube is arranged in gaseous communication with the hollow interior of the first hollow tube.

6. The hermetic tube adaptor of claim 5 wherein said gasket is an open gasket having an inner perimeter that defines an opening that allows for said gaseous communication between the interior of the second hollow tube and the hollow interior of the first hollow tube.

7. The hermetic tube adaptor of claim 6 wherein the open gasket is a peripheral gasket that extends around the open rim of the first hollow tube.

8. The hermetic tube adaptor of claim 2 wherein the rim of the hollow tube includes said first Peclet sealing surface that is flat and extends around the outer perimeter of the groove and the flange supports said second Peclet sealing surface, surrounding the outer perimeter of the groove and extending radially along said flow path length, that faces the first Peclet sealing surface in a confronting spaced apart relationship defining said Peclet gap G therebetween having said flow path length L.

9. The hermetic tube adaptor of claim 2 wherein said majority of sweep gas that surrounds the open gasket and flows into and through the Peclet seal, flows along the Peclet flow path at a velocity sufficient to suppress diffusion of outside air towards the inner volume to the degree that said any sweep gas in the groove that flows through and/or around the gasket into the hollow interior of the tube, as said leakage, contains at least an order of magnitude less air than would otherwise be the case if the flow of sweep gas were deactivated for a sustained period of time and thus exposed the gasket to outside air.

10. The hermetic tube adaptor seal of claim 9 wherein the sweep gas flows through the Peclet seal at a rate of between and inclusive of 0.01 to 0.1 standard liters per minute (SLM) to 10 SLM for every linear centimeter of circumferential gasket perimeter.

11. The hermetic tube adaptor of claim 10 wherein the sweep gas flows through the Peclet seal at a rate of between and inclusive of 0.1 to 1.0 SLM.

12. The hermetic tube adaptor of claim 9 wherein the gasket material is one of (i) sufficiently porous such that a majority of said leakage flows through the gasket as opposed to around the gasket and the leakage can be readily detected by monitoring steady state pressure rise in a closed system at vacuum (ii) an elastomeric material that is sufficiently diffusive to oxygen such that diffusion therethrough can be detected by use of a Helium leak tester.

13. The hermetic tube adaptor seal of claim 2 wherein the sweep gas is a highly purified oxygen free inert gas.

14. The hermetic tube adaptor of claim 13 wherein the sweep gas is a pure, laboratory grade, inert gas with a purity substantially better than 1 ppm of oxygen or any other gaseous contaminates including hydrocarbon gases.

15. The hermetic tube adaptor of claim 13 wherein a majority of the sweep gas is highly purified Argon.

16. The hermetic tube adaptor of claim 2 wherein the Peclet seal includes (i) said Peclet gap having said Peclet gap length L of (i) at least one mm.

17. The hermetic tube adaptor of claim 16 wherein the Peclet gap is between or equal to one of 0.001 inches to 0.010 inches.

18. The hermetic tube adaptor of claim 16 wherein the Peclet gap is between or equal to one of 0.002 inches to about 0.005 inches.

19. The hermetic tube adaptor of claim 13 wherein the Peclet seal provides isolation against diffusion of outside are to a sufficient degree such that any sweep gas in the sweep gas groove that leaks into the sealed vacuum retort through the gasket leak is contaminated with outside air only by an amount that is lower than 1 part per million (ppm).

20-46. (canceled)

47. A hermetic tube adaptor, comprising:
a first hollow tube composed of a first tube material that is hermetically impervious to diffusion of gases therethrough, having at least one open tube end such that a first hollow interior of the first hollow tube terminates at that open tube end which supports thereon a first gasket sealing surface that circumscribes the open termination of said first hollow interior, an adaptor assembly including:
(i) a flange composed of a hermetically impermeable flange material, that includes a second gasket sealing surface having a shape that matches and faces the first gasket sealing surface such that a vacuum gasket can be sandwiched between said gasket sealing surfaces,
(ii) a second hollow tube, composed of a second tube material that is hermetically impervious to diffusion of air therethrough, that is hermetically sealed with and/or co-fabricated with the flange such that the hollow inside of said second tube is in gaseous communication with the hollow inside of the first hollow tube,
an open gasket serving as a peripheral vacuum seal composed of a non-hermetic gasket material peripherally disposed around the open termination of said first hollow interior, sandwiched between said first and second gasket sealing surfaces such that an inner periphery of the open gasket defines a gasket opening to provide for said gaseous communication between said interiors of said hollow tubes,
a clamping arrangement that mechanically engages both the first tube and the flange and is configured for clamping the first and second gasket sealing surfaces towards one another to cause compression force upon said open gasket, and
the hollow interiors of the tubes, in gaseous communication with one another, can be hermetically sealed from outside ambient air employing a hermetic sealing arrangement including:
(i) the open gasket serving as a non-hermetic vacuum seal that exhibits at least some gasket leakage as a gaseous diffusion through and/or around said non-hermetic gasket,
(ii) a groove disposed around an outer perimeter of the open gasket and configured to receive a flow of oxygen free sweep gas that is injected therein through an injection channel within said adaptor assembly such that said sweep gas surrounds said open gasket,
(iii) an external Peclet seal surrounding the vacuum gasket and interposed in a series arrangement between said vacuum gasket and the outside ambient air, and configured to receive said flow of oxygen free sweep gas to provide diffusion sealing, by radial gas flow of said oxygen free sweep gas, from an interior perimeter of the Peclet seal to the outer perimeter of the Peclet seal such that the Peclet seal can hermetically isolate the open gasket,
wherein a majority of said flow of oxygen free sweep gas flows through the Peclet seal and a trace minority of the oxygen free sweep gas flows through and/or around said open gasket as said leakage such that the non-hermetic vacuum seal provides sufficient sealing to support and allow for vacuum pressure within the hollow tubes, yet would not provide sufficient hermiticity in the absence of said Peclet seal, and the Peclet seal provides for sufficient hermetic isolation from the outside air such that said leakage through and/or around the non-hermetic gasket seal is hermetically free of oxygen.
